(19) United States
(12) Patent Application Publication
(10) Pub. No.: US 2003/0099254 A1
(43) Pub. Date: May 29, 2003

(54) Systems and methods for interfacing asynchronous and non-asynchronous data media

(76) Inventor: Roger K. Richter, Leander, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 10/277,613

(22) Filed: Oct. 22, 2002

Related U.S. Application Data
(63) Continuation-in-part of application No. 09/797,404, filed on Mar. 1, 2001.
(60) Provisional application No. 60/353,553, filed on Jan. 31, 2002.
(60) Provisional application No. 60/417,178, filed on Oct. 9, 2002.
(60) Provisional application No. 60/187,211, filed on Mar. 3, 2000.
(60) Provisional application No. 60/246,373, filed on Nov. 7, 2000.

(51) Int. Cl. H04J 3/16

(52) U.S. Cl. 370/466; 370/352; 370/401

(57) ABSTRACT

Systems and methods for interfacing asynchronous and non-asynchronous data media, such as for interfacing an asynchronous computing I/O bus medium with a non-asynchronous T/N medium. The disclosed systems and methods may be implemented, for example, in a manner that allows conversion or transformation of information in asynchronous-compliant form to information in non-asynchronous-compliant form in real time.

This application claims priority from Provisional Application Serial No. 60/353,553, which was filed Jan. 31, 2002 and is entitled “SWITCH FABRIC INTERFACE,” and also claims priority from Provisional Application Serial No. ______, which was filed Oct. 9, 2002 and is entitled “SYSTEMS AND METHODS FOR INTERFACING ASYNCHRONOUS AND NON-ASYNCHRONOUS DATA MEDIA” by Richter, the disclosures of which are each incorporated herein by reference. This application is also a continuation-in-part of U.S. patent application Ser. No. 09/797,404 filed on Mar. 1, 2001 which is entitled “INTERPROCESS COMMUNICATIONS WITHIN A NETWORK NODE USING SWITCH FABRIC,” and which itself claims priority to U.S. Provisional Application Serial No. 60/246,373 filed on Nov. 7, 2000 which is entitled “INTERPROCESS COMMUNICATIONS WITHIN A NETWORK NODE USING SWITCH FABRIC,” and also claims priority to U.S. Provisional Application Serial No. 60/187,211 filed on Mar. 3, 2000 which is entitled “SYSTEM AND APPARATUS FOR INCREASING FILE SERVER BANDWIDTH,” the disclosures of each of the foregoing applications being incorporated herein by reference.

### BACKGROUND OF THE INVENTION

The present invention relates generally to data signal communication, and more particularly to data signal communication interfaces.

Computing systems, such as workstation, server and desktop personal computers, commonly connect core microprocessors or central processing units (“CPU's”) to Input/Output (“I/O”) devices using computing I/O bus technology. For example, a computing I/O bus attached to an arbiter may be employed to connect a CPU processor bus to a set of I/O devices such as video devices, storage devices, and network devices. Conventional computing I/O bus standards that have been developed include ISA, E-ISA, MicroChannel, VME, S-Bus, PCI and PCI-X. Computing I/O buses may vary in physical characteristics (e.g., clock rate, bus width, number of control signals) but share many common operational characteristics. In this regard, computing I/O buses are primarily simplex in nature with one common clock signal. Multiple devices may share the computing I/O bus, but only one processing entity may use the bus for data transfer at any given point in time. Conventional computing I/O buses rely on a hardware-based signaling scheme to allow multiple devices on a bus to arbitrate for access to the bus. Other than the arbitration signaling scheme (i.e., request, grant, stop, etc.), there is no specific provision for rate control. Bus access is granted in an arbitrary manner to a given device seeking access at a given point in time.

In the Telecommunications (“Telco”) and networking industries, switch fabrics may be employed for interconnecting devices that manage network traffic. Telco/networking (“T/N”) equipment employ switch fabric hardware standards for interconnecting devices that manage network traffic that are very different from conventional computing I/O bus standards used in computing systems. Examples of commonly adopted T/N interconnect interface standards include UTOPIA Level 1/2/3, POS PHY Level 3/Level 4, SPI-3/SPI-4/SPI-5 and CSIX. T/N interface standards may vary in specific physical characteristics (e.g., clock rates, signal levels, bus widths, etc.), but share many operational characteristics. In this regard, T/N interface standards typically employ duplex control and data operation, independent transmit and receive clocks, hardware level flow control support for transmit and receive, and isochronous operation support, i.e. Time Division Multiplexing (“TDM”)/slotted or cell based.

### SUMMARY OF THE INVENTION

Disclosed herein are systems and methods for interfacing asynchronous and non-asynchronous data media, such as for interfacing an asynchronous computing I/O bus medium with a non-asynchronous T/N medium. Advantageously, the disclosed systems and methods may be implemented in one embodiment to reduce latency and complexity of information exchange between asynchronous and non-asynchronous data media. Further the disclosed systems and methods may be implemented in a manner that allows conversion or transformation (e.g., including any desired or needed data conversion and flow control calculations) of information in asynchronous-compliant form to information in non-asynchronous-compliant form in real time or “on the fly”.

In one respect, the disclosed systems and methods may be advantageously implemented to interface with standard asynchronous data media (e.g., standard computing I/O bus such as PCI or PCI-type (e.g., including PCI-X, etc.), S-Bus, Microchannel, VME, Hypertransport, etc) using direct memory access (“DMA”) formats that are standard for use with such asynchronous data media. In this regard, the disclosed systems and methods may be so implemented to provide an asynchronous/non-asynchronous (“A/N”) data media interface between standard asynchronous data media and a given non-asynchronous data media (e.g., of any desired or selected type) that appears to the asynchronous data media as a standard DMA-intelligent device, thus effectively hiding the complexity of the interface from the asynchronous data media. Because the disclosed systems and methods may be so implemented with standard asynchronous data media types, an information management system (e.g., content router) may be implemented in one embodiment using standard chipsets on the asynchronous data medium (e.g., computing I/O bus) side without requiring customized hardware and/or software, such as custom application specific integrated circuits (“ASICs”).

Further, a given asynchronous data medium may be interfaced or coupled to a variety of different non-asynchronous data media types, e.g., in one exemplary embodiment to provide a computing I/O bus master type interface for coupling to any given conventional T/N type switch fabric. Thus, in one exemplary embodiment, a standard asynchronous data medium may be communicatively coupled to a non-asynchronous data medium that possesses differentiated service capabilities of prioritization, CoS, QoS, etc. such as described in co-pending U.S. patent application Ser. No. 09/879,810 filed on Jun. 12, 2001 which is entitled SYSTEMS AND METHODS FOR PROVIDING DIFFERENTIATED SERVICE IN INFORMATION MANAGEMENT ENVIRONMENTS, which is incorporated herein by reference. This configuration may be advantageously implemented, for example, to allow information (e.g., data) from one or more asynchronous devices to be received from an operating system environment of an asynchronous data medium (e.g., computing I/O bus) across a first generic asynchronous interface (e.g., generic computing I/O bus interface such as PCI interface), to be transformed into non-asynchronous compatible form, and to be communicated across a non-asynchronous interface to a non-asynchronous data medium (e.g., distributed interconnect such as switch fabric) in a manner that takes advantage of one or more capabilities of the non-asynchronous data medium (e.g., fault tolerance, flow control, buffering, multiple queue prioritization, high throughput, etc.). In one exemplary embodiment, such information may be further received from the non-asynchronous data medium, transformed to appropriate asynchronous form, and then communicated across a second generic asynchronous interface to one or more other asynchronous devices.

Further advantageously, one or more of the above-described differentiated service and/or other capabilities of the non-asynchronous data medium may be selectively implemented in real time basis (or “on the fly”), for example, on a per protocol data unit (“PDU”)-basis. This may be accomplished, for example, by using a utility or tool that functions (e.g., without need for real-time software involvement) to set parameters and transform traffic in an A/N data media interface, e.g., by building a PDU that contains information indicative of desired data transformation (if any).

In another respect, the disclosed systems and methods may be implemented to provide an A/N data media interface that presents one or more selected standardized device interface/s (e.g., Ethernet adapter, storage adapter, block driver interface, selected combinations thereof, etc.) to a standard asynchronous data media (e.g., standard computing I/O bus described elsewhere herein), while at the same time performing data transformation effective to allow communication of data from the standard asynchronous medium to a selected non-asynchronous data medium (e.g., T/N switch fabric, etc.). This may be accomplished in one exemplary embodiment by software that emulates the one or more selected interface/s. In one embodiment, an A/N data media interface may be configured to multiplex multiple driver interfaces over the same non-asynchronous data medium. Further, data may be encapsulated, DMA buffering may be employed, and PDU formats may be used to indicate desired transformations (e.g., prioritization, flow control, etc.).

In one exemplary embodiment, an A/N data media interface may be implemented in a manner that presents itself to an asynchronous data medium as one or more devices (e.g., as two or more S-Bus and/or PCI devices) having its own generic PDU header. Such a generic PDU header may be employed to indicate that transformations are to be performed on the data. In this exemplary embodiment, an A/N data media interface may be implemented in a flexible manner to receive data from a standard asynchronous data medium and to perform selected task/s on the data as desired or prescribed. For example, an A/N data media interface may be employed to offload Ethernet traffic across a non-asynchronous data medium (e.g., switch fabric) by accepting data from an asynchronous data medium (e.g., computing I/O bus), encapsulating the data, and communicating it across the non-asynchronous data medium.

In one embodiment, the present disclosure provides a fabric switch interface. The fabric switch interface may be utilized to interface and interconnect a processing entity configured with an asynchronous data medium (e.g., computing I/O bus or high speed computing I/O bus) to a non-asynchronous T/N switch fabric data medium. The disclosed fabric switch interface may be utilized with switch fabrics that are incorporated into a variety of computing systems. For example, the computing system may be a content delivery system (as used herein also called a content router).

### BRIEF DESCRIPTION OF THE DRAWINGS

FIG. 1A is a representation of components of a content delivery system according to one embodiment of the disclosed content delivery system.

FIG. 1B is a representation of data flow between modules of a content delivery system of FIG. 1A according to one embodiment of the disclosed content delivery system.

FIG. 1C (shown split on two pages as FIGS. 1C′ and 1C″) is a simplified schematic diagram showing one possible network content delivery system hardware configuration.

FIG. 1D is a functional block diagram of an exemplary network processor.

FIG. 1E is a functional block diagram of an exemplary interface between a switch fabric and a processor.

FIG. 2 is a representation of components of an information management system according to one embodiment of the disclosed systems and methods.

FIG. 3 is a representation of a subsystem having processing entities and a set of processing objects thereon according to one embodiment of the disclosed systems and methods.

FIG. 4 is a representation of message passing between two processing entities and respective processing objects thereon according to one embodiment of the disclosed systems and methods.

FIG. 5 is a representation of an asynchronous/non-asynchronous (“A/N”) data media interface according to one embodiment of the disclosed systems and methods.

FIG. 6 is a representation of an A/N data media interface according to one embodiment of the disclosed systems and methods.

FIG. 7 is a representation of an A/N data media interface according to one embodiment of the disclosed systems and methods.

FIG. 8 illustrates a PCI configuration space layout according to one embodiment of the disclosed systems and methods.

FIG. 9 illustrates a FabPCI DMA Control Structure Area according to one embodiment of the disclosed systems and methods.

FIG. 10 illustrates FabPCI Parameters field of the FabPCI DMA Control Structure Area of FIG. 9 according to one embodiment of the disclosed systems and methods.

FIG. 11 illustrates Flow Control Event Status register of the FabPCI DMA Control Structure Area of FIG. 9 according to one embodiment of the disclosed systems and methods.

FIG. 12 illustrates a FabPCI DMA buffer descriptor structure according to one embodiment of the disclosed systems and methods.

### DESCRIPTION OF ILLUSTRATIVE EMBODIMENTS

In one embodiment, the interface systems and methods described herein may be implemented in any multi-node I/O interconnection hardware or hardware/software system suitable for distributing functionality by selectively interconnecting two or more devices of a system including, but not limited to, high speed interchange systems configured with non-asynchronous data medium (e.g., non-asynchronous distributed interconnect such as switch fabric architecture) interfaced to asynchronous data medium (e.g., computing I/O bus architecture). Examples of non-asynchronous switch fabric architectures include cross-bar switch fabrics, ATM switch fabrics, etc. Examples of asynchronous bus architectures include high speed computing I/O bus architectures. Specific examples of computing I/O bus architectures include, but are not limited to, PCI-type bus architectures (e.g., PCI, PCI-X, other PCI-derivative bus architectures, etc.), S-Bus, Microchannel, VME, Hypertransport, etc. However, it will also be understood that the disclosed systems and methods may be advantageously implemented in any other envirorunent to interface one or more non-asynchronous data media to one or more asynchronous data media, including to interface any of the non-asynchronous and asynchronous data medium types described elsewhere herein.

In one embodiment, the systems and methods disclosed here may be implemented in an information management system such as a functional multi-processor network connected computing system. Examples of just a few of the many types of information delivery environments and/or information management system configurations with which the disclosed methods and systems may be advantageously employed are described in co-pending U.S. patent application Ser. No. 09/797,413 filed on Mar. 1, 2001 which is entitled NETWORK CONNECTED COMPUTING SYSTEM; in co-pending U.S. patent application Ser. No. 09/797,200 filed on Mar. 1, 2001 which is entitled SYSTEMS AND METHODS FOR THE DETERMINISTIC MANAGEMENT OF INFORMATION; and in co-pending U.S. patent application Ser. No. 09/879,810 filed on Jun. 12, 2001 which is entitled SYSTEMS AND METHODS FOR PROVIDING DIFFERENTIATED SERVICE IN INFORMATION MANAGEMENT ENVIRONMENTS; and in U.S. patent application Ser. No. 10/003,683 filed on Nov. 2, 2001 which is entitled “SYSTEMS AND METHODS FOR USING DISTRIBUTED INTERCONNECTS IN INFORMATION MANAGEMENT ENVIRONMENTS”; each of the foregoing applications being incorporated herein by reference. In one embodiment, the disclosed systems and methods may be implemented in network connected computing systems that may be employed to manage the delivery of content across a network that utilizes computing systems such as servers, switches and/or routers.

In one embodiment, systems and methods for operating network connected computing systems may utilize the disclosed fabric switch interface techniques. The network connected computing systems disclosed provide a more efficient use of computing system resources and provide improved performance as compared to traditional network connected computing systems. Network connected computing systems may include network endpoint systems. The systems and methods disclosed herein may be particularly beneficial for use in network endpoint systems. Network endpoint systems may include a wide variety of computing devices, including but not limited to, classic general purpose servers, specialized servers, network appliances, storage area networks or other storage medium, content delivery systems, corporate data centers, application service providers, home or laptop computers, clients, any other device that operates as an endpoint network connection, etc.

Other network connected systems may be considered a network intermediate node system. Such systems are generally connected to some node of a network that may operate in some other fashion than an endpoint. Typical examples include network switches or network routers. Network intermediate node systems may also include any other devices coupled to intermediate nodes of a network.

Further, some devices may be considered both a network intermediate node system and a network endpoint system. Such hybrid systems may perform both endpoint functionality and intermediate node functionality in the same device. For example, a network switch that also performs some endpoint functionality may be considered a hybrid system. As used herein such hybrid devices are considered to be a network endpoint system and are also considered to be a network intermediate node system.

For ease of understanding, the systems and methods disclosed herein are described with regards to an illustrative network connected computing system. In the illustrative example the system is a network endpoint system optimized for a content delivery application. Thus a content delivery system is provided as an illustrative example that demonstrates the structures, methods, advantages and benefits of the network computing system and methods disclosed herein. Content delivery systems (such as systems for serving streaming content, HTTP content, cached content, etc.) generally have intensive input/output demands.

It will be recognized that the hardware and methods discussed below may be incorporated into other hardware or applied to other applications. For example with respect to hardware, the disclosed system and methods may be utilized in network switches. Such switches may be considered to be intelligent or smart switches with expanded functionality beyond a traditional switch. Referring to the content delivery application described in more detail herein, a network switch may be configured to also deliver at least some content in addition to traditional switching functionality. Thus, though the system may be considered primarily a network switch (or some other network intermediate node device), the system may incorporate the hardware and methods disclosed herein. Likewise a network switch performing applications other than content delivery may utilize the systems and methods disclosed herein. The nomenclature used for devices utilizing the concepts of the present invention may vary. The network switch or router that includes the content delivery system disclosed herein may be called a network content switch or a network content router or the like. Independent of the nomenclature assigned to a device, it will be recognized that the network device may incorporate some or all of the concepts disclosed herein.

The disclosed hardware and methods also may be utilized in storage area networks, network attached storage, channel attached storage systems, disk arrays, tape storage systems, direct storage devices or other storage systems. In this case, a storage system having the traditional storage system functionality may also include additional functionality utilizing the hardware and methods shown herein. Thus, although the system may primarily be considered a storage system, the system may still include the hardware and methods disclosed herein. The disclosed hardware and methods of the present invention also may be utilized in traditional personal computers, portable computers, servers, workstations, mainframe computer systems, or other computer systems. In this case, a computer system having the traditional computer system functionality associated with the particular type of computer system may also include additional functionality utilizing the hardware and methods shown herein. Thus, although the system may primarily be considered to be a particular type of computer system, the system may still include the hardware and methods disclosed herein.

As mentioned above, the benefits of the systems described herein are not limited to any specific tasks or applications. The content delivery applications described herein are thus illustrative only. Other tasks and applications that may incorporate the principles of the present invention include, but are not limited to, database management systems, application service providers, corporate data centers, modeling and simulation systems, graphics rendering systems, other complex computational analysis systems, etc. Although the principles of the present invention may be described with respect to a specific application, it will be recognized that many other tasks or applications performed with the hardware and methods may utilize the present invention.

Disclosed herein are systems and methods for delivery of content to computer-based networks that employ functional multi-processing using a “staged pipeline” content delivery environment to optimize bandwidth utilization and accelerate content delivery while allowing greater determination in the data traffic management. The disclosed systems may employ individual modular processing engines that are optimized for different layers of a software stack. Each individual processing engine may be provided with one or more discrete subsystem modules configured to run on their own optimized platform and/or to function in parallel with one or more other subsystem modules across a high speed distributive interconnect, such as a switch fabric, that allows peer-to-peer communication between individual subsystem modules. The use of discrete subsystem modules that are distributively interconnected in this manner advantageously allows individual resources (e.g., processing resources, memory resources) to be deployed by sharing or reassignment in order to maximize acceleration of content delivery by the content delivery system. The use of a scalable packet-based interconnect, such as a switch fabric, advantageously allows the installation of additional subsystem modules without significant degradation of system performance. Furthermore, policy enhancement/enforcement may be optimized by placing intelligence in each individual modular processing engine.

The network systems disclosed herein may operate as network endpoint systems. Examples of network endpoints include, but are not limited to, servers, content delivery systems, storage systems, application service providers, database management systems, corporate data center servers, etc. A client system is also a network endpoint, and its resources may typically range from those of a general purpose computer to the simpler resources of a network appliance. The various processing units of the network endpoint system may be programmed to achieve the desired type of endpoint.

Some embodiments of the network endpoint systems disclosed herein are network endpoint content delivery systems. The network endpoint content delivery systems may be utilized in replacement of or in conjunction with traditional network servers. A “server” can be any device that delivers content, services, or both. For example, a content delivery server receives requests for content from remote browser clients via the network, accesses a file system to retrieve the requested content, and delivers the content to the client. As another example, an applications server may be programmed to execute applications software on behalf of a remote client, thereby creating data for use by the client. Various server appliances are being developed and often perform specialized tasks.

As will be described more fully below, the network endpoint system disclosed herein may include the use of network processors. Though network processors conventionally are designed and utilized at intermediate network nodes, the network endpoint system disclosed herein adapts this type of processor for endpoint use.

The network endpoint system disclosed may be construed as a switch based computing system. The system may further be characterized as an asymmetric multi-processor system configured in a staged pipeline manner.

Exemplary System Overview

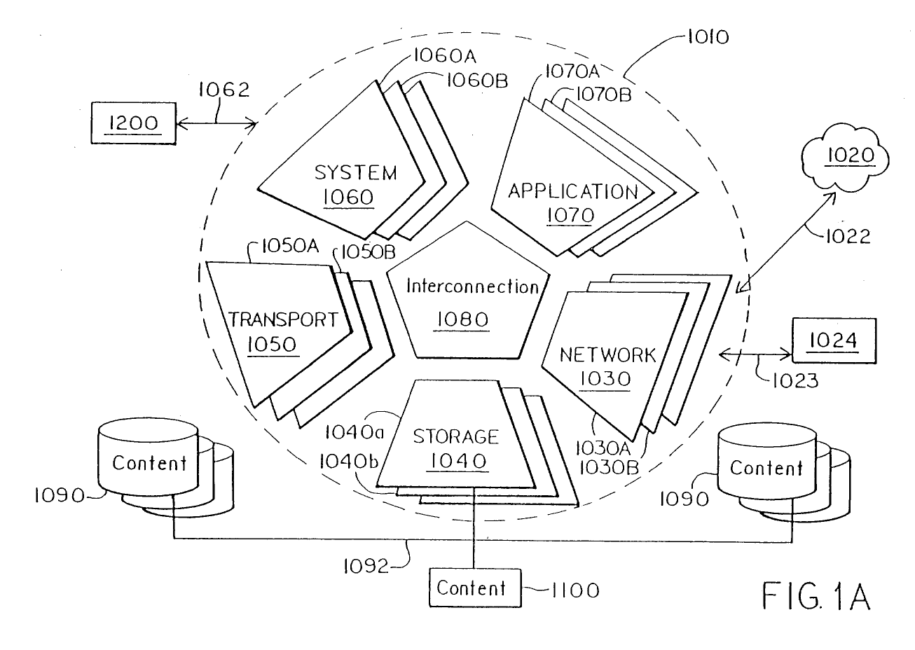

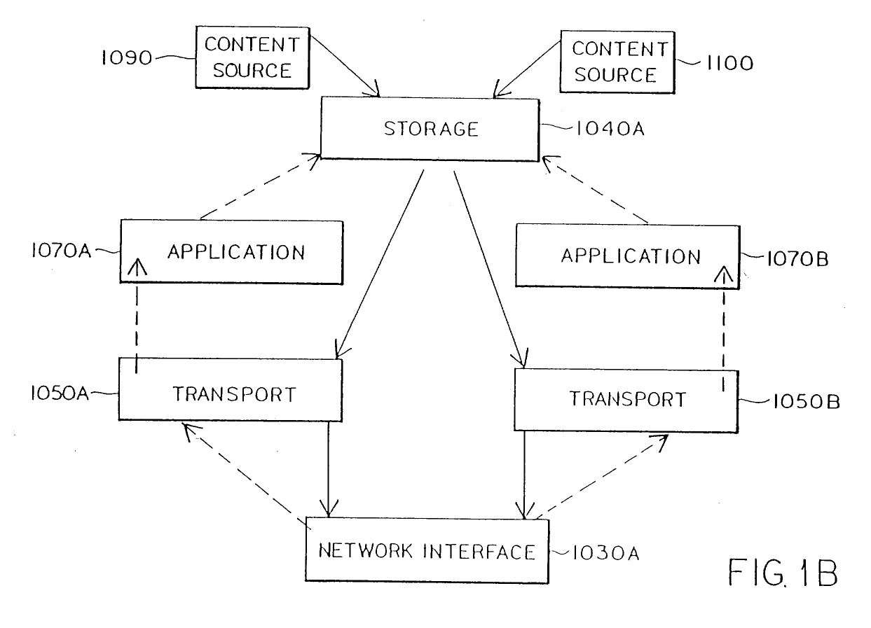

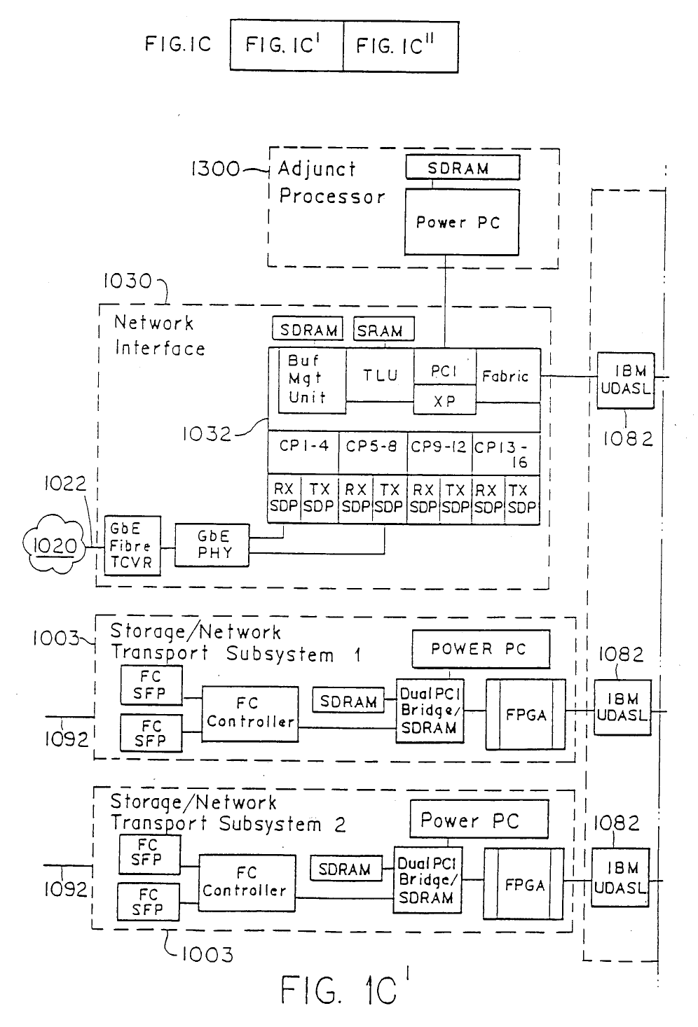

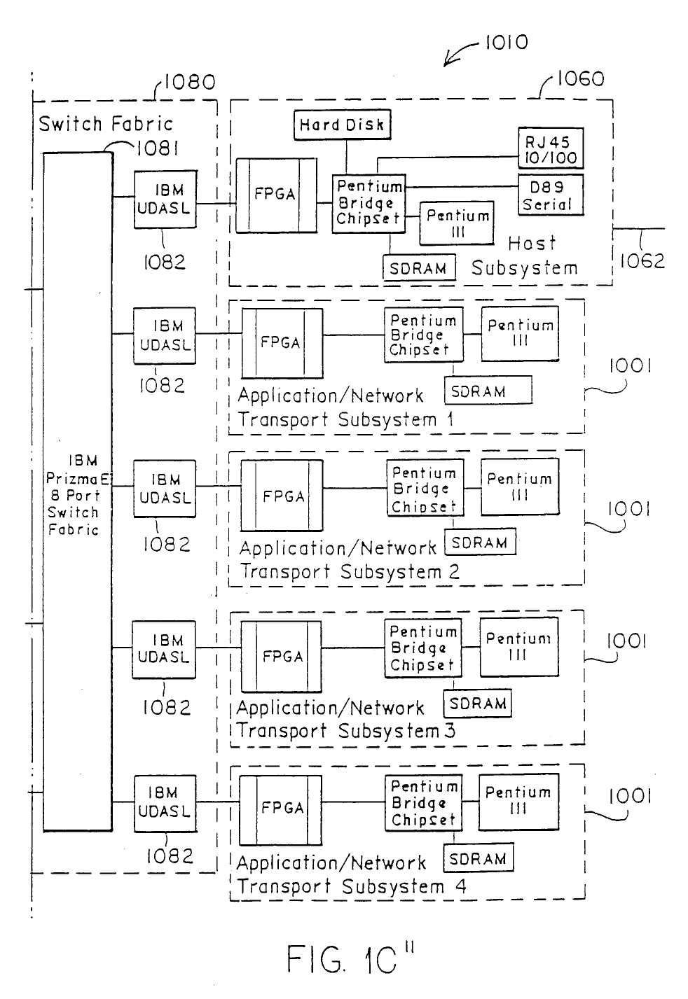

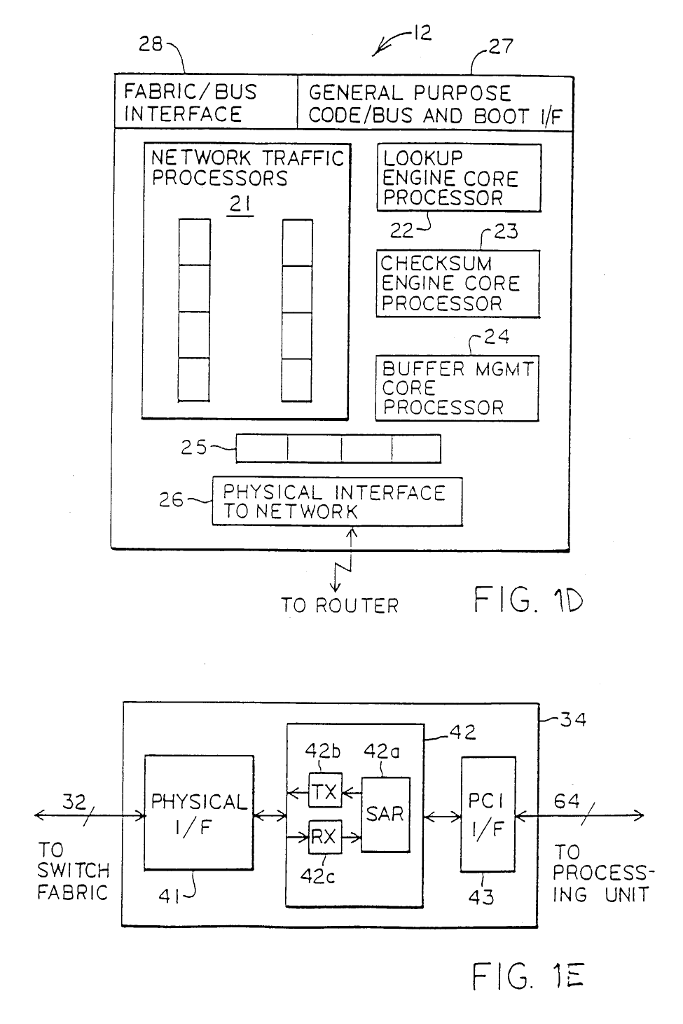

FIG. 1A is a representation of one embodiment of a content delivery system 1010, for example as may be employed as a network endpoint system in connection with a network 1020. Network 1020 may be any type of computer network suitable for linking computing systems. Content delivery system 1010 may be coupled to one or more networks including, but not limited to, the public internet, a private intranet network (e.g., linking users and hosts such as employees of a corporation or institution), a wide area network (WAN), a local area network (LAN), a wireless network, any other client based network or any other network environment of connected computer systems or online users. Thus, the data provided from the network 1020 may be in any networking protocol. In one embodiment, network 1020 may be the public internet that serves to provide access to content delivery system 1010 by multiple online users that utilize internet web browsers on personal computers operating through an internet service provider. In this case the data is assumed to follow one or more of various Internet Protocols, such as TCP/IP, UDP/IP, HTTP, RTSP, SSL, FTP, etc. However, the same concepts apply to networks using other existing or future protocols, such as IPX, SNMP, NetBios, Ipv6, etc. The concepts may also apply to file protocols such as network file system (NFS) or common internet file system (CIFS) file sharing protocol.

Examples of content that may be delivered by content delivery system 1010 include, but are not limited to, static content (e.g., web pages, MP3 files, HTTP object files, audio stream files, video stream files, etc.), dynamic content, etc. In this regard, static content may be defined as content available to content delivery system 1010 via attached storage devices and as content that does not generally require any processing before delivery. Dynamic content, on the other hand, may be defined as content that either requires processing before delivery, or resides remotely from content delivery system 1010. As illustrated in FIG. 1A, content sources may include, but are not limited to, one or more storage devices 1090 (magnetic disks, optical disks, tapes, storage area networks (SAN's), etc.), other content sources 1100, third party remote content feeds, broadcast sources (live direct audio or video broadcast feeds, etc.), delivery of cached content, combinations thereof, etc. Broadcast or remote content may be advantageously received through second network connection 1023 and delivered to network 1020 via an accelerated flowpath through content delivery system 1010. As discussed below, second network connection 1023 may be connected to a second network 1024 (as shown). Alternatively, both network connections 1022 and 1023 may be connected to network 1020.

As shown in FIG. 1A, one embodiment of content delivery system 1010 includes multiple system engines 1030, 1040, 1050, 1060, and 1070 communicatively coupled via distributive interconnection 1080. In the exemplary embodiment provided, these system engines operate as content delivery engines. As used herein, “content delivery engine” generally includes any hardware, software or hardware/software combination capable of performing one or more dedicated tasks or sub-tasks associated with the delivery or transmittal of content from one or more content sources to one or more networks. In the embodiment illustrated in FIG. 1A content delivery processing engines (or “processing blades”) include network interface processing engine 1030, storage processing engine 1040, network transport/protocol processing engine 1050 (referred to hereafter as a transport processing engine), system management processing engine 1060, and application processing engine 1070. Thus configured, content delivery system 1010 is capable of providing multiple dedicated and independent processing engines that are optimized for networking, storage and application protocols, each of which is substantially self-contained and therefore capable of functioning without consuming resources of the remaining processing engines.

It will be understood with benefit of this disclosure that the particular number and identity of content delivery engines illustrated in FIG. 1A are illustrative only, and that for any given content delivery system 1010 the number and/or identity of content delivery engines may be varied to fit particular needs of a given application or installation. Thus, the number of engines employed in a given content delivery system may be greater or fewer in number than illustrated in FIG. 1A, and/or the selected engines may include other types of content delivery engines and/or may not include all of the engine types illustrated in FIG. 1A. In one embodiment, the content delivery system 1010 may be implemented within a single chassis, such as for example, a 2U chassis.

Content delivery engines 1030, 1040, 1050, 1060 and 1070 are present to independently perform selected sub-tasks associated with content delivery from content sources 1090 and/or 1100, it being understood however that in other embodiments any one or more of such subtasks may be combined and performed by a single engine, or subdivided to be performed by more than one engine. In one embodiment, each of engines 1030, 1040, 1050, 1060 and 1070 may employ one or more independent processor modules (e.g., CPU modules) having independent processor and memory subsystems and suitable for performance of a given function/s, allowing independent operation without interference from other engines or modules. Advantageously, this allows custom selection of particular processor-types based on the particular sub-task each is to perform, and in consideration of factors such as speed or efficiency in performance of a given subtask, cost of individual processor, etc. The processors utilized may be any processor suitable for adapting to endpoint processing. Any “PC on a board” type device may be used, such as the x86 and Pentium processors from Intel Corporation, the SPARC processor from Sun Microsystems, Inc., the PowerPC processor from Motorola, Inc. or any other microcontroller or microprocessor. In addition, network processors (discussed in more detail below) may also be utilized. The modular multi-task configuration of content delivery system 1010 allows the number and/or type of content delivery engines and processors to be selected or varied to fit the needs of a particular application.

The configuration of the content delivery system described above provides scalability without having to scale all the resources of a system. Thus, unlike the traditional rack and stack systems, such as server systems in which an entire server may be added just to expand one segment of system resources, the content delivery system allows the particular resources needed to be the only expanded resources. For example, storage resources may be greatly expanded without having to expand all of the traditional server resources.

Distributive Interconnect

Still referring to FIG. 1A, distributive interconnection 1080 may be any multi-node I/O interconnection hardware or hardware/software system suitable for distributing functionality by selectively interconnecting two or more content delivery engines of a content delivery system including, but not limited to, high speed interchange systems such as a switch fabric or bus architecture. Examples of switch fabric architectures include cross-bar switch fabrics, Ethernet switch fabrics, ATM switch fabrics, etc. Examples of bus architectures include PCI, PCI-X, S-Bus, Microchannel, VME, etc. Generally, for purposes of this description, a “bus” is any system bus that carries data in a manner that is visible to all nodes on the bus. Generally, some sort of bus arbitration scheme is implemented and data may be carried in parallel, as n-bit words. As distinguished from a bus, a switch fabric establishes independent paths from node to node and data is specifically addressed to a particular node on the switch fabric. Other nodes do not see the data nor are they blocked from creating their own paths. The result is a simultaneous guaranteed bit rate in each direction for each of the switch fabric's ports.

The use of a distributed interconnect 1080 to connect the various processing engines in lieu of the network connections used with the switches of conventional multi-server endpoints is beneficial for several reasons. As compared to network connections, the distributed interconnect 1080 is less error prone, allows more deterministic content delivery, and provides higher bandwidth connections to the various processing engines. The distributed interconnect 1080 also has greatly improved data integrity and throughput rates as compared to network connections.

Use of the distributed interconnect 1080 allows latency between content delivery engines to be short, finite and follow a known path. Known maximum latency specifications are typically associated with the various bus architectures listed above. Thus, when the employed interconnect medium is a bus, latencies fall within a known range. In the case of a switch fabric, latencies are fixed. Further, the connections are “direct”, rather than by some undetermined path. In general, the use of the distributed interconnect 1080 rather than network connections, permits the switching and interconnect capacities of the content delivery system 1010 to be predictable and consistent.

One example interconnection system suitable for use as distributive interconnection 1080 is an 8/16 port 28.4 Gbps high speed PRIZMA-E non-blocking switch fabric switch available from IBM. It will be understood that other switch fabric configurations having greater or lesser numbers of ports, throughput, and capacity are also possible. Among the advantages offered by such a switch fabric interconnection in comparison to shared-bus interface interconnection technology are throughput, scalability and fast and efficient communication between individual discrete content delivery engines of content delivery system 1010. In the embodiment of FIG. 1A, distributive interconnection 1080 facilitates parallel and independent operation of each engine in its own optimized environment without bandwidth interference from other engines, while at the same time providing peer-to-peer communication between the engines on an as-needed basis (e.g., allowing direct communication between any two content delivery engines 1030, 1040, 1050, 1060 and 1070). Moreover, the distributed interconnect may directly transfer inter-processor communications between the various engines of the system. Thus, communication, command and control information may be provided between the various peers via the distributed interconnect. In addition, communication from one peer to multiple peers may be implemented through a broadcast communication which is provided from one peer to all peers coupled to the interconnect. The interface for each peer may be standardized, thus providing ease of design and allowing for system scaling by providing standardized ports for adding additional peers.

Network Interface Processing Engine

As illustrated in FIG. 1A, network interface processing engine 1030 interfaces with network 1020 by receiving and processing requests for content and delivering requested content to network 1020. Network interface processing engine 1030 may be any hardware or hardware/software subsystem suitable for connections utilizing TCP (Transmission Control Protocol) IP (Internet Protocol), UDP (User Datagram Protocol), RTP (Real-Time Transport Protocol), Wireless Application Protocol (WAP) as well as other networking protocols. Thus the network interface processing engine 1030 may be suitable for handling queue management, buffer management, TCP connect sequence, checksum, IP address lookup, internal load balancing, packet switching, etc. Thus, network interface processing engine 1030 may be employed as illustrated to process or terminate one or more layers of the network protocol stack and to perform look-up intensive operations, offloading these tasks from other content delivery processing engines of content delivery system 1010. Network interface processing engine 1030 may also be employed to load balance among other content delivery processing engines of content delivery system 1010. Both of these features serve to accelerate content delivery, and are enhanced by placement of distributive interchange and protocol termination processing functions on the same board. Examples of other functions that may be performed by network interface processing engine 1030 include, but are not limited to, security processing.

With regard to the network protocol stack, the stack in traditional systems may often be rather large. Processing the entire stack for every request across the distributed interconnect may significantly impact performance. As described herein, the protocol stack has been segmented or “split” between the network interface engine and the transport processing engine. An abbreviated version of the protocol stack is then provided across the interconnect. By utilizing this functionally split version of the protocol stack, increased bandwidth may be obtained. In this manner the communication and data flow through the content delivery system 1010 may be accelerated. The use of a distributed interconnect (for example a switch fabric) further enhances this acceleration as compared to traditional bus interconnects.

The network interface processing engine 1030 may be coupled to the network 1020 through a Gigabit (Gb) Ethernet fiber front end interface 1022. One or more additional Gb Ethernet interfaces 1023 may optionally be provided, for example, to form a second interface with network 1020, or to form an interface with a second network or application 1024 as shown (e.g., to form an interface with one or more server/s for delivery of web cache content, etc.). Regardless of whether the network connection is via Ethernet, or some other means, the network connection could be of any type, with other examples being ATM, SONET, or wireless. The physical medium between the network and the network processor may be copper, optical fiber, wireless, etc.

In one embodiment, network interface processing engine 1030 may utilize a network processor, although it will be understood that in other embodiments a network processor may be supplemented with or replaced by a general purpose processor or an embedded microcontroller. The network processor may be one of the various types of specialized processors that have been designed and marketed to switch network traffic at intermediate nodes. Consistent with this conventional application, these processors are designed to process high speed streams of network packets. In conventional operation, a network processor receives a packet from a port, verifies fields in the packet header, and decides on an outgoing port to which it forwards the packet. The processing of a network processor may be considered as “pass through” processing, as compared to the intensive state modification processing performed by general purpose processors. A typical network processor has a number of processing elements, some operating in parallel and some in pipeline. Often a characteristic of a network processor is that it may hide memory access latency needed to perform lookups and modifications of packet header fields. A network processor may also have one or more network interface controllers, such as a gigabit Ethernet controller, and are generally capable of handling data rates at “wire speeds”.

Examples of network processors include the C-Port processor manufactured by Motorola, Inc., the IXP1200 processor manufactured by Intel Corporation, the Prism processor manufactured by SiTera Inc., and others manufactured by MMC Networks, Inc. and Agere, Inc. These processors are programmable, usually with a RISC or augmented RISC instruction set, and are typically fabricated on a single chip.

The processing cores of a network processor are typically accompanied by special purpose cores that perform specific tasks, such as fabric interfacing, table lookup, queue management, and buffer management. Network processors typically have their memory management optimized for data movement, and have multiple I/O and memory buses. The programming capability of network processors permit them to be programmed for a variety of tasks, such as load balancing, network protocol processing, network security policies, and QoS/CoS support. These tasks can be tasks that would otherwise be performed by another processor. For example, TCP/IP processing may be performed by a network processor at the front end of an endpoint system. Another type of processing that could be offloaded is execution of network security policies or protocols. A network processor could also be used for load balancing. Network processors used in this manner can be referred to as “network accelerators” because their front end “look ahead” processing can vastly increase network response speeds. Network processors perform look ahead processing by operating at the front end of the network endpoint to process network packets in order to reduce the workload placed upon the remaining endpoint resources. Various uses of network accelerators are described in the following co-pending U.S. patent applications: Ser. No. 09/797,412, entitled “Network Transport Accelerator,” by Bailey et. al; Ser. No. 09/797,507 entitled “Single Chassis Network Endpoint System With Network Processor For Load Balancing,” by Richter et. al; and Ser. No. 09/797,411 entitled “Network Security Accelerator,” by Canion et. al; the disclosures of which are all incorporated herein by reference. When utilizing network processors in an endpoint environment it may be advantageous to utilize techniques for order serialization of information, such as for example, as disclosed in co-pending U.S. patent application Ser. No. 09/797.197, entitled “Methods and Systems For The Order Serialization Of Information In A Network Processing Environment,” by Richter et. al, the disclosure of which is incorporated herein by reference.

FIG. 1D illustrates one possible general configuration of a network processor. As illustrated, a set of traffic processors 21 operate in parallel to handle transmission and receipt of network traffic. These processors may be general purpose microprocessors or state machines. Various core processors 22-24 handle special tasks. For example, the core processors 22-24 may handle lookups, checksums, and buffer management. A set of serial data processors 25 provide Layer 1 network support. Interface 26 provides the physical interface to the network 1020. A general purpose bus interface 27 is used for downloading code and configuration tasks. A specialized interface 28 may be specially programmed to optimize the path between network processor 12 and distributed interconnection 1080.

As mentioned above, the network processors utilized in the content delivery system 1010 are utilized for endpoint use, rather than conventional use at intermediate network nodes. In one embodiment, network interface processing engine 1030 may utilize a MOTOROLA C-Port C-5 network processor capable of handling two Gb Ethernet interfaces at wire speed, and optimized for cell and packet processing. This network processor may contain sixteen 200 MHz MIPS processors for cell/packet switching and thirty-two serial processing engines for bit/byte processing, checksum generation/verification, etc. Further processing capability may be provided by five co-processors that perform the following network specific tasks: supervisor/executive, switch fabric interface, optimized table lookup, queue management, and buffer management. The network processor may be coupled to the network 1020 by using a VITESSE GbE SERDES (serializer-deserializer) device (for example the VSC7123) and an SFP (small form factor pluggable) optical transceiver for LC fiber connection.

Transport/Protocol Processing Engine

Referring again to FIG. 1A, transport processing engine 1050 may be provided for performing network transport protocol sub-tasks, such as processing content requests received from network interface engine 1030. Although named a “transport” engine for discussion purposes, it will be recognized that the engine 1050 performs transport and protocol processing and the term transport processing engine is not meant to limit the functionality of the engine. In this regard transport processing engine 1050 may be any hardware or hardware/software subsystem suitable for TCP/UDP processing, other protocol processing, transport processing, etc. In one embodiment transport engine 1050 may be a dedicated TCP/UDP processing module based on an INTEL PENTIUM III or MOTOROLA POWERPC 7450 based processor running the Thread-X RTOS environment with protocol stack based on TCP/IP technology.

As compared to traditional server type computing systems, the transport processing engine 1050 may off-load other tasks that traditionally a main CPU may perform. For example, the performance of server CPUs significantly decreases when a large amount of network connections are made merely because the server CPU regularly checks each connection for time outs. The transport processing engine 1050 may perform time out checks for each network connection, connection setup and tear-down, session management, data reordering and retransmission, data queueing and flow control, packet header generation, etc. off-loading these tasks from the application processing engine or the network interface processing engine. The transport processing engine 1050 may also handle error checking, likewise freeing up the resources of other processing engines.

Network Interface/Transport Split Protocol

The embodiment of FIG. 1A contemplates that the protocol processing is shared between the transport processing engine 1050 and the network interface engine 1030. This sharing technique may be called “split protocol stack” processing. The division of tasks may be such that higher tasks in the protocol stack are assigned to the transport processor engine. For example, network interface engine 1030 may processes all or some of the TCP/IP protocol stack as well as all protocols lower on the network protocol stack. Another approach could be to assign state modification intensive tasks to the transport processing engine.

In one embodiment related to a content delivery system that receives packets, the network interface engine performs the MAC header identification and verification, IP header identification and verification, IP header checksum validation, TCP and UDP header identification and validation, and TCP or UDP checksum validation. It also may perform the lookup to determine the TCP connection or UDP socket (protocol session identifier) to which a received packet belongs. Thus, the network interface engine verifies packet lengths, checksums, and validity. For transmission of packets, the network interface engine performs TCP or UDP checksum generation using the algorithm referenced herein, IP header generation, and MAC header generation, IP checksum generation, MAC FCS/CRC generation, etc.

Tasks such as those described above can all be performed rapidly by the parallel and pipeline processors within a network processor. The “fly by” processing style of a network processor permits it to look at each byte of a packet as it passes through, using registers and other alternatives to memory access. The network processor's “stateless forwarding” operation is best suited for tasks not involving complex calculations that require rapid updating of state information.

An appropriate internal protocol may be provided for exchanging information between the network interface engine 1030 and the transport engine 1050 when setting up or terminating a TCP and/or UDP connections and to transfer packets between the two engines. For example, where the distributive interconnection medium is a switch fabric, the internal protocol may be implemented as a set of messages exchanged across the switch fabric. These messages indicate the arrival of new inbound or outbound connections and contain inbound or outbound packets on existing connections, along with identifiers or tags for those connections. The internal protocol may also be used to transfer identifiers or tags between the transport engine 1050 and the application processing engine 1070 and/or the storage processing engine 1040. These identifiers or tags may be used to reduce or strip or accelerate a portion of the protocol stack.

For example, with a TCP/IP connection, the network interface engine 1030 may receive a request for a new connection. The header information associated with the initial request may be provided to the transport processing engine 1050 for processing. That result of this processing may be stored in the resources of the transport processing engine 1050 as state and management information for that particular network session. The transport processing engine 1050 then informs the network interface engine 1030 as to the location of these results. Subsequent packets related to that connection that are processed by the network interface engine 1030 may have some of the header information stripped and replaced with an identifier or tag that is provided to the transport processing engine 1050. The identifier or tag may be a pointer, index or any other mechanism that provides for the identification of the location in the transport processing engine of the previously setup state and management information (or the corresponding network session). In this manner, the transport processing engine 1050 does not have to process the header information of every packet of a connection. Rather, the transport interface engine merely receives a contextually meaningful identifier or tag that identifies the previous processing results for that connection.

In one embodiment, the data link, network, transport and session layers (layers 2-5) of a packet may be replaced by identifier or tag information. For packets related to an established connection the transport processing engine does not have to perform intensive processing with regard to these layers such as hashing, scanning, look up, etc. operations. Rather, these layers have already been converted (or processed) once in the transport processing engine and the transport processing engine just receives the identifier or tag provided from the network interface engine that identifies the location of the conversion results.

In this manner an identifier or tag is provided for each packet of an established connection so that the more complex data computations of converting header information may be replaced with a more simplistic analysis of an identifier or tag. The delivery of content is thereby accelerated, as the time for packet processing and the amount of system resources for packet processing are both reduced. The functionality of network processors, which provide efficient parallel processing of packet headers, is well suited for enabling the acceleration described herein. In addition, acceleration is further provided as the physical size of the packets provided across the distributed interconnect may be reduced.

Though described herein with reference to messaging between the network interface engine and the transport processing engine, the use of identifiers or tags may be utilized amongst all the engines in the modular pipelined processing described herein. Thus, one engine may replace packet or data information with contextually meaningful information that may require less processing by the next engine in the data and communication flow path. In addition, these techniques may be utilized for a wide variety of protocols and layers, not just the exemplary embodiments provided herein.

With the above-described tasks being performed by the network interface engine, the transport engine may perform TCP sequence number processing, acknowledgement and retransmission, segmentation and reassembly, and flow control tasks. These tasks generally call for storing and modifying connection state information on each TCP and UDP connection, and therefore are considered more appropriate for the processing capabilities of general purpose processors.

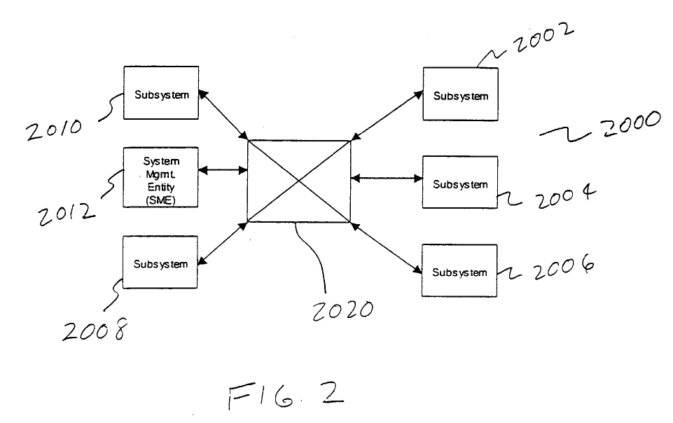

As will be discussed with references to alternative embodiments (such as FIGS. 2 and 2A), the transport engine 1050 and the network interface engine 1030 may be combined into a single engine. Such a combination may be advantageous as communication across the switch fabric is not necessary for protocol processing. However, limitations of many commercially available network processors make the split protocol stack processing described above desirable.

Application Processing Engine

Application processing engine 1070 may be provided in content delivery system 1010 for application processing, and may be, for example, any hardware or hardware/software subsystem suitable for session layer protocol processing (e.g., HTTP, RTSP streaming, etc.) of content requests received from network transport processing engine 1050. In one embodiment application processing engine 1070 may be a dedicated application processing module based on an INTEL PENTIUM III processor running, for example, on standard x86 OS systems (e.g., Linux, Windows NT, FreeBSD, etc.). Application processing engine 1070 may be utilized for dedicated application-only processing by virtue of the off-loading of all network protocol and storage processing elsewhere in content delivery system 1010. In one embodiment, processor programming for application processing engine 1070 may be generally similar to that of a conventional server, but without the tasks off-loaded to network interface processing engine 1030, storage processing engine 1040, and transport processing engine 1050.

Storage Management Engine

Storage management engine 1040 may be any hardware or hardware/software subsystem suitable for effecting delivery of requested content from content sources (for example content sources 1090 and/or 1100) in response to processed requests received from application processing engine 1070. It will also be understood that in various embodiments a storage management engine 1040 may be employed with content sources other than disk drives (e.g., solid state storage, the storage systems described above, or any other media suitable for storage of data) and may be programmed to request and receive data from these other types of storage.

In one embodiment, processor programming for storage management engine 1040 may be optimized for data retrieval using techniques such as caching, and may include and maintain a disk cache to reduce the relatively long time often required to retrieve data from content sources, such as disk drives. Requests received by storage management engine 1040 from application processing engine 1070 may contain information on how requested data is to be formatted and its destination, with this information being comprehensible to transport processing engine 1050 and/or network interface processing engine 1030. The storage management engine 1040 may utilize a disk cache to reduce the relatively long time it may take to retrieve data stored in a storage medium such as disk drives. Upon receiving a request, storage management engine 1040 may be programmed to first determine whether the requested data is cached, and then to send a request for data to the appropriate content source 1090 or 1100. Such a request may be in the form of a conventional read request. The designated content source 1090 or 1100 responds by sending the requested content to storage management engine 1040, which in turn sends the content to transport processing engine 1050 for forwarding to network interface processing engine 1030.

Based on the data contained in the request received from application processing engine 1070, storage processing engine 1040 sends the requested content in proper format with the proper destination data included. Direct communication between storage processing engine 1040 and transport processing engine 1050 enables application processing engine 1070 to be bypassed with the requested content. Storage processing engine 1040 may also be configured to write data to content sources 1090 and/or 1100 (e.g., for storage of live or broadcast streaming content).

In one embodiment storage management engine 1040 may be a dedicated block-level cache processor capable of block level cache processing in support of thousands of concurrent multiple readers, and direct block data switching to network interface engine 1030. In this regard storage management engine 1040 may utilize a POWER PC 7450 processor in conjunction with ECC memory and a LSI SYMFC929 dual 2GBaud fibre channel controller for fibre channel interconnect to content sources 1090 and/or 1100 via dual fibre channel arbitrated loop 1092. It will be recognized, however, that other forms of interconnection to storage sources suitable for retrieving content are also possible. Storage management engine 1040 may include hardware and/or software for running the Fibre Channel (FC) protocol, the SCSI (Small Computer Systems Interface) protocol, iSCSI protocol as well as other storage networking protocols.

Storage management engine 1040 may employ any suitable method for caching data, including simple computational caching algorithms such as random removal (RR), first-in first-out (FIFO), predictive read-ahead, over buffering, etc. algorithms. Other suitable caching algorithms include those that consider one or more factors in the manipulation of content stored within the cache memory, or which employ multi-level ordering, key based ordering or function based calculation for replacement. In one embodiment, storage management engine may implement a layered multiple LRU (LMLRU) algorithm that uses an integrated block/buffer management structure including at least two layers of a configurable number of multiple LRU queues and a two-dimensional positioning algorithm for data blocks in the memory to reflect the relative priorities of a data block in the memory in terms of both recency and frequency. Such a caching algorithm is described in further detail in co-pending U.S. patent application Ser. No. 09/797,198, entitled “Systems and Methods for Management of Memory” by Qiu et. al, the disclosure of which is incorporated herein by reference.

For increasing delivery efficiency of continuous content, such as streaming multimedia content, storage management engine 1040 may employ caching algorithms that consider the dynamic characteristics of continuous content. Suitable examples include, but are not limited to, interval caching algorithms. In one embodiment, improved caching performance of continuous content may be achieved using an LMLRU caching algorithm that weighs ongoing viewer cache value versus the dynamic time-size cost of maintaining particular content in cache memory. Such a caching algorithm is described in further detail in co-pending U.S. patent application Ser. No. 09/797,201, entitled “Systems and Methods for Management of Memory in Information Delivery Environments” by Qiu et. al, the disclosure of which is incorporated herein by reference.

System Management Engine

System management (or host) engine 1060 may be present to perform system management functions related to the operation of content delivery system 1010. Examples of system management functions include, but are not limited to, content provisioning/updates, comprehensive statistical data gathering and logging for sub-system engines, collection of shared user bandwidth utilization and content utilization data that may be input into billing and accounting systems, “on the fly” ad insertion into delivered content, customer programmable sub-system level quality of service (“QoS”) parameters, remote management (e.g., SNMP, web-based, CLI), health monitoring, clustering controls, remote/local disaster recovery functions, predictive performance and capacity planning, etc. In one embodiment, content delivery bandwidth utilization by individual content suppliers or users (e.g., individual supplier/user usage of distributive interchange and/or content delivery engines) may be tracked and logged by system management engine 1060, enabling an operator of the content delivery system 1010 to charge each content supplier or user on the basis of content volume delivered.

System management engine 1060 may be any hardware or hardware/software subsystem suitable for performance of one or more such system management engines and in one embodiment may be a dedicated application processing module based, for example, on an INTEL PENTIUM III processor running an x86 OS. Because system management engine 1060 is provided as a discrete modular engine, it may be employed to perform system management functions from within content delivery system 1010 without adversely affecting the performance of the system. Furthermore, the system management engine 1060 may maintain information on processing engine assignment and content delivery paths for various content delivery applications, substantially eliminating the need for an individual processing engine to have intimate knowledge of the hardware it intends to employ.

Under manual or scheduled direction by a user, system management processing engine 1060 may retrieve content from the network 1020 or from one or more external servers on a second network 1024 (e.g., LAN) using, for example, network file system (NFS) or common internet file system (CIFS) file sharing protocol. Once content is retrieved, the content delivery system may advantageously maintain an independent copy of the original content, and therefore is free to employ any file system structure that is beneficial, and need not understand low level disk formats of a large number of file systems.

Management interface 1062 may be provided for interconnecting system management engine 1060 with a network 1200 (e.g., LAN), or connecting content delivery system 1010 to other network appliances such as other content delivery systems 1010, servers, computers, etc. Management interface 1062 may be by any suitable network interface, such as 10/100 Ethernet, and may support communications such as management and origin traffic. Provision for one or more terminal management interfaces (not shown) for may also be provided, such as by RS-232 port, etc. The management interface may be utilized as a secure port to provide system management and control information to the content delivery system 1010. For example, tasks which may be accomplished through the management interface 1062 include reconfiguration of the allocation of system hardware (as discussed below with reference to FIGS. 1C-1F), programming the application processing engine, diagnostic testing, and any other management or control tasks. Though generally content is not envisioned being provided through the management interface, the identification of or location of files or systems containing content may be received through the management interface 1062 so that the content delivery system may access the content through the other higher bandwidth interfaces.

Management Performed by the Network Interface

Some of the system management functionality may also be performed directly within the network interface processing engine 1030. In this case some system policies and filters may be executed by the network interface engine 1030 in real-time at wirespeed. These polices and filters may manage some traffic/bandwidth management criteria and various service level guarantee policies. Examples of such system management functionality of are described below. It will be recognized that these functions may be performed by the system management engine 1060, the network interface engine 1030, or a combination thereof.

For example, a content delivery system may contain data for two web sites. An operator of the content delivery system may guarantee one web site (“the higher quality site”) higher performance or bandwidth than the other web site (“the lower quality site”), presumably in exchange for increased compensation from the higher quality site. The network interface processing engine 1030 may be utilized to determine if the bandwidth limits for the lower quality site have been exceeded and reject additional data requests related to the lower quality site. Alternatively, requests related to the lower quality site may be rejected to ensure the guaranteed performance of the higher quality site is achieved. In this manner the requests may be rejected immediately at the interface to the external network and additional resources of the content delivery system need not be utilized. In another example, storage service providers may use the content delivery system to charge content providers based on system bandwidth of downloads (as opposed to the traditional storage area based fees). For billing purposes, the network interface engine may monitor the bandwidth use related to a content provider. The network interface engine may also reject additional requests related to content from a content provider whose bandwidth limits have been exceeded. Again, in this manner the requests may be rejected immediately at the interface to the external network and additional resources of the content delivery system need not be utilized.

Additional system management functionality, such as quality of service (QoS) functionality, also may be performed by the network interface engine. A request from the external network to the content delivery system may seek a specific file and also may contain Quality of Service (QoS) parameters. In one example, the QoS parameter may indicate the priority of service that a client on the external network is to receive. The network interface engine may recognize the QoS data and the data may then be utilized when managing the data and communication flow through the content delivery system. The request may be transferred to the storage management engine to access this file via a read queue, e.g., [Destination IP][Filename][File Type (CoS)][Transport Priorities (QoS)]. All file read requests may be stored in a read queue. Based on CoS/QoS policy parameters as well as buffer status within the storage management engine (empty, full, near empty, block seq#, etc), the storage management engine may prioritize which blocks of which files to access from the disk next, and transfer this data into the buffer memory location that has been assigned to be transmitted to a specific IP address. Thus based upon QoS data in the request provided to the content delivery system, the data and communication traffic through the system may be prioritized. The QoS and other policy priorities may be applied to both incoming and outgoing traffic flow. Therefore a request having a higher QoS priority may be received after a lower order priority request, yet the higher priority request may be served data before the lower priority request.

The network interface engine may also be used to filter requests that are not supported by the content delivery system. For example, if a content delivery system is configured only to accept HTTP requests, then other requests such as FTP, telnet, etc. may be rejected or filtered. This filtering may be applied directly at the network interface engine, for example by programming a network processor with the appropriate system policies. Limiting undesirable traffic directly at the network interface offloads such functions from the other processing modules and improves system performance by limiting the consumption of system resources by the undesirable traffic. It will be recognized that the filtering example described herein is merely exemplary and many other filter criteria or policies may be provided.

Multi-Processor Module Design

As illustrated in FIG. 1A, any given processing engine of content delivery system 1010 may be optionally provided with multiple processing modules so as to enable parallel or redundant processing of data and/or communications. For example, two or more individual dedicated TCP/UDP processing modules 1050a and 1050b may be provided for transport processing engine 1050, two or more individual application processing modules 1070a and 1070b may be provided for network application processing engine 1070, two or more individual network interface processing modules 1030a and 1030b may be provided for network interface processing engine 1030 and two or more individual storage management processing modules 1040a and 1040b may be provided for storage management processing engine 1040. Using such a configuration, a first content request may be processed between a first TCP/UDP processing module and a first application processing module via a first switch fabric path, at the same time a second content request is processed between a second TCP/UDP processing module and a second application processing module via a second switch fabric path. Such parallel processing capability may be employed to accelerate content delivery.

Alternatively, or in combination with parallel processing capability, a first TCP/UDP processing module 1050a may be backed-up by a second TCP/UDP processing module 1050b that acts as an automatic failover spare to the first module 1050a. In those embodiments employing multiple-port switch fabrics, various combinations of multiple modules may be selected for use as desired on an individual system-need basis (e.g., as may be dictated by module failures and/or by anticipated or actual bottlenecks), limited only by the number of available ports in the fabric. This feature offers great flexibility in the operation of individual engines and discrete processing modules of a content delivery system, which may be translated into increased content delivery acceleration and reduction or substantial elimination of adverse effects resulting from system component failures.

In yet other embodiments, the processing modules may be specialized to specific applications, for example, for processing and delivering HTTP content, processing and delivering RTSP content, or other applications. For example, in such an embodiment an application processing module 1070a and storage processing module 1040a may be specially programmed for processing a first type of request received from a network. In the same system, application processing module 1070b and storage processing module 1040b may be specially programmed to handle a second type of request different from the first type. Routing of requests to the appropriate respective application and/or storage modules may be accomplished using a distributive interconnect and may be controlled by transport and/or interface processing modules as requests are received and processed by these modules using policies set by the system management engine.

Further, by employing processing modules capable of performing the function of more than one engine in a content delivery system, the assigned functionality of a given module may be changed on an as-needed basis, either manually or automatically by the system management engine upon the occurrence of given parameters or conditions. This feature may be achieved, for example, by using similar hardware modules for different content delivery engines (e.g., by employing PENTIUM III based processors for both network transport processing modules and for application processing modules), or by using different hardware modules capable of performing the same task as another module through software programmability (e.g., by employing a POWER PC processor based module for storage management modules that are also capable of functioning as network transport modules). In this regard, a content delivery system may be configured so that such functionality reassignments may occur during system operation, at system boot-up or in both cases. Such reassignments may be effected, for example, using software so that in a given content delivery system every content delivery engine (or at a lower level, every discrete content delivery processing module) is potentially dynamically reconfigurable using software commands. Benefits of engine or module reassignment include maximizing use of hardware resources to deliver content while minimizing the need to add expensive hardware to a content delivery system.

Thus, the system disclosed herein allows various levels of load balancing to satisfy a work request. At a system hardware level, the functionality of the hardware may be assigned in a manner that optimizes the system performance for a given load. At the processing engine level, loads may be balanced between the multiple processing modules of a given processing engine to further optimize the system performance.

Exemplary Data and Communication Flow Paths

FIG. 1B illustrates one exemplary data and communication flow path configuration among modules of one embodiment of content delivery system 1010. The flow paths shown in FIG. 1B are just one example given to illustrate the significant improvements in data processing capacity and content delivery acceleration that may be realized using multiple content delivery engines that are individually optimized for different layers of the software stack and that are distributively interconnected as disclosed herein. The illustrated embodiment of FIG. 1B employs two network application processing modules 1070a and 1070b, and two network transport processing modules 1050a and 1050b that are communicatively coupled with single storage management processing module 1040a and single network interface processing module 1030a. The storage management processing module 1040a is in turn coupled to content sources 1090 and 1100. In FIG. 1B, inter-processor command or control flow (i.e. incoming or received data request) is represented by dashed lines, and delivered content data flow is represented by solid lines. Command and data flow between modules may be accomplished through the distributive interconnection 1080 (not shown), for example a switch fabric.

As shown in FIG. 1B, a request for content is received and processed by network interface processing module 1030a and then passed on to either of network transport processing modules 1050a or 1050b for TCP/UDP processing, and then on to respective application processing modules 1070a or 1070b, depending on the transport processing module initially selected. After processing by the appropriate network application processing module, the request is passed on to storage management processor 1040a for processing and retrieval of the requested content from appropriate content sources 1090 and/or 1100. Storage management processing module 1040a then forwards the requested content directly to one of network transport processing modules 1050a or 1050b, utilizing the capability of distributive interconnection 1080 to bypass application processing modules 1070a and 1070b. The requested content may then be transferred via the network interface processing module 1030a to the external network 1020. Benefits of bypassing the application processing modules with the delivered content include accelerated delivery of the requested content and offloading of workload from the application processing modules, each of which translate into greater processing efficiency and content delivery throughput. In this regard, throughput is generally measured in sustained data rates passed through the system and may be measured in bits per second. Capacity may be measured in terms of the number of files that may be partially cached, the number of TCP/IP connections per second as well as the number of concurrent TCP/IP connections that may be maintained or the number of simultaneous streams of a certain bit rate. In an alternative embodiment, the content may be delivered from the storage management processing module to the application processing module rather than bypassing the application processing module. This data flow may be advantageous if additional processing of the data is desired. For example, it may be desirable to decode or encode the data prior to delivery to the network.

To implement the desired command and content flow paths between multiple modules, each module may be provided with means for identification, such as a component ID. Components may be affiliated with content requests and content delivery to effect a desired module routing. The data-request generated by the network interface engine may include pertinent information such as the component ID of the various modules to be utilized in processing the request. For example, included in the data request sent to the storage management engine may be the component ID of the transport engine that is designated to receive the requested content data. When the storage management engine retrieves the data from the storage device and is ready to send the data to the next engine, the storage management engine knows which component ID to send the data to.

As further illustrated in FIG. 1B, the use of two network transport modules in conjunction with two network application processing modules provides two parallel processing paths for network transport and network application processing, allowing simultaneous processing of separate content requests and simultaneous delivery of separate content through the parallel processing paths, further increasing throughput/capacity and accelerating content delivery. Any two modules of a given engine may communicate with separate modules of another engine or may communicate with the same module of another engine. This is illustrated in FIG. 1B where the transport modules are shown to communicate with separate application modules and the application modules are shown to communicate with the same storage management module.

FIG. 1B illustrates only one exemplary embodiment of module and processing flow path configurations that may be employed using the disclosed method and system. Besides the embodiment illustrated in FIG. 1B, it will be understood that multiple modules may be additionally or alternatively employed for one or more other network content delivery engines (e.g., storage management processing engine, network interface processing engine, system management processing engine, etc.) to create other additional or alternative parallel processing flow paths, and that any number of modules (e.g., greater than two) may be employed for a given processing engine or set of processing engines so as to achieve more than two parallel processing flow paths. For example, in other possible embodiments, two or more different network transport processing engines may pass content requests to the same application unit, or vice-versa.

Thus, in addition to the processing flow paths illustrated in FIG. 1B, it will be understood that the disclosed distributive interconnection system may be employed to create other custom or optimized processing flow paths (e.g., by bypassing and/or interconnecting any given number of processing engines in desired sequence/s) to fit the requirements or desired operability of a given content delivery application. For example, the content flow path of FIG. 1B illustrates an exemplary application in which the content is contained in content sources 1090 and/or 1100 that are coupled to the storage processing engine 1040. However as discussed above with reference to FIG. 1A, remote and/or live broadcast content may be provided to the content delivery system from the networks 1020 and/or 1024 via the second network interface connection 1023. In such a situation the content may be received by the network interface engine 1030 over interface connection 1023 and immediately re-broadcast over interface connection 1022 to the network 1020. Alternatively, content may be proceed through the network interface connection 1023 to the network transport engine 1050 prior to returning to the network interface engine 1030 for re-broadcast over interface connection 1022 to the network 1020 or 1024. In yet another alternative, if the content requires some manner of application processing (for example encoded content that may need to be decoded), the content may proceed all the way to the application engine 1070 for processing. After application processing the content may then be delivered through the network transport engine 1050, network interface engine 1030 to the network 1020 or 1024.

In yet another embodiment, at least two network interface modules 1030a and 1030b may be provided, as illustrated in FIG. 1A. In this embodiment, a first network interface engine 1030a may receive incoming data from a network and pass the data directly to the second network interface engine 1030b for transport back out to the same or different network. For example, in the remote or live broadcast application described above, first network interface engine 1030a may receive content, and second network interface engine 1030b provide the content to the network 1020 to fulfill requests from one or more clients for this content. Peer-to-peer level communication between the two network interface engines allows first network interface engine 1030a to send the content directly to second network interface engine 1030b via distributive interconnect 1080. If necessary, the content may also be routed through transport processing engine 1050, or through transport processing engine 1050 and application processing engine 1070, in a manner described above.

Still yet other applications may exist in which the content required to be delivered is contained both in the attached content sources 1090 or 1100 and at other remote content sources. For example in a web caching application, not all content may be cached in the attached content sources, but rather some data may also be cached remotely. In such an application, the data and communication flow may be a combination of the various flows described above for content provided from the content sources 1090 and 1100 and for content provided from remote sources on the networks 1020 and/or 1024.

The content delivery system 1010 described above is configured in a peer-to-peer manner that allows the various engines and modules to communicate with each other directly as peers through the distributed interconnect. This is contrasted with a traditional server architecture in which there is a main CPU. Furthermore unlike the arbitrated bus of traditional servers, the distributed interconnect 1080 provides a switching means which is not arbitrated and allows multiple simultaneous communications between the various peers. The data and communication flow may by-pass unnecessary peers such as the return of data from the storage management processing engine 1040 directly to the network interface processing engine 1030 as described with reference to FIG. 1B.

Communications between the various processor engines may be made through the use of a standardized internal protocol. Thus, a standardized method is provided for routing through the switch fabric and communicating between any two of the processor engines which operate as peers in the peer to peer environment. The standardized internal protocol provides a mechanism upon which the external network protocols may “ride” upon or be incorporated within. In this manner additional internal protocol layers relating to internal communication and data exchange may be added to the external protocol layers. The additional internal layers may be provided in addition to the external layers or may replace some of the external protocol layers (for example as described above portions of the external headers may be replaced by identifiers or tags by the network interface engine).

The standardized internal protocol may consist of a system of message classes, or types, where the different classes can independently include fields or layers that are utilized to identify the destination processor engine or processor module for communication, control, or data messages provided to the switch fabric along with information pertinent to the corresponding message class. The standardized internal protocol may also include fields or layers that identify the priority that a data packet has within the content delivery system. These priority levels may be set by each processing engine based upon system-wide policies. Thus, some traffic within the content delivery system may be prioritized over other traffic and this priority level may be directly indicated within the internal protocol call scheme utilized to enable communications within the system. The prioritization helps enable the predictive traffic flow between engines and end-to-end through the system such that service level guarantees may be supported.

Other internally added fields or layers may include processor engine state, system timestamps, specific message class identifiers for message routing across the switch fabric and at the receiving processor engine(s), system keys for secure control message exchange, flow control information to regulate control and data traffic flow and prevent congestion, and specific address tag fields that allow hardware at the receiving processor engines to move specific types of data directly into system memory.

In one embodiment, the internal protocol may be structured as a set, or system of messages with common system defined headers that allows all processor engines and, potentially, processor engine switch fabric attached hardware, to interpret and process messages efficiently and intelligently. This type of design allows each processing engine, and specific functional entities within the processor engines, to have their own specific message classes optimized functionally for the exchanging their specific types control and data information. Some message classes that may be employed are: System Control messages for system management, Network Interface to Network Transport messages, Network Transport to Application Interface messages, File System to Storage engine messages, Storage engine to Network Transport messages, etc. Some of the fields of the standardized message header may include message priority, message class, message class identifier (subtype), message size, message options and qualifier fields, message context identifiers or tags, etc. In addition, the system statistics gathering, management and control of the various engines may be performed across the switch fabric connected system using the messaging capabilities.

By providing a standardized internal protocol, overall system performance may be improved. In particular, communication speed between the processor engines across the switch fabric may be increased. Further, communications between any two processor engines may be enabled. The standardized protocol may also be utilized to reduce the processing loads of a given engine by reducing the amount of data that may need to be processed by a given engine.

The internal protocol may also be optimized for a particular system application, providing further performance improvements. However, the standardized internal communication protocol may be general enough to support encapsulation of a wide range of networking and storage protocols. Further, while internal protocol may run on PCI, PCI-X, ATM, IB, Infiniband, HyperTransport, Lightning I/O, the internal protocol is a protocol above these transport-level standards and is optimal for use in a switched (non-bus) environment such as a switch fabric. In addition, the internal protocol may be utilized to communicate devices (or peers) connected to the system in addition to those described herein. For example, a peer need not be a processing engine. In one example, a peer may be an ASIC protocol converter that is coupled to the distributed interconnect as a peer but operates as a slave device to other master devices within the system. The internal protocol may also be as a protocol communicated between systems such as used in the clusters described above.

Thus a system has been provided in which the networking/server clustering/storage networking has been collapsed into a single system utilizing a common low-overhead internal communication protocol/transport system.

Content Delivery Acceleration

As described above, a wide range of techniques have been provided for accelerating content delivery from the content delivery system 1010 to a network. By accelerating the speed at which content may be delivered, a more cost effective and higher performance system may be provided. These techniques may be utilized separately or in various combinations.

One content acceleration technique involves the use of a multi-engine system with dedicated engines for varying processor tasks. Each engine can perform operations independently and in parallel with the other engines without the other engines needing to yield or halt operations. The engines do not have to compete for resources such as memory, I/O, processor time, etc. but are provided with their own resources. Each engine may also be tailored in hardware and/or software to perform specific content delivery task, thereby providing increasing content delivery speeds while requiring less system resources. Further, all data, regardless of the flow path, gets processed in a staged pipeline fashion such that each engine continues to process its layer of functionality after forwarding data to the next engine/layer.

Content acceleration is also obtained from the use of multiple processor modules within an engine. In this manner, parallelism may be achieved within a specific processing engine. Thus, multiple processors responding to different content requests may be operating in parallel within one engine.

Content acceleration is also provided by utilizing the multi-engine design in a peer to peer environment in which each engine may communicate as a peer. Thus, the communications and data paths may skip unnecessary engines. For example, data may be communicated directly from the storage processing engine to the transport processing engine without have to utilize resources of the application processing engine.

Acceleration of content delivery is also achieved by removing or stripping the contents of some protocol layers in one processing engine and replacing those layers with identifiers or tags for use with the next processor engine in the data or communications flow path. Thus, the processing burden placed on the subsequent engine may be reduced. In addition, the packet size transmitted across the distributed interconnect may be reduced. Moreover, protocol processing may be off-loaded from the storage and/or application processors, thus freeing those resources to focus on storage or application processing.

Content acceleration is also provided by using network processors in a network endpoint system. Network processors generally are specialized to perform packet analysis functions at intermediate network nodes, but in the content delivery system disclosed the network processors have been adapted for endpoint functions. Furthermore, the parallel processor configurations within a network processor allow these endpoint functions to be performed efficiently.

In addition, content acceleration has been provided through the use of a distributed interconnection such as a switch fabric. A switch fabric allows for parallel communications between the various engines and helps to efficiently implement some of the acceleration techniques described herein.

It will be recognized that other aspects of the content delivery system 1010 also provide for accelerated delivery of content to a network connection. Further, it will be recognized that the techniques disclosed herein may be equally applicable to other network endpoint systems and even non-endpoint systems.

Exemplary Hardware Embodiments

FIG. 1C (shown on two sheets as FIGS. 1C′ and 1C″ and collectively referred to herein as 1C) illustrates a network content delivery engine configurations possible with one exemplary hardware embodiment of content delivery system 1010. In the illustrated configuration of this hardware embodiment, content delivery system 1010 includes processing modules that may be configured to operate as content delivery engines 1030, 1040, 1050, 1060, and 1070 communicatively coupled via distributive interconnection 1080. As shown in FIG. 1C, a single processor module may operate as the network interface processing engine 1030 and a single processor module may operate as the system management processing engine 1060. Four processor modules 1001 may be configured to operate as either the transport processing engine 1050 or the application processing engine 1070. Two processor modules 1003 may operate as either the storage processing engine 1040 or the transport processing engine 1050. The Gigabit (Gb) Ethernet front end interface 1022, system management interface 1062 and dual fibre channel arbitrated loop 1092 are also shown.

As mentioned above, the distributive interconnect 1080 may be a switch fabric based interconnect. As shown in FIG. 1C, the interconnect may be an IBM PRIZMA-E eight/sixteen port switch fabric 1081. In an eight port mode, this switch fabric is an 8×3.54 Gbps fabric and in a sixteen port mode, this switch fabric is a 16×1.77 Gbps fabric. The eight/sixteen port switch fabric may be utilized in an eight port mode for performance optimization. The switch fabric 1081 may be coupled to the individual processor modules through interface converter circuits 1082, such as IBM UDASL switch interface circuits. The interface converter circuits 1082 convert the data aligned serial link interface (DASL) to a UTOPIA (Universal Test and Operations PHY Interface for ATM) parallel interface. FPGAs (field programmable gate array) may be utilized in the processor modules as a fabric interface on the processor modules as shown in FIG. IC. These fabric interfaces provide a 64/66 Mhz PCI interface to the interface converter circuits 1082. FIG. 1E illustrates a functional block diagram of such a fabric interface 34. As explained below, the interface 34 provides an interface between the processor module bus and the UDASL switch interface converter circuit 1082. As shown in FIG. 1E, at the switch fabric side, a physical connection interface 41 provides connectivity at the physical level to the switch fabric. An example of interface 41 is a parallel bus interface complying with the UTOPIA standard. In the example of FIG. 1E, interface 41 is a UTOPIA 3 interface providing a 32-bit 110 Mhz connection. However, the concepts disclosed herein are not protocol dependent and the switch fabric need not comply with any particular ATM or non ATM standard.

Still referring to FIG. 1E, SAR (segmentation and reassembly) unit 42 has appropriate SAR logic 42a for performing segmentation and reassembly tasks for converting messages to fabric cells and vice-versa as well as message classification and message class-to-queue routing, using memory. 42b and 42c for transmit and receive queues. This permits different classes of messages and permits the classes to have different priority. For example, control messages can be classified separately from data messages, and given a different priority. All fabric cells and the associated messages may be self routing, and no out of band signaling may be employed.

A special memory modification scheme permits one processor module to write directly into memory of another. This feature is facilitated by switch fabric interface 34 and in particular by its message classification capability. Commands and messages follow the same path through switch fabric interface 34, but can be differentiated from other control and data messages. In this manner, processes executing on processor modules can communicate directly using their own memory spaces.

Bus interface 43 permits switch fabric interface 34 to communicate with the processor of the processor module via the module device or I/O bus. An example of a suitable bus architecture is a PCI architecture, but other architectures could be used. Bus interface 43 is a master/target device, permitting interface 43 to write and be written to and providing appropriate bus control. The logic circuitry within interface 43 implements a state machine that provides the communications protocol, as well as logic for configuration and parity.

Referring again to FIG. 1C, network processor 1032 (for example a MOTOROLA C-Port C-5 network processor) of the network interface processing engine 1030 may be coupled directly to an interface converter circuit 1082 as shown. As mentioned above and further shown in FIG. 1C, the network processor 1032 also may be coupled to the network 1020 by using a VITESSE GbE SERDES (serializer-deserializer) device (for example the VSC7123) and an SFP (small form factor pluggable) optical transceiver for LC fibre connection.

The processor modules 1003 include a fibre channel (FC) controller as mentioned above and further shown in FIG. 1C. For example, the fibre channel controller may be the LSI SYMFC929 dual 2GBaud fibre channel controller. The fibre channel controller enables communication with the fibre channel 1092 when the processor module 1003 is utilized as a storage processing engine 1040. Also illustrated in FIG. 1C is optional adjunct processing unit 1300 that employs a POWER PC processor with SDRAM. The adjunct processing unit is shown coupled to network processor 1032 of network interface processing engine 1030 by a PCI interface. Adjunct processing unit 1300 may be employed for monitoring system parameters such as temperature, fan operation, system health, etc.

As shown in FIG. 1C, each processor module of content delivery engines 1030, 1040, 1050, 1060, and 1070 is provided with its own synchronous dynamic random access memory (“SDRAM”) resources, enhancing the independent operating capabilities of each module. The memory resources may be operated as ECC (error correcting code) memory. Network interface processing engine 1030 is also provided with static random access memory (“SRAM”). Additional memory circuits may also be utilized as will be recognized by those skilled in the art. For example, additional memory resources (such as synchronous SRAM and non-volatile FLASH and EEPROM) may be provided in conjunction with the fibre channel controllers. In addition, boot FLASH memory may also be provided on the of the processor modules.

As described above, the switch fabric (as used herein the terms switch fabric and fabric switch may be used interchangeably) may be a high performance full duplex switch fabric that links all of the major processing components of the Content Router into a cohesive system. For example, the switch fabric may be an IBM 3209K4060 (PRIZMA-E) 28.4 Gbps Packet Routing Switch. The switch fabric may support either 8/16 ports @ 3.54 Gbps per port or 16 ports @ 1.77 Gbps. In one embodiment, the 8 port configuration @ 3.54 Gbps/port is utilized for the Content Router. The IBM 28.4G Packet Routing Switch Databook provides more information regarding the IBM 3209K4060 Fabric Switch.

Asynchronous/Non-Asynchronous Data Media Interface

The disclosed systems and methods may be implemented to interface one or more asynchronous data media (e.g., a computing I/O bus medium) with one or more non-asynchronous data media (e.g., a non-asynchronous T/N medium) and, in one exemplary embodiment, may be implemented as an interface for a non-asynchronous distributed interconnect, e.g., as a fabric switch interface that may be utilized with switch fabrics that are incorporated into a variety of computing systems such as those systems described elsewhere herein. Further information is provided elsewhere herein on exemplary types of asynchronous and non-asynchronous data media, as well as exemplary systems in which such media may be interfaced using the disclosed systems and methods.

As used herein, “asynchronous data medium” refers to any hardware, software or combination thereof that is suitable for effecting data communication using signals that are not synchronized, or coordinated, in fixed time domains. Examples of asynchronous data media include, but are not limited to, computing I/O buses, asynchronous serial links, etc. In one exemplary embodiment, an asynchronous data medium may be a computing I/O bus (e.g., ISA, E-ISA, MicroChannel, VME, S-Bus, PCI-type bus such as PCI, PCI-X, other PCI-derivative bus, etc.) that is arbitrated and simplex in nature (e.g., with one common or single clock signal or domain) and to which data transfer access is granted in an arbitrary manner to one processing entity (e.g. processing engine or module) at a time. Such a computing I/O bus may employ a hardware-based signaling scheme to allow multiple processing entities to arbitrate (e.g., via request, grant, stop, etc.) for access to the bus, but otherwise have no specific provision for rate control. For example, during operation such a computing I/O bus may burst data in raw fashion using control signals and arbitration to identify the start and stop of transactions and the initiator/target pair. In one exemplary embodiment, transactions across a computing I/O bus may be further characterized as being arbitrated, asynchronous and variable in transaction size/rate.

As used herein, “non-asynchronous data medium” refers to any hardware, software or combination thereof that is suitable for effecting data communication using signals that are not asynchronous (e.g., isochronous, plesiochronous, etc.). Examples of non-asynchronous data media include, but are not limited to, non-asynchronous switch fabrics (e.g., cross-bar switch fabrics, ATM switch fabrics, cell-based, time division multiplexing (“TDM”) fabrics, etc.). In one exemplary embodiment, a non-asynchronous data medium may be a switch fabric employing T/N interconnect interface standards (e.g., such as UTOPIA Level 1/2/3/4, POS PHY Level 3/Level 4/Level 5, SPI-3/SPI-4/SPI-5, CSIX, or any other asynchronous interconnect standard) that employs duplex hardware flow-control and data operation (e.g., with independent transmit and receive clocks). Such a non-asynchronous switch fabric may employ hardware level flow control support for transmit and receive, employ isochronous or plesiochronous signals (e.g., using TDM/slotted or cell based), and provide access to multiple processing entities at a given time. For example, during operation such a T/N interconnect interface may employ specific data formats (usually cells, or packets) that identify device/port addresses in-band via specific data header fields and also carry certain data information (e.g., cyclical redundancy checking “CRC”, parity, flow control state, etc.) in fixed-size slots or cells. In one exemplary embodiment, transactions across a T/N interconnect interface may be further characterized as synchronous and deterministic.

In one embodiment, the interface systems and methods described herein may be implemented in any multi-node I/O interconnection hardware or hardware/software system suitable for distributing functionality by selectively interconnecting two or more devices of a system including, but not limited to, high speed interchange systems configured with one or more non-asynchronous. data media (e.g., non-asynchronous distributed interconnect such as switch fabric architecture) that is interfaced to one or more asynchronous data media (e.g., computing I/O bus architecture). As previously described, examples of switch fabric architectures include, but are not limited to, cross-bar switch fabrics, ATM switch fabrics, etc. Examples of computing I/O bus architectures include, but are not limited to, ISA, E-ISA, MicroChannel, VME, S-Bus, PCI, PCI-X, etc. However, it will also be understood that the disclosed systems and methods may be advantageously implemented in any other environment to interface one or more non-asynchronous data media to one or more asynchronous data media, including to interface any other non-asynchronous and/or asynchronous data medium types described elsewhere herein.

In one embodiment, the present disclosure provides a fabric switch interface. The fabric switch interface may be utilized to interface and interconnect a processing entity configured with an asynchronous data medium (e.g., computing I/O bus) to a non-asynchronous switch fabric data medium (e.g., T/N switch fabric). The disclosed fabric switch interface may be utilized with switch fabrics that are incorporated into a variety of computing systems, including any of those systems described elsewhere herein or described in the references incorporated by reference herein. For example, the computing system may be an information management system such as content delivery system (also referred to herein as a content router), or any other computing system or information management system. The interfaces between processing entities (e.g., subsystems or processing engines) across a switch fabric of such a system are described in more detail below.

As is well known in basic networking applications, utilizing logical entities that exchange information across an interconnected medium generally requires the ability to resolve entity location via an addressing scheme, standardization of the format of exchanged information for proper interpretation, control and management of information flow (by data unit and/or by data stream), and state management for communicating nodes. In one embodiment of the fabric switch interface provided herein, the interconnecting medium for two or more attached nodes (e.g., for all attached nodes) may be a cell-based switch fabric. In such an embodiment, all information passed through the switch fabric is transferred in cell units. However, logical entities convey information in logical messages (Protocol Data Units <PDUs>; see following “terms” section) that can span physical cells. Addressing is fixed per the characteristics of the fabric switch. These mechanics may be characterized as being similar to ATM (“Asynchronous Transfer Mode”).

A variety of terms used herein are defined in Table 1 (e.g., as may be used in reference to an information management system embodiment, such as a content router embodiment).

TABLE 1

| Item | Definition/Comments |
|---|---|
| Subsystem | A logically defined software/firmware processing entity component of |
| | an information management system. Some examples are: the storage |
| | processor engine (or Storage Subsystem), the network interface |
| | engine (Network Subsystem), the transport processor engine, the |
| | application processor engine, etc. |
| Fabric | A functional processing object (sub)component within a subsystem. |
| Functional | Some examples are: Data Cache and Data Flow Mgr. of the Storage |
| User Entity | Subsystem, the Network Protocol processor of the Network |
| (FUE) | Subsystem, etc. These entities speak one, or more, “fabric languages.” |
| Node | This term references the subsystem, the logical process which in may |
| | cases is a fabric switch driver, attached to a specific fabric switch port |
| | (see following). |
| Port | The ingress/egress addressable attachment point for a switch node |
| Cell | The fixed, uniform data unit size within a switch fabric. The |
| | exemplary switch fabric described above, may for example, support |
| | control, data and idle cell types. |
| Protocol | A logical packet or message unit that can span more than one cell. |
| Data Unit | Usually PDUs are moved across switch fabrics from node to node |
| (PDU) | without regard to the internal cell size. There are 2 kinds of PDUs, |
| | data and control PDUs for conveying information. These PDU types |
| | do not necessarily have a direct correspondence with the cell types |
| Message | This term is interchangeable with PDU (see above); message = PDU. |
| Packet | This term is equivalent to a data PDU for an information management |
| | system |
| Header | This term defines a fixed, uniform section of a cell or PDU. A cell |
| | header is mandated either in part, or entirety, by the switch fabric. A |
| | PDU header is logically defined to meet system requirements. |
| Byte/Octet | An eight bit field. For the purposes of this document, these terms are |
| | equivalent. |
| System | As provided herein this term may refer to the Host System or system |
| Manageme | processing engine which is the managing entity for an information |
| nt Entity | management system. |
| (SME) | |

FIG. 2 illustrates a system level view of one embodiment of an information management system 2000 with which the disclosed systems and methods may be implemented. In FIG. 2, a system-wide or system-level perspective is used to show one possible methodology/architecture of single, multi-component information management system 2000 as it may be implemented to operate when utilizing a non-asynchronous data medium 2020 as its primary interconnection medium. Within system 2000, a series of processing entities 2002, 2004, 2006, 2008, 2010 and 2010 are illustrated which may each contain one or more processing objects (e.g., related process/es also referred to herein functional user entities, “FUE”) that may interact with processing objects on other processing entities across non-asynchronous data medium 2020.

In one exemplary embodiment, information management system 2000 of FIG. 2 may be characterized as a functional multi-processor network connected computing system, for example such as system 1010 illustrated and described herein in relation to FIG. 1A. In such a system, each of processing entities 2002, 2004, 2006, 2008 and 2010 may be one or more processing engines interconnected by a switch fabric or other non-asynchronous distributive interconnect data medium, e.g., such as two or more of respective processing engines 1030, 1040, 1050 and/or 1070 of FIG. 1A, and/or a file processing engine as described in U.S. patent application Ser. No. 10/236,467 filed Sep. 6, 2002, and entitled “SYSTEM AND METHODS FOR READ/WRITE I/O OPTIMIZATION IN INFORMATION MANAGEMENT ENVIRONMENTS,” by Richter., the disclosure of which is incorporated. herein by reference. Processing entity 2012 may be, for example, one or more system management processing engines (“SME”) 1060 of FIG. 1A, which may be configured to be responsible for the initialization and management of all fabric subsystems and entities.

Although one exemplary embodiment is illustrated and described in FIG. 2 herein, it will be understood with benefit of this disclosure that the disclosed systems and methods may be implemented with any information management system configuration having at least two processing object components configured with asynchronous data media functionality (e.g., computing I/O bus or other suitable asynchronous data media or combination thereof) communicatively coupled together across one or more non-asynchronous data media (e.g., switch fabric or other suitable non-asynchronous data media or combination thereof). Specific examples of information management environments and/or information management system configurations with which the disclosed methods and systems may be advantageously employed are described in those United States patent application references that have been incorporated by reference herein. Specifically included are embodiments employing multiple non-asynchronous data media, e.g., clustered system embodiments using one or more non-asynchronous data media to distributively interconnect two or more information management systems such as described in co-pending U.S. patent application Ser. No. 09/797,413 filed on Mar. 1, 2001 which is entitled NETWORK CONNECTED COMPUTING SYSTEM, and other United States Patent Applications incorporated by reference herein.

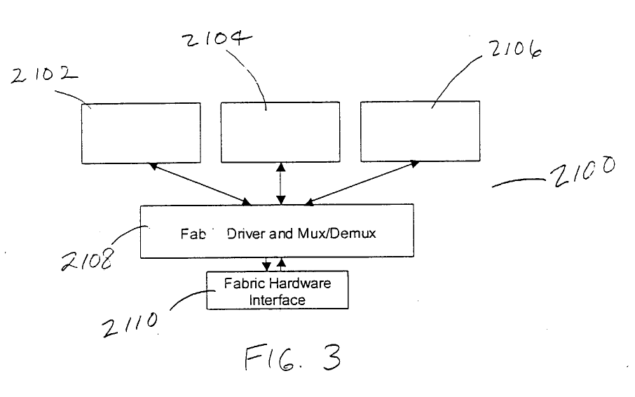

FIG. 3 illustrates one embodiment of a subsystem 2100 which may be, for example, one of processing entities 2002, 2004, 2006, 2008 or 2010. In FIG. 3, subsystem 2100 is shown having a set of processing objects (e.g., fabric-related processes or functional user entities) 2102, 2104 and 2106 resident thereon. Also illustrated in FIG. 3 is fabric driver and multiplexer/de-multiplexer entity 2108 and fabric hardware interface 2110. In one embodiment, processing objects 2102, 2104, 2106 may be standard OS driver interfaces (e.g., Ethernet, Block, etc.) multiplexed over/across fabric driver 2108. In one embodiment, fabric driver (also referred to herein as “Fab Driver”) 2108 may be an OS kernel driver.

FIG. 3 depicts how processing objects 2102, 2104 and 2106 may interact within subsystem 2100. Fabric driver 2108 is shown configured to access fabric hardware interface 2110 for the initialization and management of the fabric node hardware (UDASL, FabPCI, etc.), and for the transmission and reception of data via the switch fabric which is passed in PDU messages. Once again, although this exemplary embodiment is described in relation to a non-asynchronous switch fabric data medium, it will be understood that the disclosed systems and methods may be implemented with other types of non-asynchronous data media.

When the embodiment of FIG. 3 is implemented with a non-asynchronous switch fabric data medium, fabric messages may be exchanged with system defined headers. Basically, all messages may be conveyed with a target fabric address, which determines which node/subsystem it is destined for, and a field called a Message Class which determines which processing object (e.g., process or FUE) is the intended recipient. Much like internet protocol (“IP”), the Fab Driver layer, transfers PDUs across the Fabric Switch and uses the incoming PDUs' address and message class fields (message class being similar in function to the IP Protocol field) to determine the ultimate destination. Since the Fabric Switch utilizes multiple priorities, there is the potential for allowing data to reorder itself if a processing object uses multiple priorities within a given data stream, if so desired. The Fab Driver layer may be configured to detect rudimentary data loss and execute a basic form of flow control to prevent data loss. Processing objects may be configured to be responsible for reliable, orderly data flow between themselves at their layer. They may also be configured to be responsible for identifying processing objects on other processing entities with which they will interact. In one exemplary embodiment, a system management entity (“SME”) may be configured to assist in this detection process.

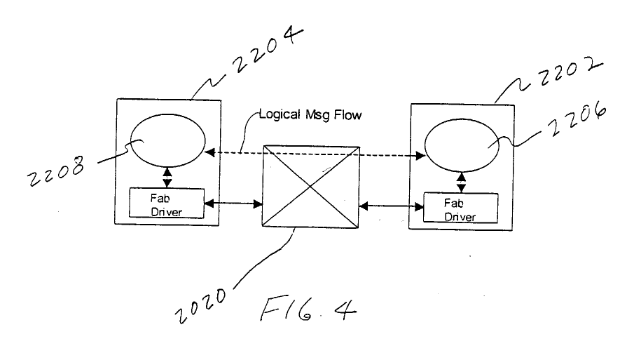

FIG. 4 depicts a logical overview of one embodiment of message passing (e.g., fabric messages) between two processing entities 2202 and 2204 and respective processing objects (e.g., functional user entities) 2206 and 2208 of an information management system across a non-asynchronous data medium 2020. One specific example of such an implementation is message passing between any given two processing entities 2002, 2004, 2006, 2008, 2010, 2012 (and their respective processing objects) of information management system 2000 of FIG. 2. Further information on possible communication and message passing methodology that may be employed between processing entities of an information management system may be found described in U.S. patent application Ser. No. 10/125,065 by Willman et. al. filed Apr. 18, 2002 and entitled “SYSTEMS AND METHODS FOR FACILITATING MEMORY ACCESS IN INFORMATION MANAGEMENT ENVIRONMENTS”, the disclosure of which is incorporated herein by reference.

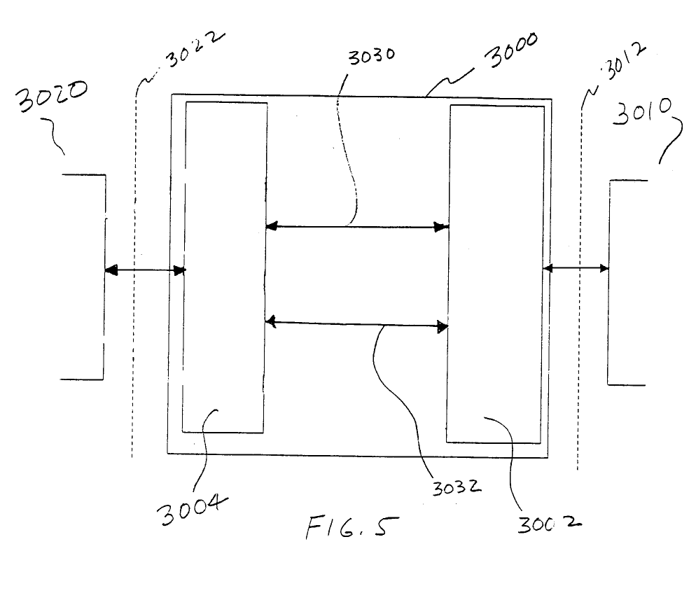

FIG. 5 illustrates one embodiment of an asynchronous/non-asynchronous (“A/N”) data media interface 3000 as it may be employed to interface asynchronous data medium 3010 (e.g., PCI I/O bus) to non-asynchronous data medium 3020 (e.g., switch fabric). In this regard, A/N data media interface 3000 may be configured to perform data format conversion and rate adaptation for data traffic between asynchronous data medium 3010 and non-asynchronous data medium 3020. Asynchronous data medium 3010 may in turn be communicatively coupled to any one or more processing entities that are configured to cooperatively communicate over synchronous data medium 3010, and non-asynchronous data medium 3020 may be communicatively coupled (e.g., distributively interconnected) to one or more other asynchronous data media or non-asynchronous data media. As shown in FIG. 5, a non-asynchronous interface 3022 is defined between A/N data media interface 3000 and non-asynchronous data medium 3020, and an asynchronous interface 3012 is defined between A/N data media interface 3000 and asynchronous data medium 3010. As previously described, in one embodiment A/N data media interface 3000 may be configured to interconnect one or more processing entities (e.g., processing engines) of an information management system.

Still referring to FIG. 5, A/N data media interface 3000 is configured with asynchronous communication engine (e.g., I/O state machine processor) 3002 and non-asynchronous communication engine (e.g., I/O state machine processor) 3004, which together may perform data format conversion and rate adaptation for data traffic between asynchronous interface 3012 and non-asynchronous interface 3022. In the illustrated embodiment, asynchronous communication engine 3002 and non-asynchronous communication engine 3004 are shown exchanging data-related information 3030 between non-asynchronous data media interface 3000 and asynchronous data media interface 3012. Asynchronous communication engine 3002 and non-asynchronous communication engine 3004 are also shown exchanging error/state/control information 3032.

In the illustrated embodiment, non-asynchronous communication engine 3004 is shown configured to communicate information that it receives directly or indirectly from asynchronous communication engine 3002 to non-asynchronous data medium 3020 in a non-asynchronous manner (e.g., as cells), and is shown configured to receive non-asynchronous information from non-asynchronous data medium 3020 and to communicate this information directly or indirectly to asynchronous communication engine 3002. Likewise, in the illustrated embodiment, asynchronous communication engine 3002 is shown configured to communicate information that it receives directly or indirectly from non-asynchronous communication engine 3004 to asynchronous data medium 3012 in an asynchronous manner (e.g., as PDU's), and is shown configured to receive asynchronous information from asynchronous data medium 3010 and to communicate this information directly or indirectly to non-asynchronous communication engine 3004.

In one embodiment, non-asynchronous communication engine 3004 may be configured to communicate with non-asynchronous data medium 3020 in any manner suitable for establishing and maintaining a non-asynchronous communication link between non-asynchronous communication engine 3004 and non-asynchronous data medium 3020. For example, non-asynchronous communication engine 3004 may be configured to operate using non-asynchronous operational parameters suitable for allowing communication with non-asynchronous data medium 3020, which may vary for a given application according to the particular type/s of non-asynchronous data medium 3020 in communication with non-asynchronous communication engine 3004. Specific examples of such parameters include, but are not limited to, cell size, cell transmit rate, cell receive rate, etc.

Furthermore, non-asynchronous communication engine 3004 may be configured so that its cell transmission and/or cell receive rates are psuedo-synchronized with non-asynchronous data medium 3020 to allow communication of cells therebetween. In one exemplary embodiment, non-asynchronous communication engine 3004 may be configured to generate “idle-cell” data to non-asynchronous interface 3022 whenever no information is available or communicated to non-asynchronous communication engine 3004 from asynchronous communication engine 3002, and/or to receive (and discard when appropriate) cell data received from non-asynchronous interface 3022.

In a similar manner, asynchronous communication engine 3002 may be configured to communicate with asynchronous data medium 3010 in any manner suitable for establishing and maintaining an asynchronous communication link between asynchronous communication engine 3002 and asynchronous data medium 3010. For example, asynchronous communication engine 3002 may be configured to operate using asynchronous operational parameters suitable for allowing communication with asynchronous data medium 3010, which may vary for a given application according to the particular type/s of asynchronous data medium 3010 in communication with asynchronous communication engine 3002. Specific examples of such parameters include, but are not limited to, maximum PCI data burst size, PCI latency, minimum PCI grant delay, etc.

Where appropriate, asynchronous communication engine 3002 may also be configured to arbitrate for communication opportunities (e.g., transmit and receive opportunities) across asynchronous interface 3012 to asynchronous data medium 3010. This arbitration may result in information flow latencies. Therefore, status of arbitration may be communicated to non-asynchronous communication engine 3004 for communication to non-asynchronous data medium 3020 along with any flow control information received from non-asynchronous data medium 3020, e.g., for information flow control purposes.

Multiple clock domains may be employed to “bridge” between asynchronous interface 3012 and non-asynchronous interface 3022. For example, in one embodiment, non-asynchronous communication engine 3004 may employ at least one clock domain for transmission and receipt of information across non-asynchronous interface 3022, and alternatively may employ two clock separate clock domains, one domain for transmission of information to non-asynchronous interface 3022 and one separate domain for receipt of information from non-asynchronous interface 3022. At least one separate clock domain (e.g., independent of clock domain/s employed by non-asynchronous communication engine 3004) may be employed by asynchronous communication engine 3002 for transmittal and receipt of information across asynchronous interface 3012. Buffering and signaling operations that are related to each of respective non-asynchronous communication engine 3004 and asynchronous communication engine 3002 may be segregated with respect to the clock domain/s of each respective engine 3004 and 3002. In this configuration, communication of non-asynchronous information across non-asynchronous interface 3022 may occur separately and independently of communication of asynchronous information across asynchronous interface 3012.

It will be understood with benefit of this disclosure that asynchronous communication engine 3002 and non-asynchronous communication engine 3004 may be communicatively coupled in any manner suitable for allowing A/N data media interface 3000 to communicate information from asynchronous interface 3012 to non-asynchronous interface 3022 (and vice-versa), in a rate adaptive manner as described elsewhere herein. In one embodiment, bursts of asynchronous information may be transmitted by A/N data media interface 3000 across asynchronous interface 3012 while non-asynchronous information is simultaneously transmitted (e.g., isochronously) across non-asynchronous interface 3022. In this regard, bursts of asynchronous information may be transmitted across asynchronous interface 3012 by asynchronous communication engine 3002, for example, using internal buffers.

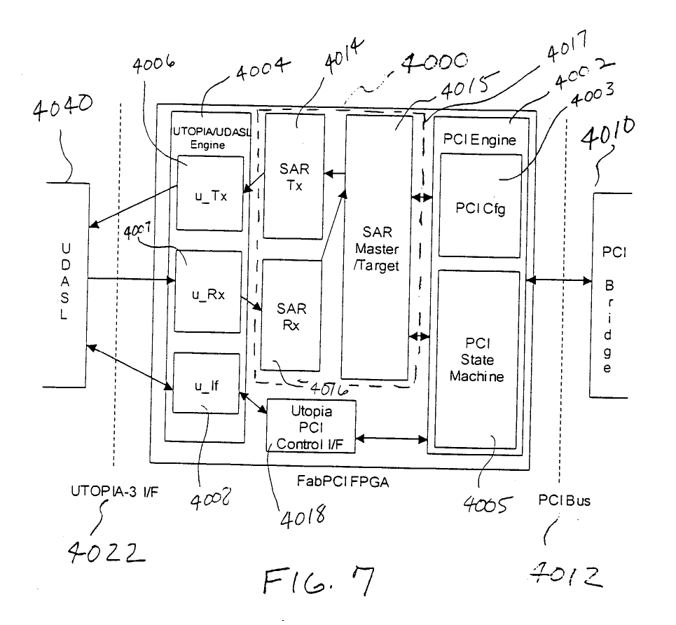

For transmission of non-asynchronous information across non-asynchronous interface 3022, asynchronous information received by asynchronous communication engine 3002 may be prepared into a non-asynchronous form compatible with non-asynchronous interface 3022 and/or non-asynchronous data medium 3020 (e.g., having appropriate cell size, header information, etc.). This task may be performed in any suitable manner by A/N data media interface 3000, for example, by asynchronous communication engine 3002, non-asynchronous communication engine 3004, by a separate logical entity (e.g., an information transformation logic such as transformation engine illustrated and described hereinbelow in FIG. 7) operating on A/N data media interface 3000, or a combination thereof. In one embodiment, asynchronous information may be received and staged for non-asynchronous transmittal (e.g., dis-aggregated into appropriate cell size, with appropriate cell headers, prior to non-asynchronous transmittal). Once non-asynchronous information is so prepared for transmittal, non-asynchronous communication engine 3004 may then transmit this non-asynchronous information (e.g., isochronously) across non-asynchronous interface 3022 to non-asynchronous data medium 3020. When information from asynchronous communication engine 3002 is not available for transmission, non-asynchronous communication engine 3004 may be configured to generate and transmit idling information (e.g., one or more idle cells) until such specific information is available for transmission.

For receipt of non-asynchronous information across non-asynchronous interface 3022, non-asynchronous information received by non-asynchronous communication engine 3004 may be prepared into an asynchronous form compatible with asynchronous interface 3012 and/or asynchronous data medium 3010. This task may be performed in any suitable manner by A/N data media interface 3000, for example, by asynchronous communication engine 3002, non-asynchronous communication engine 3004, by a separate logical entity operating on A/N data media interface 3000, or a combination thereof. For example, non-asynchronous communication engine 3004 may be configured to receive all incoming non-asynchronous information (e.g., incoming cells), and to process them by identifying and discarding idle cells, receiving and processing data cells (i.e., aggregating back into message units), etc. Cells may also be decoded for any target specific parameters, and then staged for transmittal to asynchronous communication engine 3002 for communication across asynchronous interface 3012.

In the illustrated embodiment, non-asynchronous communication engine 3004 may be configured to communicate error/state/control information 3032 (e.g., error events, state information, diagnostic information, etc.) to asynchronous communication engine 3002, e.g., for further communication across asynchronous data media interface 3012 to asynchronous data medium 3010. In a similar manner, asynchronous communication engine 3002 may be configured to communicate error/state/control information 3032 to non-asynchronous communication engine 3004, e.g., for use in maintaining non-asynchronous information flow control across non-asynchronous data media interface 3022.

Although one exemplary embodiment has been illustrated and described in relation to FIG. 5, it will be understood that the individual described tasks of engines 3002 and/or 3004 may be combined or partitioned in any manner that is suitable for performing the described tasks of A/N data media interface 3000. For example, the described tasks of engines 3002 and/or 3004 may be combined and performed by a single logical entity, or may be separated into multiple tasks that are performed by multiple logical entities, on one or more hardware devices, or a combination thereof. In this regard, details of just one possible exemplary implementation are described and illustrated in Example 2 herein.

### EXAMPLES

The following examples are illustrative and should not be construed as limiting the scope of the invention or claims thereof.

### Example 1

### A/N Data Media Interface Design Considerations for Exemplary Content Router System

Provided herein for use in the following example are cell and PDU definitions for communication, initialization, and management of Content Router subsystems employing a switch fabric distributed interconnect. In one example, the definition of these Cell and PDU headers, along with the accompanying field values and usages, may be employed using the disclosed systems and methods to meet the following exemplary design goals:

Efficiency: The ability to convey as much necessary information as possible in minimal amount of data space and retain some level of uniformity for interpretation amongst various subsystems (i.e. don't rely on a large set of dynamic headers that are conditionally present).

Compatibility: Maintain compatibility between the subsystems and their respective processing cores while at the same time maintaining compatibility with the functionality of the MOTOROLA C-Port C-5 network processor's Fabric Processing unit without the requirement of special hardware.

Extensibility: Create a design that allows future growth in both terms of interprocess communication, data flow and functional expansion.

Platform Independence: This category addresses switch fabric and processor independence. Issues related to specific implementations, such as cell header requirements, maximum cell size, priority and control management requirements, peripheral attachment unit design (DMA interfaces, etc.), and big/little endian-ness issues all may affect the fabric switch interface to a varying degree.

In one embodiment, the design of an A/N Data Media Interface for switch fabric configuration may be made in consideration of the previously mentioned specified considerations, design goals, as well as any constraints and/or restrictions that may be dictated or influenced by various selected hardware components that connect to, and interconnect with, the fabric switch in a given design application.

Following is a list of exemplary content router hardware components (e.g., that may be employed in an exemplary content router system embodiment as described elsewhere herein). Also included are parameters/design considerations associated with such components. These parameters/design considerations are given below for illustrative purposes only, i.e., to illustrate just one example of A/N Data Media Interface design considerations based on a given set of exemplary hardware components and parameters thereof. It will be understood that the following listed hardware and parameters/design considerations thereof are particular to the listed hardware and are exemplary only, and are therefore not limiting with respect to information management system (e.g., content router, etc.) implementations employing other types and/or combinations of hardware components. Further, the following parameters/design configurations represent relate to just one design implementation possible with the listed hardware, it being understood that other A/N Data Media Interface implementations and/or configurations are possible with the below-listed exemplary hardware.

MOTOROLA C-Port C-5 Fabric Processor (“FP”): supports fixed cell sizes between 48-252 bytes. The FP supports two (2) cell header sizes for initial PDU header and continuation header modes. The FP may be additionally configured for cell header and payload lengths to be in 32-bit multiples. Also, the FP utilizes idle cells to indicate end-of-PDU which induces a ‘cell tax’ per PDU.

IBM 3209K4060 Prizma Fabric Switch: The IBM Fabric Switch supports cell sizes in the 48-160 byte range. The maximum cell sizes allowed are based on the configuration of the IBM Fabric Switch based on its operational mode and the number of interconnected nodes supported.

UTOPIA/UDASL Interface: Currently, the UTOPIA-to-UDASL interface chip supports a maximum cell size of 80 bytes. This maximum cell size reduces the maximum cell payload and makes a reduction in PDU/cell header size desirable to reduce cell overhead.

Based on the preceding listed parameters of this example, a maximum cell size may be selected to be 80 bytes and two standard cell header sizes may be selected for use: one for beginning of PDU/message cells, and the other for continuation/interim cells. The IBM Fabric Switch supports cell sizes from 48 to 160 bytes with a fixed, three byte cell header. Due to the above-listed parameters, it may be desirable in this example that the maximum cell size be configured to be 80 bytes. Therefore, an exemplary Content Router may employ the maximum available cell size, 80 bytes, as its fixed cell size to reduce cell header and PDU message header overhead relative to payload.

In the exemplary embodiment of this example, two primary forms of messages may be employed: 1) data messages and 2) control messages. For example, Content Router messages (PDUs) may be mapped to the “blue cell’ category of the IBM 3209K4060 Prizma Fabric Switch. Further information regarding the Blue Data/Control cells may be found with reference to pp. 20-22 of the IBM 3209K4060 Databook, which is incorporated herein by reference. Each of these cells has an assignable 4-level priority that may be dynamically assigned to it on a per cell basis, and the exemplary Content Router of this example may be configured to use these priorities on a per-PDU basis. For the Content Router of this example, data cells that are not participating in network specific QoS algorithms may receive a priority level of “one” (1). Control cells may receive the highest level priority which is “zero” (0) (see IBM 3209K4060 Databook, pp. 21). In this exemplary configuration, no receive cell filters are needed.

In the exemplary configuration of this example, the IBM switch fabric may be configured to recognize three cell types: 1) Control cells, 2) Data cells, and 3) Idle cells. A set of common cell headers may be used for uniform message and data passing between Content Router subsystems. As previously mentioned, the exemplary fabric switch of this example may employ a predefined three-byte cell header. This fixed cell header may be employed as the start of a set of system-defined common cell headers that are specific to the exemplary Content Router design of this example. The first four bytes of all cells may be identical and comprise the Global Common cell header (“GCH”). The next eight bytes may be similar, but not identical, for Data and Control cells. The means that each PDU cell may have a fixed size, though the format of the fields following the GCH may be dependent on the type of cell. After this initial 12 bytes, all PDUs may be allowed the ability to have a conditional amount of extension header space. This allows, for example, entities communicating across the switch fabric to tailor message headers, beyond the fixed cell header definitions, to match their needs.

### Example 2

### A/N Data Media Interface Implementation for Content Router System

In the Examples described herein, the following exemplary addressing and bit/byte notation are used for cell definitions. In this regard, all structures are shown herein in a lowest order to highest order memory address fashion using ‘offset notation’ to describe a field's position relative to its base address in memory. This notation is also synonymous with the serial bit order in which PDU/Cell data may be transferred to and from a Prizma-E switch fabric on its serial interface (DASL). For the UTOPIA interface, which may be a 32-bit parallel bus interface, the byte/bit at offset 0 (as used in the diagrams and notation herein), is the Most Significant Byte/Bit (MSB/MSb) which is similar to big-endian memory subsystems and is compliant with IBM and Motorola memory notation.

Therefore, the first field in the following diagrams and structures (regardless of size) is in the lowest order address; usually at offset zero. Subsequent fields occur in ascending address space. All multibyte fields, that are not strings, are represented in Network Byte Order (NBO) which is big endian. This means that the 16-bit hexadecimal value 0×1234 is stored in memory as 0×1234 (low to high order address space; offset ‘n’=0×12, offset ‘n+1’=0×34) whereas a little endian representation would be 0×3412 in memory. Octet based bit fields are left as-is by all standard representation notation.

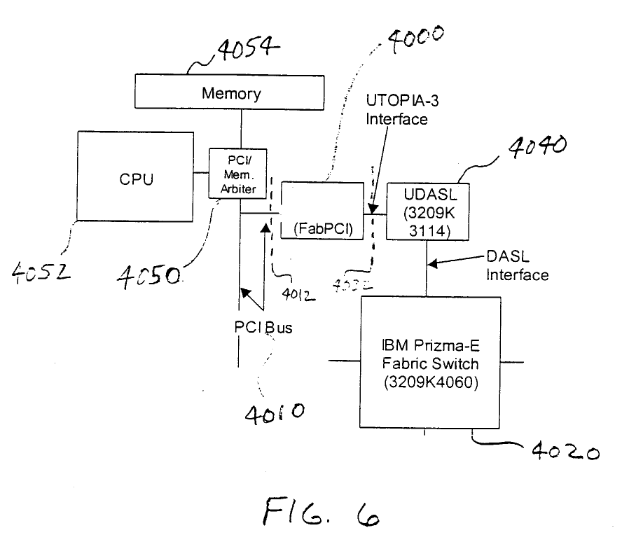

FIG. 6 illustrates one exemplary implementation of the disclosed A/N Data Media Interface 4000 which may be employed as a programmable bus interface (e.g., FabPCI FPGA) with one exemplary Content Router implementation having non-network processor (non-MOTOROLA-C-Port) subsystems, e.g., such as those Content Router implemenations employing a x86 Pentium or Motorola/IBM Power PC processor. In the illustrated embodiment of FIG. 6, A/N Data Media Interface 4000 may be employed to manage data and its associated descriptor information across an asynchronous PCI bus interface 4012 to asynchronous PCI I/O bus 4010 while managing a non-asynchronous UDASL (UTOPIA-3) interface 4022 to a non-asynchronous data medium on the backend (e.g., IBM 3209K3114 UDASL chip 4040 which is in turn coupled to a 3209K4060 IBM PRIZMA-E Fabric Switch 4020). As illustrated, asynchronous PCI bus 4010 couples A/N Data Media Interface 4000 to PCI/Memory Arbiter 4050 (e.g., ServerWorks/Intel Northbridge or Galileo Discovery GT 64260), which is in turn coupled to CPU 4052 (e.g., a x86 Pentium or Motorola/IBM Power PC processor) and to memory 4054 (SDRAM, DDRRAM, etc.).

In the exemplary embodiment of this example, A/N Data Media Interface 4000 may be implemented to provide an efficient and flexible DMA interface for data movement across computing I/O bus/es common to the x86 industry (e.g., PCI/PCI-X bus master devices) while maintaining characteristics of a Fabric Switch Interface (e.g., data priority). Efficiency may be realized by reducing the number of CPU instruction cycles and hardware bus cycles employed in the movement of data and in the constructing/decoding of data descriptor information. This may include, for example, directing the majority of the CPU read and write cycles to CPU memory instead of the PCI bus to maintain a higher performance level (i.e., utilizing memory bus speed and width versus PCI bus speed and width).

In the exemplary embodiment of this example, flexibility may be enhanced by providing the ability to handle memory structures of various forms and sizes in both embedded (linear=physical addresses) environments and in virtual memory environments. This includes scatter-gather capabilities for both transmit and receive paths. To take advantage of the multiple priority levels supported by Fabric Switch 4020, AIN Data Media Interface 4000 may be configured to support multiple (e.g., dual) output (receive) queues for control (high priority) PDUs and data (low priority) PDUs. This configuration may be implemented to advantageously enable data and control traffic to be processed in accordance with their associated priority levels.

FIG. 7 illustrates exemplary logic block diagram for A/N Data Media Interface 4000 as it may be implemented in this example, e.g., using a field programmable gate array (FPGA). However, besides FPGA it will be understood that an A/N Data Media Interface may be implemented using any other hardware and/or software combination suitable for accomplishing A/N Data Media Interface tasks and capabilities described herein, for example, using ASICs, etc. In the illustrated exemplary embodiment, A/N data media interface 4000 includes asynchronous communication engine 4002 and non-asynchronous communication engine 4004, which together may perform data format conversion and rate adaptation for data traffic between non-asynchronous UTOPIA interface 4022 and asynchronous PCI bus interface 4012. As illustrated, asynchronous communication engine 4002 and non-asynchronous communication engine 4004 are shown exchanging data-related information between non-asynchronous data media interface 4022 and asynchronous data media interface 4012 via an information transformation engine, in this embodiment, Segmentation and Reassembly (“SAR”) engine 4017. Asynchronous communication engine 4002 and non-asynchronous communication engine 4004 are also shown exchanging error/state/control information via Utopia PCI Control Interface 4018.

In the illustrated embodiment of FIG. 7, non-asynchronous communication engine 4004 is shown provided with UTOPIA/UDASL Transmit logic (“u_Tx”) 4006, UTOPIA/UDASL Receive logic (“u_Rx”) 4007 and UTOPIA/UDASL Interface Management Logic (“u_If”) 4008 for enabling communication of cells to and from non-asynchronous UTOPIA interface 4022. Asynchronous communication engine 4002 is provided with PCI Configuration Space (“PCI Cfg”) 4003, PCI State Machine 4005 and PCI Target Control logic for enabling communication of PDU's to and from synchronous PCI Bus interface 4012. Also illustrated in FIG. 7 are components of SAR engine 4017 that include Segmentation and Reassembly Transmit logic (“SAR Tx”) 4014, Segmentation and Reassembly Receive Logic (“SAR Rx”) 4016 and SAR Master/Target logic 4015 for communicating data between non-asynchronous communication engine 4004 and asynchronous communication engine 4002. Utopia PCI Control Interface 4018 is present for communicating control information between engines 4004 and 4002.

Referring to FIG. 7 in more detail, non-asynchronous communication engine 4004 is shown provided with u_Tx 4006 that is configured to be responsible for staging and transmitting cells generated by SAR_Tx logic 4014 across UTOPIA-3 interface 4022 to UDASL v2 chip 4040, and with u_Rx logic 4007 that is configured to receive cells from the UDASL v2 chip 4040 across the UTOPIA-3 interface 4022 and to stage them for processing and communication to SAR_Rx logic 4016. Non-asynchronous communication engine 4004 is also shown provided with u_If logic 4008 that is configured to manage UTOPIA-3 interface logic (data, address, grant, etc.). Asynchronous communication engine 4002 is provided with PCI Cfg logic 4003 that is configured to provide PCI v2.2 Configuration space logic, PCI State Machine logic 4005 that is configured to provide the DMA/Bus arbitration to support the FabPCI DMA features (as described elsewhere herein), and PCI Target Control logic that is configured to provide a PCI interface for controlling the logic blocks of SAR engine 4017. The logic blocks of SAR engine 4017 acting in combination with PC State Machine logic 4005 are also referred to herein as “FabPCI DMA engines” or “DMA engines” for one described exemplary embodiment. In this regard, SAR_Tx logic 4014 and SAR_Rx logic 4016 may be configured to interact with SAR Master/Target 4015 in a manner as described further herein, and SAR Master/Target 4015 may be configured to drive (e.g., schedule, arbitrate, prioritize, etc.) necessary bus mastering operations through PCI State Machine logic 4005 to support operations of SAR Rx logic 4016 and SAR Tx logic 4014 in a manner as described further herein.

Still referring to FIG. 7, SAR Tx logic 4014 is shown configured to accept PDUs from SAR Master/Target logic 4015 for transmission via u_Tx logic 4006 of communication engine 4004 across UTOPIA-3 interface 4022 to non-asynchronous UDASL data medium 4040. In this regard, SAR Tx logic 4014 may be configured to process PDU-to-cell generation logic as will be described hereinbelow. Likewise, SAR Rx logic 4016 is shown configured to receive cells from non-asynchronous UDASL data medium 4040 across non-asynchronous UTOPIA-3 interface 4022 via u_Rx logic 4007. SAR Rx logic 4016 may be configured to convert incoming cells to PDUs (e.g., via the process described herein) and to pass them on to SAR Master/Target 4015. SAR Master/Target logic 4015 is shown configured to drive necessary bus mastering operations through PCI State Machine logic 4005 to support operations of SAR Rx logic 4016 and SAR Tx logic 4014. In this regard, Target logic in SAR Master/Target logic 4015 may be configured to manage all of the PCI target transactions destined for, or originating from, the SAR logic blocks. Utopia PCI Control Interface logic 4018 is shown configured to provide a PCI target interface (BAR 2) for initializing and managing UDASL v2 chip 4040 via UTOPIA signals.

### Example 3

### Exemplary Configuration for A/N Data Media Interface Implementation of Example 2

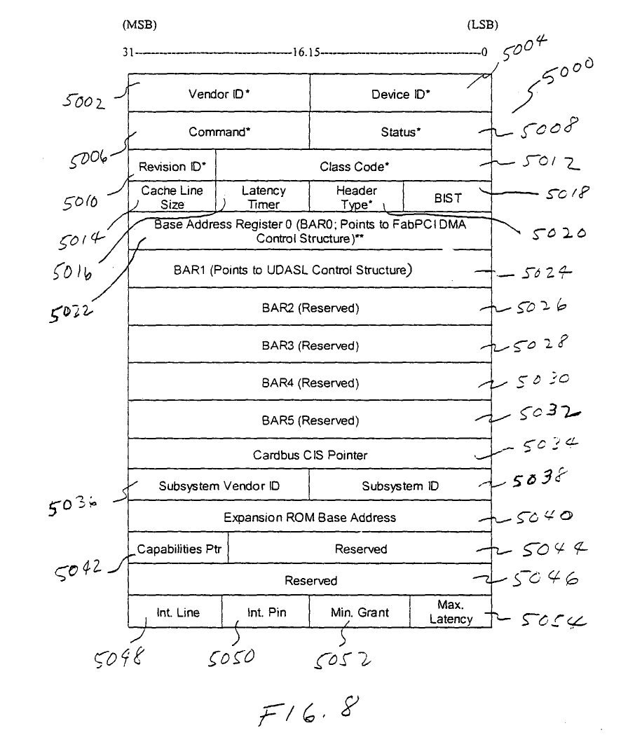

FIG. 8 illustrates just one exemplary embodiment of PCI configuration space layout that may be employed in the A/N Data Media Interface implementation of Example 2. In the illustrated embodiment, All PCI fields and values are natively little-endian. Description and exemplary information for these fields in one embodiment are listed below. It will be understood that the below indicated values and other information described in relation to any one or more of the following fields are exemplary only, and that they may vary in value, or may be absent in other embodiments. Further, those fields not supported in this exemplary embodiment, may be supported in other embodiments as desired or required to fit the needs of a given implementation of another embodiment/s.

Vendor ID field 5002: May be employed in one exemplary embodiment, and assigned per PCI v2.2 specification. (Initial preformal assignment value: 0xFDB9).

Device ID field 5004: May be employed in one exemplary embodiment, and assigned per PCI v2.2 specification. (Initial preformal assignment value: 0x7351).

Command field 5006: For one exemplary embodiment, this PCI field may be employed for all PCI devices and may be used as a writable Command register for programmatic device setup and initialization per PCI v2.2.

Status field 5008: For one exemplary embodiment, this PCI field my be employed for all PCI devices and is used as a readable Status register for a given PCI device to determine device status and capabilities.

Revision ID field 5010: This 8-bit PCI field identifies the version level of the PCI device. In one exemplary embodiment, this value may be 0x00.

Class Code field 5012: May be employed for one exemplary embodiment per PCI v2.2 specification.

Cache Line Size field 5014: This value matches the native cache line size of the associated host CPU. It is given on DWORD (4 byte/32-bit) multiples. For Intel Pentium III and PowerPC 750/74xx systems this value is 8 (8×4=32 bytes).

Latency Timer field 5016: Not supported for this exemplary embodiment (0x00).

Header Type field 5018: 0x00.

BIST field 5020: Not supported for this exemplary embodiment (0x00).

Base Address Register (“BAR”) 0 field 5020: This 32-bit address field provides the base physical address of the FabPCI DMA Control Structure. This area is the control interface for all FabPCI DMA and data activity. In this regard, the FabPCI DMA Control Structure format is defined hereinbelow.

Base Address Register 1 field 5022: This 32-bit address field provides the base physical address of the UDASL Control Structure.

Base Address Register fields 2-5 (elements 5026, 5028, 5030, and 5032 of FIG. 8): Not supported in this exemplary embodiment. Values are fixed at 0x00000000.

CardBus CIS Pointer field 5034: Not supported in this exemplary embodiment. Value fixed at 0x00000000.

Subsystem Vendor ID field 5036: Value fixed at 0x0000.

Subsystem ID field 5038: Value fixed at 0x0000.

Expansion ROM Base Address field 5040: Not supported in this exemplary embodiment. Value fixed at 0x00000000.

Capabilities Pointer field 5042: Not supported in this exemplary embodiment. Value fixed at 0x00.

Interrupt Line field 5048: Written by POST or PCI BIOS system software to provide Interrupt routing/level information to the PCI device (see pages 199,200 of PCI v2.2 Specification).

Interrupt Pin field 5050: 0x01 (INT#A; see page 200 of PCI v2.2 Specification).

Minimum Grant field 5052: Value 0x01 (see PCI version 2.2 for 64/66 MHz PCI buses).

Maximum Latency field 5054: Not supported in this exemplary embodiment. Value 0x00.

Fields 5044 and 5046: Reserved.

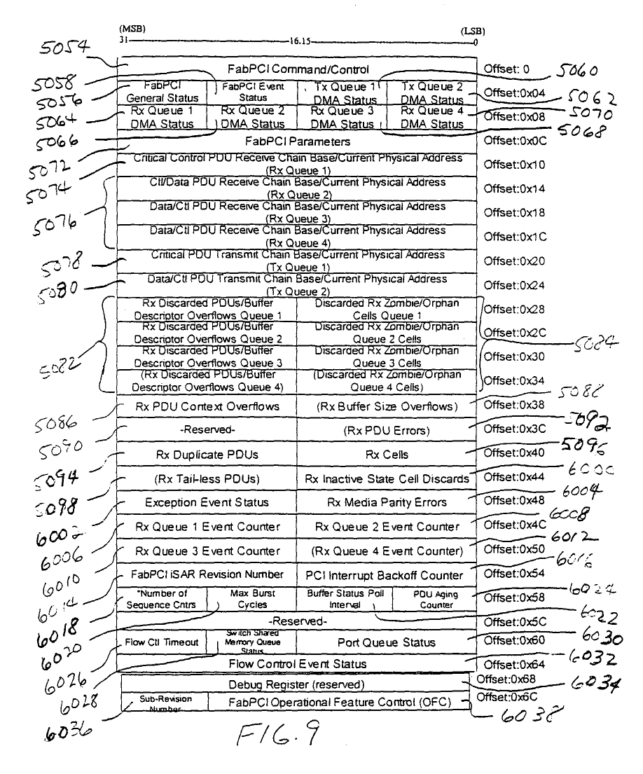

FIG. 9 illustrates just one exemplary embodiment of FabPCI DMA Control Structure Area that may be employed in the A/N Data Media Interface implementation of Example 2. As previously mentioned, FabPCI DMA Control Structure Area of FIG. 9 may be pointed to by BARO in PCI configuration space layout of FIG. 8. In the illustrated exemplary embodiment of FIG. 9, all PCI fields and values are natively little-endian, and the preceding fields are only accessible (read/write operations) as 32-bit words; byte and short (16-bit) word accesses are ignored. Further, all PCI fields encapsulated by parenthesis in FIG. 9 are not supported in this exemplary embodiment of FabPCI FPGA. Description and exemplary information for these fields in one embodiment are listed below. As with the layout of FIG. 8, it will be understood that the below indicated values and other information described in relation to any one or more of the following fields are exemplary only, and that they may vary in value, or may be absent in other embodiments. Further, those fields not supported in this exemplary embodiment, may be supported in other embodiments as desired or required to fit the needs of a given implementation of another embodiment/s.

FabPCI Command/Control field 5054: Write-only. This 32-bit, little-endian, memory mapped register serves as the command register for the Fabric DMA controller. Commands for the FabPCI DMA Controller are issued in one of two formats. Commands that can reference a specific queue instance of either the Tx or Rx DMA engines (i.e., a specific queues instance of either the SAR Tx logic 4014 or SAR Rx logic 4016 of FIG. 7) utilize the high-order 8-bits as the Tx/Rx queue identifier. Otherwise, the commands are issued as 32-bit unsigned integer values. In the following definitions, commands that use Tx/Rx queue values have ‘QQ’ in the bit fields to identify their presence. In one exemplary embodiment, the commands for the FabPCI DMA may be:

Reset/Stop FabPCI: 0x00000001.

Start FabPCI DMA Receive: 0xQQ000002.

Stop FabPCI DMA Receive: 0xQQ000003.

Start FabPCI DMA Transmit: 0xQQ000004.

Stop FabPCI DMA Transmit: 0xQQ000005

Interrupt Acknowledge: 0xII000006 // NEW 09/12/2000 //

Enable/Disable FabPCI DMA Interrupts: 0xII000007 (‘II’=Interrupt types; see below) // NEW 08/02/2000 //

Enable FabPCI DMA Statistics: 0x00000008

Reset FabPCI DMA Statistics: 0x00000009

Reset Rx Queue Event Counters: 0x0000000A // NEW 10/25/2000 //

All other values are currently reserved.

The values for the ‘QQ’ Tx/Rx queue ID field in the preceding command definitions are:

0x00. All Tx or Rx queues

0x01. Tx or Rx queue 1.

0x02. Tx or Rx queue 2.

0x03. Rx queue 3.

0x04. Rx queue 4.

Using the above values, issuing a command to stop Rx DMA activity for Rx queue 2 would have the value of 0x02000003; the command for starting Tx DMA activity for ALL the FabPCI Tx queues would be 0x00000004; etc. Interrupt type values (‘II’) for the Enable/Disable FabPCI DMA Interrupts are:

0x00: No Interrupts (this is the mask to disable FabPCI interrupts).

0x01: This mask enables/ACKs FabPCI DMA Rx Interrupts.

0x02: This mask enables/ACKs FabPCI DMA Tx Interrupts.

0x04: This mask enables/ACKs FabPCI Exception Interrupts

0x08: This mask enables/ACKs FabPCI Tx Flow Control Interrupts //

0x0f: This mask obviously enables/ACKs all FabPCI Interrupts

FabPCI General Status field 5056: This 8-bit read-only status register indicates the general state of the FabPCI FPGA as a whole. In general, it is useful for determining if the FPGA is ready for commands, etc. after a reset/restart. Values are:

0x00: Ready (General)

0x01: Busy/Resetting

0x02: UTOPIA Interface Not Ready

0x04: PCI Interface Not Ready

0x08: Tx Egress FIFO Empty

All other values are reserved for future definition and indicate errors.

FabPCI Event Status field 5058: This 8-bit read-only status register indicates which DMA Engine/s (or SAR logic block/s) has/have events/activity present: Values are:

0x01: Tx Queue 1 Events Pending/Active

0x02: Tx Queue 2 Events Pending/Active

0x04: Rx Queue 1 Events Pending/Active //

0x08: Rx Queue 2 Events Pending/Active //

0x10: Rx Queue 3 Events Pending/Active //

0x20: Rx Queue 4 Events Pending/Active //

0x40: Exception Events Pending/Active //

0x80: Tx Flow Control Event Pending/Active //

This register clears when the Interrupt Acknowledge command is written with the appropriate mask bits set (See Interrupt type values “II” in previous sections). It indicates which DMA Queues have events pending/active (i.e. Tx/Rx completion events, Exception Events, etc.). Once this register is cleared, the FabPCI DMA Engines will update these bits when the next events occur. This register is to be read and cleared with the Interrupt Acknowledge command whether the Fab driver is operating in Interrupt-driven or Poll modes. The Interrupt Enable Command is used to distinguish between Interrupt-driven and Poll mode. The Exception Event Status register may be read to determine the type of Exception Events pending.

FabPCI Tx/Rx Queue 1-n Status fields 5060 to 5070: These six memory mapped 8-bit registers are read-only status registers for each of the Fabric PCI DMA Engines (per Tx/Rx Queue). In one exemplary embodiment, status values for the FabPCI Tx/Rx DMA Queue Engines may be:

DMA Inactive (OK; Rx/Tx Stopped): 0x00

DMA Active: 0x01

DMA Error (Stopped): 0x02-0x7F

All other values are reserved.

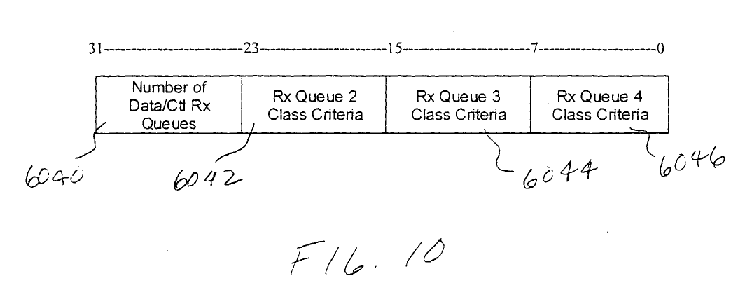

FabPCI Parameters field 5072: Read/Write. This 32-bit, little-endian, memory mapped register sets-up the operational parameters for the FabPCI DMA Engines. In one exemplary embodiment, this register may only be written to when the FabPCI Tx and Rx DMA Engines are stopped (see previous registers). FIG. 10 describes the parameter layout for setting up the receive queue parameters:

1) Bits 24-31 (highest order byte) comprise the Number of Data/Control Rx Queues field 6040. In one exemplary embodiment, valid values for Number of Data/Control Rx Queues are:

0x01 (One Critical Control Receive Queue+1 Data/Ctl Receive Queue)

0x02 (One Critical Control Receive Queue+2 Data/Ctl Receive Queues)

0x03 (One Critical Control Receive Queue+3 Data/Ctl Receive Queues)

2) The next three lower order bytes of this register comprise the separate fields (i.e., 6042, 6044, 6046) that setup the CCH/DCH Message Class receive criteria associated with a setup receive queue (as indicated by the Number of Data/Ctl Rx Queues). The values placed in these fields indicate the CCH/DCH Message Class value that is to be received into the designated/associated queue. Any Receive Queue that is inactive (not setup) OR is used as a general Receive Queue (in one exemplary embodiment at least one general data/control receive queue is utilized in addition to Rx Queue 1), receives a Message Class criteria value of 0xFF which is the equivalent of ANY. In one exemplary embodiment, valid values for the Rx Queue 2/3/4 Class Criteria bit fields are:

Any valid CCH/DCH Message Class value; OR . . .

0xFF which is a ‘wild card’ (ANY match) Message Class value.

Using these definitions, for example, a subsystem that desired to setup three Rx Queues, one for critical Control messages (Rx Queue 1), another for Message Class 5, and then a general receive queue would write the value 0x0205FFFF to the FabPCI Status/Parameters register after writing 0x00000007 to the FabPCI Command/Control register. To setup one critical Control message queue (Rx Queue 1) and a general data/control receive queue a value of 0x01FFFFFF may be employed for the receive queue parameters. If a subsystem wanted to have a critical Control message receive queue plus one receive queue for Message Class 0x07, plus another receive queue for Message Class 0x04, plus a general data/control queue, the value 0x030704FF would be written to the receive queue parameters. A synopsis of the receive queue parameters for one exemplary embodiment is:

All subsystems may have a critical Control Message receive queue plus at least one general data/control receive queue.

Rx Queues 2-4 may be used in ascending order without skipping any intervening Rx Queue(s). In other words, if two data/control receive queues are setup in addition to Rx Queue 1, they may be Rx Queues 2 and 3 (rather than 2 and 4 or 3 and 4).

Returning now to the fields of the exemplary embodiment of FabPCI DMA Control Structure Area of FIG. 9 that may be employed in the A/N Data Media Interface implementation of Example 2:

Critical Control PDU Receive Chain Base/Current Physical Address (Rx Queue 1) field 5072: This memory mapped read/write register has two functions: 1) When the Rx Queue DMA Engine is stopped/inactive it is loaded with, and points to, the physical (non-virtual) address of the head FabPCI Buffer Descriptor chain element for the receive queue of incoming Critical priority Control PDUs; therefore, in one exemplary embodiment this register is setup by the controlling software before the Rx DMA Engine (SAR logic 4016) is started; 2) Once the Rx DMA Engine is running, this register indicates the physical address of the current active buffer descriptor that is being operated on by the Rx DMA Engine. Buffer descriptor chains are ‘wrapped’ in a circular buffer chain enabling the FabPCI DMA engine to operate by simply following the linked chain of elements.

Data/Ct1 PDU Receive Chain Base/Current Physical Address (Rx Queues 2-4) fields 5076: These registers are identical in function to the Rx Queue 1 register with the exception that these registers point to the receive queue(s) for incoming data/control PDUs that are NOT of a critical priority. Also, Rx Queues 2-4 chain registers only may be setup for the receive queues that have been activated via the FabPCI Parameters register. Any unused Rx Queues do not need to have a base chain address set.

Critical PDU Transmit Chain Base/Current Physical Address (Tx Queue 1) field 5078: This register is identical in function to the previous Rx Queue registers with the exception that it points to the transmit queue for outbound Critical priority PDUs. As with the Rx Queue registers, this register may be initially setup with the base physical address of the head Buffer Descriptor element for this Tx Queue DMA Engine. Once the DMA Engine has been activated, this register indicates the physical address of the current active buffer descriptor.

Data/Control PDU Transmit Chain Base Physical Address (Tx Queue 2) field 5080: This register is identical in function to the previous Tx/Rx Queue registers with the exception that it points to the transmit queue for outbound non-critical PDUs.

Discarded Received PDUs/Buffer Descriptor Overflows (Queues 1-4) fields 5082: This 16-bit statistic indicates the number of received PDUs (using the head-of-PDU cells) that were discarded by the FabPCI DMA controller due to insufficient (none or ‘busy’) receive buffer descriptors.

Discarded Received Zombie/Orphan Cells (Queues 1-4) fields 5084: This 16-bit statistic indicates the number of ‘zombie mutant orphan’ receive cells that were encountered. These are cells that had no discernable associated PDU context associated with them.

Received PDU Context Overflows field 5086: This 16-bit statistic indicates the number of times the FabPCI DMA Receive engine encountered more than 16 different receive PDUs incoming simultaneously. In one exemplary embodiment, the FabPCI DMA Receive engine, supports a maximum of 16 simultaneous PDU flows/contexts.

Receive Buffer Size Overflows filed 5088: This 16-bit statistic indicates the number of times a received PDU exceeded the total buffer size allocated by a Receive Buffer Descriptor.

Field 5090: Reserved.

Receive PDU Errors field 5092: This 16-bit statistic indicates the number of PDUs received with PDU errors. In one exemplary embodiment, the only error detectable and recordable is if the received PDU doesn't match the size advertised in the PDU Payload Size field.

Received Duplicate PDUs: field 5094 This 16-bit statistics indicates the number of head-of-PDU cells that were received that matched an already allocated Rx PDU context (i.e. receive operations were already underway for a PDU with the same Source ID and Sequence Number fields). Please note that this type of error may cause other types of errors as a side effect.

Received Tail-less PDUs field 5098: This 16-bit statistic indicates the number of PDUs that were engaged in FabPCI receive processing and never encountered an ‘End-of-PDU’ indication in a cell header. This condition is flagged when an Rx PDU context, within the FPGA Rx logic, goes 1024 cell times without encountering a cell with the ‘End-of-PDU’ flag set in the GCH Cell Flags field. At that point the PDU's Rx context and any associated buffer descriptor are ‘closed’ and the error generated.

Received Inactive State Cell Discards field 6000: This 16-bit statistic identifies the number of cells received for an allocated receive queue/receive state machine where the associated buffers were not active yet. This may be, for example, a small window in the initialization process if a driver activates the FabPCI FPGA before allocating receive buffers.

Exception Event Status field 6002: This 16-bit register identifies what types of exception conditions have occurred. It holds a valid value when the ‘Exception Event Pending/Active” bit on the FabPCI Event Status register is ON (set; see above description). These values are also cleared when the Interrupt Acknowledge command is written with the Exception mask set. In one exemplary embodiment, values may be:

0x0001: PCI Error. This flag indicates that a PCI bus error has occurred.

0x0002: PE TX parity Error on Utopia bus from the UDASL

0x0004: Drop PDU Error due to insufficient receive buffer descriptors Queue 1

0x0008: Drop PDU Error due to insufficient receive buffer descriptors Queue 2

0x0010: Drop PDU Error due to insufficient receive buffer descriptors Queue 3

0x0020: Drop PDU Error due to insufficient receive buffer descriptors Queue 4

0x0040: Duplicate PDU Error due to Tailless PDU

0x0080: PDU Aging Error

0x0100: UDASL Interrupt Active—may be cleared in UDASL before Interrupt Acknowledged

All other values are reserved.

Receive Media Parity Errors field 6004: This 16-bit statistics indicates the number of media bus (UTOPIA) parity errors were encountered by the FabPCI FPGA's receive engine.

Receive Queue 1-4 Event Counters 6002 to 6012: These 16-bit, unsigned short, integer counters increment every time an incoming receive event is posted to a buffer descriptor in the associated receive chain. These registers wrap once they hit 0xFFFF. In one command is written to the FabPCI Command register.

PCI Interrupt Backoff Counter 6016: This 16-bit unsigned short integer sets the minimum time, in multiples of 32 PCI cycles (32*15 ns=480 nanoseconds), between PCI interrupt generation by the FabPCI DMA engines (Rx/Tx). In one exemplary embodiment, the maximum time value 63 which is 30.24 microseconds (63*480 ns). This counter is started when interrupts are acknowledged at the FabPCI Command/Control register. A value of zero allows interrupts to occur in an umetered fashion (as-occurs mode).

FabPCI iSAR (Intelligent SAR) Revision Number field 6014: This 16-bit, unsigned short integer indicates the revision number/version level of the iSAR logic. The high order byte contains the major revision number and the low order byte contains the minor revision number.

PDU Aging Counter field 6024: This 8-bit unsigned counter sets the maximum inter-cell wait time allowed for aging-out stranded PDUs (PDUs that may have lost an End-of-PDU cell). In one exemplary embodiment, this value may be in 64 PCI cycle multiples (64*15 ns=960 nonseconds). In this embodiment, the minimum value may be 4 (due to cell transit times) and the maximum value may be 63 (˜62 microseconds).

Buffer Status Poll Interval field 6022: This unsigned 8-bit field, is a writable control register that specifies the number of PCI clocks, in 4 clock increments, to be used as an interval between polling the status of the HARDWARE_OWNERSHIP flag in a Buffer Descriptor's Flags field to determine buffer readiness. In one exemplary embodiment, on a 66.66 MHz PCI bus, the PCI clocks are 15 nanoseconds apart which 60 nanosecond increments for the poll interval. Additionally, the FabPCI FPGA may use a unique timer trigger mechanism to determine when to poll system RAM memory regions. This algorithm decrements until the carry/signed bit goes active. This countdown algorithm adds two additional ticks (which is 120 ns) to any value loaded into this register. Therefore, in one exemplary embodiment the loading entity may deduct a value of two from the desired number of ticks to arrive at the correct number of 60 ns intervals. A formula that may be employed in this embodiment for generating the proper poll interval value is: Poll_Interval=((Time_In_Nanoseconds)/60)−2;

A default value of 6 may be employed which is approximately 0.480 microseconds (((6+2) * 4) * 15 ns=480 ns). Using a minimum valid value of two generates a value of 4 poll intervals which, in turn renders a poll interval of 240 nanoseconds; ((2+2)* 4) * 15 ns=240 ns.

Max Burst Cycles field 6020: This 8-bit unsigned integer instructs the FabPCI PCI State Machine what the maximum number of back-to-back data cycles per PCI burst is. In one exemplary embodiment employing a PCI implementation that is 64-bit (8 bytes), a value of 4 would equal a max burst size of 32 bytes, and a value of 16 would render a max burst size of 128 bytes, etc.

Number of Sequence Counters field 6018: This 8-bit, read-only register (i.e., it can be written to, but no value will be saved; i.e. Teflon-mode) identifies the number of Seqnce Number Counters the FabPCI Tx DMA engine (SAR Tx logic 4014) has for generating unique Source Sequence Numbers in transmitted PDU CCHs/DCHs. In one embodiment, the value may be 8.

Reserved field 6020: 32-bits. This register may be reserved for FPGA debug.

Port Queue Status field 6030: This 16-bit register indicates the switch fabric's port queue status. Bits 0-15 indicates the queue status of ports 0-15. A one bit (ON) indicates that ‘Queue Grant’ is ON—in other words, the port's egress queue is OK. A zero value indicates that a port's egress queue has ‘Queue Grant’ OFF—it is in a hold state and is not receiving data. Therefore, a value of 0xF7CF would indicate that ports 4, 5 and 11 are in a flow control ‘backoff’ state (queue grant is OFF). In systems that only have 8 ports, only the low order byte contains valid flow control/port queue status information.

Switch Shared Memory Status field 6028: This 8-bit field contains the per-priority level status of the shared memory state of the switch fabric. The switch fabric supports four levels of priority, levels 0-3, with zero being the highest priority level (these are the same priorities are carried in the each cell of a PDU in the first octet of each cell header). Therefore, for each priority level, a bit that is one (ON) indicates that the shared memory in the switch, for that priority level, has Grant ON—the priority level has no flow control/back-pressure invoked (it's OK). If this corresponding bit is zero (OFF), then flow control/back-pressure has been invoked for that priority level. So, a value of 0x0E would indicate that priorities 1-3 are OK, but priority zero (the highest priority level) is in a congested (flow control back-pressure invoked) state.

Flow Control Timeout field 6032: This 8-bit field indicates the number of cell times (currently 180 nanoseconds per cell) that the FabPCI Tx Egress engine will ‘stall’ (wait) trying to transmit a cell on the UTOPIA interface for a target port that has flow control back-pressure invoked (i.e. the queue grant is OFF; see above). So, fundamentally, it is a head-of-line blocking limit for destination ports that are congested. Valid values range from 1 (180 nanoseconds) to 255 (45.9 microseconds); the default value is 255. Once this limit has been reached for a given cell, the FabPCI Tx Egress engine flushes the offending cell and generates an exception condition in the FabPCI General Status register (see previous; please note that any exception condition will trigger an interrupt if interrupts are enabled). After timing out and generating an exception, the FabPCI Tx Egress engine proceeds on to attempt to transmit the following cells pending in its queue. This means that these cells may potentially invoke another Flow Control Timeout ‘stall’ period. See Example 4 for details on the operation of the FabPCI Tx engine when a Flow Control timeout has been encountered.

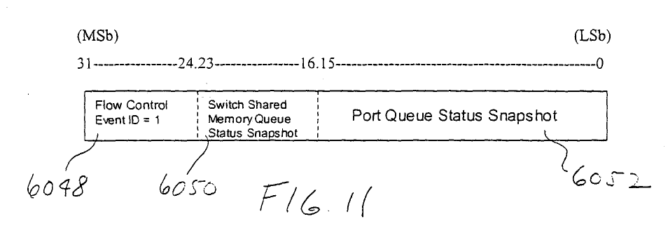

Flow Control Event Status field 6032: This 32-bit register contains state information related to Flow Control events when they occur. Currently, the only Flow Control Event that can occur is a Flow Control Timeout (see preceding). One exemplary embodiment of the format of the Flow Control Event Status register is shown in FIG. 11. This format is almost identical to the preceding 32-bits of the FabPCI register space (Port Queue Status, Switch Shared Memory Queue Status, and Flow Control Timeout) with the exception of the high-order byte (bits 24-31) which contains the Flow Control Event ID field 6048. This ID field, if it is nonzero, may contain the Event ID of the Flow Control Event that triggered the exception condition. Exemplary values are:

0x00: No event

0x01: Flow Control Timeout Event

All other values are reserved.

For Flow Control Timeout events, the Switch Shared Memory Queue Status Snapshot field 6050 and Port Queue Status Snapshot field 6052 both contain a snapshot of the Flow Control conditions that were present when the timeout event occurred. See Example 4 for details on the operation of the FabPCI Tx engine when a Flow Control timeout has been encountered.

Debug Register (reserved) field 6034: This 32-bit register may be reserved.

FabPCI Operational Feature Control (OFC) field 6038: This 24-bit field/register provides control over certain operational and behavioral aspects of the FabPCI's functionality. Exemplary values for one embodiment are:

0x001: Favorable_Bus_Read_Priority. This bit, when set, enables bus read transactions (for buffer descriptor interrogation and data transmit, etc.) to get priority over bus write transactions during bus transaction interleaving. By default this bit is zero, and in one exemplary embodiment may be set by subsystems/nodes that have determined their operational and performance behavior requires this functionality.

All other values may be reserved.

Sub-Revision Number field 6036: This 8-bit register is a companion field to the FabPCI iSAR Revision Number Register field 6014. It may be used to qualify specific release versions of a FabPCI revision.

### Example 4

### Flow Control Timeout Impacts and Recommended Actions

In this example, flow control timeout impacts and recommended actions for one exemplary implementation (e.g., Example 3) are described. In this example, when the FabPCI encounters a Flow Control Timeout event, the Tx Egress engine discards the blocking cell, saves a snapshot of the fabric flow control status bits into the Port Queue Status Snapshot register, generates an exception event, and proceeds onward to transmit the cells pending transmission in its FIFO queue. If any of the remaining cells are destined for a port that is congested, it is possible that they may also stall for the Flow Control timeout period. Therefore, it may be desirable that the Fab driver software take immediate action when a Flow Control Timeout exception event occurs to analyze the FabPCI and fabric states, and begin the appropriate recovery procedures. In one exemplary embodiment, recovery actions may include the following:

1) Read the FabPCI General Status register and test the FabPCI Exception event bit.

2) If this bit is ON (set), the driver may read the Exception Event Status register to determine if there was a Flow Control exception event or some other exception. For the purposes of this example, a Flow Control exception event is the stimulus and the Flow Control Exception event bit is set in the Exception Event Status register.

3) The driver issues a Stop FabPCI DMA Transmit command to the FabPCI Command/Control register to stop the FabPCI Tx DMA engines. If the FabPCI version supports the Tx DMA Queue Status indication bits, the driver may loop waiting for the Tx DMA Queue Status registers to indicate that the Tx DMA engines have stopped and also that the FabPCI Tx Egress FIFO Empty bit is ON (set) in the FabPCI General Status register. If the FabPCI version does not support the Tx DMA Queue Status and Egreee FIFO Empty bits, the driver may take the actions outlined in bullet 6.ii below. Either way, at this point the FabPCI Tx pipeline is completely empty and transmission is stopped for both the Tx SAR and Tx Egress engines.

4) The driver software now reads the Port Queue Status (PQS) and Switch Shared Memory Queue Status registers in one 32-bit read. This renders the current fabric flow control status which may be used to determine if a congested node has recovered, or not.

5) Next, the driver reads the Flow Control Event Status register to get the Port Queue Status Snapshot (PQSS) value of the fabric flow control information that caused the timeout exception event (this assumes that currently there is only one type of flow control exception event; otherwise, the Flow Control Event ID may be examined).

6) At this point the Tx Buffer Descriptor chains may be ‘fixed’ to either discard the buffers for a congested port, or, potentially, relink them onto the end of the Tx list in case the original port that was congested has recovered. Recovery policy or policies may be implemented as desired for the system and individual nodes, however some exemplary guidelines are mentioned in this example herein. First, a brief behavioral description of what happens to Tx Buffer Descriptor chains when a flow control timeout occurs in one exemplary embodiment:

i. When the FabPCI Tx Egress (UTOPIA) engine 4006 of FIG. 7 encounters a Flow Control Timeout (FCT) condition it flushes the blocking cell, captures the flow control information, generates an exception condition and moves on to the next cells in its Egress FIFO (which may, or may not, be of the same PDU). In one exemplary embodiment, the Tx Egress (UTOPIA) engine 4007 may be configured to operate autonomously from the FabPCI Tx SAR engine 4014 so that Tx Buffer Descriptor operations occur independently from the back-end egress FIFO operations. This means that when a FCT condition occurs, the FabPCI Tx DMA processes may be stopped to get the Tx SAR engine 4014 and Tx Egress engine 4004 to complete current operations and halt so that the buffer descriptor chains are static (i.e., do not have race conditions occurring during post-FCT buffer ‘triage’). Also, the FabPCI Tx SAR engine 4014 may be configured so that it only halts when complete PDUs have been processed; and so that it does not stop mid-PDU. In such an exemplary configuration, it may be desirable to poll the status bits (if the FabPCI version is configured to support them), and/or to have the Tx buffer descriptor lists polled (see following discussion herein), to determine when each of the engines have completed current operations and stopped. In one exemplary embodiment, each of the FabPCI Tx SAR engine 4014 and Tx Egress engine 4004 continue processing once a FCT condition has occurred, and in such an embodiment it is possible that their follow-on processing may encounter additional FCT conditions. Therefore, it may be configured so that the Tx Buffer Descriptor chains are still active for some time period after the transmitter has been instructed to stop. Also, the last descriptor marked as completed (HARDWARE_OWNERSHIP bit is OFF) is not necessarily the ‘problem’ buffer in one exemplary embodiment, nor is the last completed descriptor for a congested port guaranteed to have transmitted all cells successfully in one exemplary embodiment, i.e., in exemplary embodiment when completion notifications being signaled by the Tx SAR engine 4014 are prior to the Tx Egress engine's completion of cell transmission. In other words, when a FCT condition occurs in such an exemplary embodiment, there is the possibility that the Tx SAR 4014 may have signaled completion to a Tx buffer descriptor only to have the Tx Egress engine 4004 encounter a FCT condition that caused one, or more cells, from that buffer descriptor to be discarded. Therefore, the last completed buffer descriptor of a congested destination port may not have actually completed successfully (i.e. all the cells may not have made it). Additionally, in such an exemplary embodiment, the Tx SAR engine 4014 and Tx Egress engine 4004 may proceed onward to the next PDU/cells after a FCT condition, so that the last completed buffer descriptor isn't necessarily one that is related to a congested port. In such case, it may have completed successfully.

ii. In one exemplary embodiment, a FabPCI Tx SAR engine 4014 may be configured to sample the results of Stop commands (made to the FabPCI Command/Control register) between, but not during, servicing PDUs for transmission (i.e. once every PDU sampling). This means that issuing a Stop command to the FabPCI Tx DMA engine may have a delayed reaction that depends upon the FabPCI TX engine's current state and position in a buffer descriptor list. One way that may be used to confirm that both the FabPCI Tx SAR engine 4014 and Tx Egress engine 4004 have halted is to find the first Tx buffer descriptor in the chain that has not completed (after issuing the Stop command) and wait for it to complete. The wait time may be computed by reading the PDU Payload size, adding the PDU header size, dividing this sum by 80 to get the cell count, and then adding one to this value to derive the number of microseconds to wait (worst case) for the FabPCI Tx DMA engines to completely halt. Therefore one exemplary wait formula may be expressed as follows:

((PDU Hdr Size+PDU Payload Size)/80)+1=number of microseconds to wait (worst case).

In the above-described exemplary embodiment, there is a possibility that the FabPCI Tx SAR engine 4014 may sample the halt command status immediately after completing a PDU, which means that there is the potential for the buffer that the driver software is waiting for completion indication on, may not actually complete. Either way, after the ‘wait’ time, the Tx buffer descriptor chain may be considered safe for servicing.

Given the aforementioned behavior, there are two ways to approach FCT recovery for such an exemplary embodiment: 1) Data for a congested port may be removed and discarded (freed), or, 2) If the failed congested port is no longer congested, the original data for the congested port may be extracted, re-linked and placed at the tail of the Tx buffer descriptor list for retransmission. In one exemplary embodiment, a FCT event may be considered catastrophic, i.e., the fact that a node being blocked for ˜46 microseconds may be considered to indicate that the node is dead. In such an embodiment, the second option for the retransmission of PDUs to a prior congested node may not be considered viable. Nonetheless, even under such conditions, flow control data may be used to ascertain congestion status and determine proper action.

For recovery option 1, a Fab driver may be configured to wait until the FabPCI Tx engines have stopped (see above bullet ii) then to scan the Tx buffer descriptor chain(s) for two things: 1) the last buffer descriptor completed, and, 2) the last buffer descriptor completed to the congested node that caused the FCT exception. The latter may be done using the Flow Control Port Queue Status Snapshot (PQSS) mask to identify the blocked port(s) at the time of the FCT event. The PQSS mask may be converted to a Target Fabric Address (TFA) so that the related buffer descriptors may be identified. Following is an exemplary code example of how a PQS mask may be converted to a TFA:

static inline int PqsToTfa( unsigned short pqss,

unsigned short tfaArray[],
int tfaArraySize)

{

register int i, count, maxPorts;
register unsigned char *pTfa;
/* Determine how many ports to service
*/
maxPorts= MIN(NUMBER_OF_SWITCH_PORTS, tfaArraySize);
/* For each congested port, generate a TFA value
*/
for (i = count = 0; i < maxPorts; i++)
{

If( ((pqss >> i) &1))
{

pTfa = (unsigned char *) &tfaArray[count++];

If(i >= 8)

pTfa[1] =(1 << (15 − i));

else pTfa[0] =(1 << (7 − i));

}

}
return( count);

}

When the last completed buffer descriptor that matches the TFA mask is suspect; it may have not actually completed. If there are no provisions for retransmission, or indicating to a FUE transmission status per-buffer, this buffer and all subsequent buffers that match the TFA may be discarded (freed). If per-buffer transmission status is supported, then an error status may be provided for all buffers matching the ‘offending’ TFA starting with the last completed, TFA-matching buffer descriptor. If driver level retransmission is to be supported, all buffers matching the TFA mask, starting with last completed, TFA-matching buffer descriptor may be extracted from the current Tx buffer descriptor list and re-linked, in-sequence, to the end of the Tx buffer descriptor list provided that current Port Queue Status bits indicate that the congestion condition has abated for the target node (bitwise AND of the two PQSS masks; see bullet); PDU duplication may occur in such a mode.

7) Once the Tx buffer descriptor list(s) has/have been rebuilt after FCT ‘editing’, the FabPCI Tx engines may be restarted with the new list(s).

### Example 5

### FabPCI Buffer Design

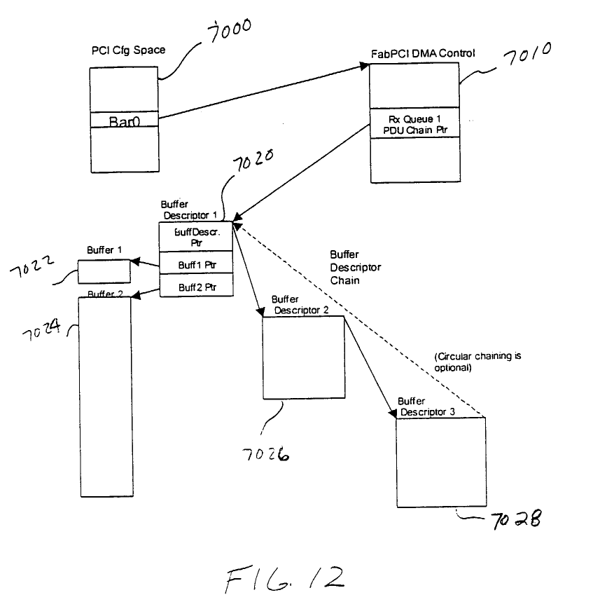

FIG. 12 illustrates one exemplary embodiment of FabPCI DMA buffer descriptor structure that may be employed with buffer chains for transmit and receive PDUs (e.g., both control and data PDUs). In one embodiment, the Buffer Descriptors may be located in system RAM, and the fields set as little-endian (e.g., mastered from system RAM via the PCI bus which is little-endian by nature). In one exemplary embodiment, the fields for the buffer descriptor structure fields may be described as follows. As with the layout of other examples herein, it will be understood that the below indicated values and other information described in relation to any one or more of the following fields are exemplary only, and that they may vary in value, or may be absent in other embodiments. Further, those fields not supported in this exemplary embodiment, may be supported in other embodiments as desired or required to fit the needs of a given implementation of another embodiment/s.

Physical Address of Next Buffer Descriptor (Chain Ptr) 6054: This 32-bit physical address may be used to point, in system RAM, to the next buffer descriptor in a buffer chain (either Tx or Rx queue).

Reserved (64-bit Physical Address Extension) Field 6056: 32-bits. In one exemplary embodiment, this reserved field may be used to provide extensibility for 64-bit addressability while also providing Quad-word (64-bit) alignment for the remaining portion of the Buffer Descriptor. Please see section “Buffer Descriptor Considerations” hereinbelow for Buffer Descriptor alignment issues.

FabPCI Completion Fields (“Completion Line”) 6061 and 6062: The following two fields, Buffer Descriptor Flags 6061, and Number of Buffers 6062, may constitute a single 32-bit word that gets overwritten, in a single cycle, by the FabPCI Tx DMA engine and FabPCI Rx DMA engine upon completion of a Buffer Descriptor operation. Precompletion values in these fields may be destroyed. Further information regarding these fields is provided below.

Buffer Descriptor Flags field 6061: This 16-bit little-endian (PCI native order) field indicates buffer descriptor function and status. In one exemplary embodiment, values may be:

HARDWARE_OWNERSHIP: 0x000. This flag may be used to indicate whether code on the host processor ‘owns’ a descriptor or the FabPCI DMA engine. For receive operations this indicates that a buffer descriptor is ready for DMA use.

The DMA engine will clear this bit when it completes the receive transfer operation. For transmit operations it indicates that the DMA hardware is not done with the buffer descriptor, yet. When transmit operations complete for a given buffer descriptor, this flag is cleared (zeroed) by the DMA transmitter. When either the transmit or receive DMA engines encounter a buffer descriptor without the Hardware Ownership flag set, DMA operations are quiesced since this event is interpreted as an end-of-chain condition (i.e. no more buffers available). In this quiesced state, any incoming PDUs are discarded due to a lack of buffer resources.

GENERATE_PAYLOAD_CHECKSUM: 0x0002. This flag may be used to indicate to the DMA transmit engine to generate a 32-bit checksum trailer as part of the PDU (see section 1.6.4.2). In one embodiment, this flag may only be valid for transmit buffer descriptors. When this flag is set, the Payload Offset field may be set (see following explanation of the Payload Offset field) to indicate the starting offset within the PDU where the checksum calculation is to start.

PDU_HEADER_SEPARATION: 0x0004. This flag may be used to indicate that the receiving entity wants the PDU header portion of incoming PDUs placed in separate memory from the PDU payload data. This feature may be used to allow exact memory placement of PDU payload data. In one exemplary embodiment, when this flag is ON, the FabPCI Rx DMA engine may be configured to place the incoming PDU header, by default, in the Buffer Descriptor's PDU Header Space field. If this flag is OFF, the FabPCI Rx DMA engine may be configured to place the incoming PDU header and payload data in memory contiguously with regards to the receive buffer structure.

RECEIVE_ERROR: 0x0008. This flag may be used to indicate a receive error occurred for the associated PDU (e.g., the Rx-based statistics may be read to determine error type). The Rx buffer descriptor may, or may not, contain data depending upon the Rx state when the error was encountered. The FabPCI Rx DMA engine may proceed to the next Rx buffer descriptor.

TRANSMIT_PARM_ERROR: 0x-000. This flag may be used to indicate that the FabPCI Tx DMA engine encountered a set of transmit parameters that were invalid. This buffer descriptor was marked and the FabPCI Tx DMA engine proceeded to the next Tx buffer descriptor. In one exemplary embodiment, this is an indication that the indicated PDU and buffer sizes do not match.

GEN_INTERRUPT: 0x0020. This flag may be used to indicate to the FabPCI Rx/Tx DMA Engines that an interrupt event is requested when an Rx or Tx operation is completed for the corresponding Buffer Descriptor. In one embodiment, if this flag is ON, an interrupt event may be generated ONLY if the corresponding state information and parameters are true: 1) Tx and/or Rx Interrupts are enabled and unmasked for the FabPCI controller, and 2) Tx and/or Rx interrupts are not currently pending for this FabPCI interface, and 3) the PCI Interrupt Backoff Counter has ticked-/counted-down to zero indicating the minimum time interval between interrupts has expired. Therefore, the Rx/Tx interrupt management at the FabPCI Command/Control register interface, for interrupt enablement and interrupt interval management, takes precedence over this bit setting in the individual Buffer Descriptors. However, in one exemplary embodiment, if Tx and/or Rx interrupts have been enabled via the FabPCI Command/Control register interface, these interrupt types may only be generated if this flag is ON at the proper interrupt interval. If this bit flag is OFF, no interrupt events may be generated for completion events in any case.

DRIVER_FLAGS: 0xE000 (0x8000, 0x4000, 0x20000). In one exemplary embodiment, the high order 3 bits of the Buffer Descriptor flags may be reserved for driver software usage and their values are preserved (and otherwise ignored) by the FabPCI hardware across buffer descriptor completion processing. In other words, if a buffer descriptor's flags had a value of 0x402 1 (HARDWARE_OWNERSHIP, GEN_INTERRUPT, DRIVER_FLAGS=0x4000) prior to buffer processing by the FabPCI hardware, the flags value would be 0x4000 upon successful processing of the buffer descriptor; the hardware would reinstate the original value of the DRIVER_FLAGS along with its completion indication values.

All other values may be reserved and may be set to zero.

Number of Buffers field 6062: This unsigned 16-bit little endian (native PCI format) field may be modified/written by both system software (Fab driver) and the FabPCI Tx/Rx DMA engines. This means that it may have both pre-, and post-, completion values and interpretations. For precompletion values (i.e. the values setup by software to initiate DMA activity), this field may indicate the number of transmit or receive buffers associated with the given buffer descriptor. In one exemplary embodiment, there may be a one-to-one correlation between a buffer descriptor and a PDU (i.e. a PDU is described to the DMA processor by a single buffer descriptor; a PDU cannot span multiple buffer descriptors). In such an embodiment this means that a transmit PDU may be comprised of up to four buffers. On the receive side, the FabPCI DMA engine may be configured to place an incoming PDU in up to four buffers referenced by a receive buffer descriptor. Therefore, a fabric switch node may be configured to deploy its receive buffer descriptors with each descriptor referencing enough buffer capacity to successfully receive its advertised maximum PDU size, and to prevent possibility that Receive Overflow occurs in the receive DMA engine.

For post-completion values, this field may be overwritten by the FabPCI Tx DMA engine as part of its update of the adjacent Buffer Descriptor Flags field; therefore its value may be nondeterminate after transmit completion. For Rx completion events, this field will bear two values. The lowest order three bits (0x0007 mask), will indicate the last external buffer that received DMA data. This means that it will identify Buffer1 (0x00) or Buffer2 (0x0002) or Buffer3 (0x0003) or Buffer4 (0x0004) as being the last buffer to receive data; a zero indicates no external buffers received data. The high-order 13 bits convey the number of bytes that were placed in the last buffer to receive data from the Rx DMA engine. Since only 13 bits are used, the last buffer may only receive up to 8191 bytes of information with accurate notification from the FabPCI Rx DMA engine using this field. Effectively, any values beyond 8191 become a modulo value of 8192 and software on the receiving side may be employed to use the PDU Header Payload Size field to determine the actual amount of received data and how it was distributed amongst the associated receive buffers. This utilization of this field allows the FabPCI Rx DMA engine to perform Rx completion notification in a single PCI write cycle and greatly increases bus utilization. It also eliminates the redundant updating of the buffer size fields for receive buffers that are completely received into (buffer size =rx size). Two examples are given below to demonstrate how this field operates for Rx event completion:

In scenario 1, a buffer descriptor with two 1024 byte external buffers is prepared for receive operation with the PDU Header being designated to be separated into the PDU Header space field. An incoming PDU, with a 16-byte PDU header and a 962 byte payload arrives and is placed in this buffer descriptor's corresponding memory. Upon Rx completion, the PDU Header space would contain 16 bytes of data within the Buffer Descriptor, and the Number of Buffers field would read 0x1E11 indicating 962 bytes were received into Buffer1;; Buffer2 was untouched.

Here is how 0x1E11 is decoded: buffer number=(0x1E11 & 0x0007)=0x0001; last buffer size=(0x01E11>>3)=0x3C2=962; Buffer1 is the last buffer and it contains 962 bytes which matches the PDU header's Payload Size field.

In scenario 2, a buffer descriptor with four 512 byte external buffers is prepared for receiving and no PDU header separation is, designated (i.e. the PDU header is received contiguously with the PDU payload data). An incoming PDU with a 12 byte header and a 1320 byte payload is received into this buffer descriptor. Upon completion, the Number of Buffers field would read 0x09A3 indicating that 308 bytes were received into Buffer3; 512+512+308=1332 which is 1320+12 bytes of PDU header. Please note that since both Buffers 1 and 2 were completely filled, there was no need to update their size fields since the buffer size equaled the receive size so this redundant operation was eliminated.

PDU Header Size field 6058: This one byte field may be used to indicate the size, in bytes, of the PDU Header information contained in, or that may be received into, the Buffer Descriptor PDU Header Space field (see following description). Please note, that all PDU headers may be multiples of 32-bit fields (i.e. their size may be a multiple of four bytes). Therefore, the least significant 2 bits of this field may be ignored by the FabPCI Tx/Rx DMA engines (i.e. a value of 59 would become a 56 and a value of 122 would be effectively 120). For transmit buffer descriptors, this field may be set by the transmitting firmware/software indicating how many bytes of PDU header information are contained in the PDU Header Space field. If no PDU data is present in the PDU Header Space field, this field may be set to zero. For receive buffer descriptors, this field is only relevant if the PDU_HEADER_SEPARATION flag is ON in the Buffer Descriptor Flags field. If this flag is ON, the FabPCI Rx DMA Engine moves the PDU header of an incoming PDU into the Buffer Descriptor's PDU Header Space field; however, no update of this field may be performed by the Rx DMA engine since the received PDU Header contains all the fields necessary to determine the header and payload sizes. The FabPCI Rx DMA Engine may assume the PDU header fits into the PDU Header Space field of the Buffer Descriptor; no size checking may be performed prior to data movement. Please note that the PDU header may include the base (GCH+CCH/DCH) and extension header fields. The FabPCI Rx DMA Engine may use the Cell Flags field in the GCH to determine what the PDU header size is of an incoming PDU. The FabPCI DMA engine's Rx and Tx logic flows are provided herein. Payload Offset field 6060: This one byte field may be set for transmit PDUs that need payload checksumming to be performed. When the GENERATE_PAYLOAD_CHECKSUM Buffer Flag is set, this field contains the offset from the start of the PDU where the transmit DMA engine is to start computing the payload checksum. In one exemplary embodiment, the offset value may be on a 32-bit boundary and the minimum offset value may be 16 bytes. This allows the presence of any size, or type, of PDU header fields, without the FabPCI DMA engine having to be aware of the PDU header structure (since there are conditional and proprietary extension header fields allowed). One exemplary checksum algorithm that may be employed is the TCP/UDP payload checksum method which is a 32-bit accumulation of 16-bit fields. The 32-bit checksum value is appended to the end of the PDU. Therefore, in one exemplary embodiment, a formula may be implemented in the FabPCI Tx DMA engine for generating the size of the PDU data to checksum as follows:

ChecksumLength=((PduHeaderSize+PduPayloadSize)−PayloadOffset)

Where ‘PduHeaderSize’ is the standard CCH/DCH PDU header size (12 Bytes) plus any extension header fields (using the Cell Flags), and ‘PduPayloadSize’ is the PDU Payload size for the associated PDU, and ‘PayloadOffset’ is the value assigned to the previously described Payload Offset Buffer Descriptor field (see above).

This field may have no relevance for non-checksummed transmit Buffer Descriptors and all receive Buffer Descriptors.

Sequence Counter ID/Cells Received* Field 6061: This unsigned 16-bit little endian field may be transmit versus receive dependent in its use and interpretation. For transmit Buffer Descriptors this field may be used to identify the Sequence Counter within the FabPCI's Tx DMA engine to use to generate the Source Sequence Number value in the CCH/DCH. In one embodiment, the FabPCI Tx DMA engine may have 8 counters (IDs 0-7) that get set to their ID values during FabPCI initialization. These counters may be used to generate the Source Sequence Numbers in transmitted PDUs. Each counter wraps at 255 (8 bit counters). These registers may be associated with each remote node such that all PDU traffic destined for fabric node ‘4’ would use Sequence Counter ID 0x04 to generate unique Source Sequence Numbers in the CCH/DCH headers. It is possible that violation of this usage may create non-unique Source ID-Sequence Number pairs that may lead to PDU loss at the egress FabPCI controller. In one embodiment, usage of this field for Tx Buffer Descriptors may be viewed by placing the zero-origin (0-7) fabric port number of the destination node in this field. For receive Buffer Descriptors this field may indicate the number of cells that comprised the corresponding received PDU.

Buffer 1-4 Physical Address fields 6064, 60608, 6072 and 6076: In one exemplary embodiment, these 32-bit little-endian fields may contain the physical addresses (i.e., not virtual or linear addresses) of the buffers that comprise a transmit or receive PDU. These buffer address and size fields may not be required to be setup when a specific Rx Queue is setup to receive only RMOD PDUs/messages (i.e., which do not require predefined buffers to be assigned to these Buffer Descriptor fields).

Buffer 1-4 Size/Length fields 6066, 6070, 6074 and 6078: These 32-bit little endian fields may contain the size of the data contained in the associated buffer. For Transmit buffers these fields may be set by the transmitting software/firmware to indicate how much data to transmit. For receive operations these fields may be used to indicate the buffer capacity of each receive buffer. The fields may not be updated by the FabPCI Rx DMA engine; the Number of Buffers field indicates the final buffer modified (see prior definition for Number of Buffers above)., Information concerning Buffer Descriptor buffers is provided in the following section Buffer Size Information.

PDU Header Space field 6080: 80 bytes. This field may be reserved to hold up to 80 bytes worth of PDU header data. The PDU Header Size field may be used to determine whether or not this field is actually used for Tx PDUs.

Buffer Descriptor Information

Buffer Descriptor Alignment:—In one embodiment, Buffer Descriptors (transmit and receive), may be 64-bit/Quad-word aligned to comply with all known 64-bit bridge/bus arbiter constraints for 64-bit PCI bus transactions.

PDU Header Consideration for Transmit Buffer Descriptors: One additional functional consideration regarding Buffer Descriptors that may be considered for Transmit Buffer Descriptors, is that all transmit Buffer Descriptors, for both Control and Data PDUs, may be configured to have the 1^{st} twelve bytes of the PDU header in either the Buffer Descriptor's PDU Header Space field or entirely in Buffer1 (i.e., the fixed PDU header portion of a PDU (CCH and DCH) may be in a contiguous memory buffer so that these 12 bytes do not span multiple buffers. Extended header information is not required to be contiguous.

PDU Header Separation for Rx PDUs: In one embodiment, a FabPCI Rx DMA Engine may not support PDU header separation into any memory area other than a Buffer Descriptor's PDU Header Space field. In another exemplary embodiment, the PDU header of an incoming PDU may be moved into the buffer of a Rx buffer chain.

Buffer Size Considerations: In one exemplary embodiment, buffers used for FabPCI transmit and receive may be an even multiple of 8 bytes (64-bits)in length (not necessarily content size), and the FabPCI Rx and Tx DMA engines may be configured to perform 64-bit bus-to-memory operations to help optimize system performance and bus efficiency. For receive buffers this means that the buffer size(s) may be a multiple of 8 bytes since the FabPCI Rx DMA engine will master the final number of bytes within a PDU (i.e. 1-8) as an 8 byte write to system RAM. So a received 253 bye PDU would be mastered into system RAM as 256 bytes with the last 3 bytes being nondeterminate values. In one exemplary embodiment, it is possible that other buffer lengths may cause a FabPCI Rx DMA engine to potentially write over adjacent areas of memory. Conversely, for transmit operations, the FabPCI Tx DMA engine also may be configured to read in 8 byte/64-bit multiples which means that the last ‘modulo 8’-bytes of a PDU are read as an eight byte buffer and the unused/invalid bytes may be discarded in the FabPCI Tx DMA engine. In one exemplary embodiment, a 111-byte transmit PDU may cause a FabPCI Tx DMA engine to generate fourteen 64-bit read operations (14*8=112) with only 7 bytes of the last 64-bit read being used.

### Example 6

### Relationship of PCI Registers to Data Structures

FIG. 12 illustrates one exemplary embodiment of relationship of PCI registers to data structures as described in the preceding examples herein. In the exemplary illustrated embodiment, all structures except the PCI Configuration Space may be in system memory address. Illustrated are PCI Cfg Space structure 7000 (e.g., of Example 3), FabPCI DMA Control structure 7010 (e.g., of Example 3), and buffer descriptor structure (e.g., of Example 5). Also illustrated are buffers 7020. and 7024, as well as buffer descriptors 7026 and 7028.

### Example 7

### FabPCI DMA Initialization Steps

Following are exemplary FabPCI DMA Initialization Steps as may be employed in one embodiment of the disclosed systems and methods:

Write 0x00000001 to the FabPCI Command register to reset the FabPCI DMA controller.

Wait until the FabPCI DMA General Status is 0x0000 before proceeding. The Tx and Rx DMA engines are now stopped and the FPGA is ready for commands and parameters.

Write to the FabPCI Parameters register to setup the Rx Queue Parameters using the appropriate Rx Queue parameters per the FabPCI Parameters register definitions (see previous).

Allocate and Setup the Rx buffer chains. When completed, write the base physical address of the buffer chain head descriptor(s) to the corresponding Rx Queue base chain address register(s).

Write 0x00000008 to the FabPCI Command register to activate DMA engine statistics.

Write 0x00000002 to the FabPCI Command register to activate the Rx DMA engine for all setup Rx queues.

Allocate and Setup Tx buffer chain(s). When complete, write the base physical address(es) of the chain(s) head buffer descriptor(s) to the corresponding Tx base chain address register(s).

When the Tx chain(s) is/are setup, write 0x00000004 to activate the FabPCI Tx DMA engine.

If interrupts are desired write 0xii00000007 to the FabPCI Command Register to setup which interrupt types are desired.

Please note that all of the above values are to be written in little-endian format to the FabPCI registers.

### Example 8

### PCI Considerations for FabPCI DMA Interface (FPGA) PCI Considerations for One Exemplary Embodiment of FabPCI DMA Interface (FPGA) May Be Characterized as Follows:

A FabPCI DMA engine may be configured to use PCI Write Invalidate bus cycles for all memory writes to system RAM to provide cache coherency.

A FabPCI DMA Engine may be configured to be able to DMA master memory from system RAM on 2 and 4 byte address boundaries, and it may be further configured to be able to DMA master from any memory address boundary.

### Example 9

### PCI Compute I/O Bus Mapped to Utopia-3 Interface

In the following example, one exemplary embodiment is described for interfacing/adapting a 64-bit/66.67 MHz PCI I/O bus to a 32-bit/110 MHz UTOPIA-3 interface, e.g., as may be implemented by the. illustrated embodiment of FIG. 7 of Example 7. However, it will be understood that the specific characteristics of the described embodiment are exemplary only. In this exemplary embodiment, AIN Data Media Interface 4000 may be configured to perform data format conversion and rate adaptation for data traffic between PCI interface 4012 and UTOPIA interface 4022. In this regard, it should be noted that PCI and UTOPIA-3 allow different bus widths and clock rates; and thus the parameters of the following example are purely exemplary, and may vary for implementation having different bus widths and clock rates. For example, in an another below-described exemplary embodiment, a 64-bit/66.67 MHz PCI I/O bus may be similarly interfaced/adapted to a 32-bit/104 MHz UTOPIA-3 interface.

Initialization

During microprocessor initialization, memory and PCI buses may be initialized and verified for error-free operation. Devices on PCI bus 4012 may then be enumerated to identify their presence. At this point, A/N Data Media Interface 4000 is detected. Once system device drivers are loaded, the device driver of the A/N Data Media Interface 4000 may initialize A/N Data Media Interface 4000 and set up its operational parameters. Exemplary operational parameters include, but are not limited to, cell size (e.g., 80 bytes for a 32-bit/110 MHz UTOPIA-3 interface embodiment, and 64 bytes for a 32-bit/104 MHz UTOPIA-3 interface), UTOPIA Rx (receive) clock rate, UTOPIA Tx (transmit) clock rate, maximum cell buffering Rx/Tx, maximum PCI data burst size, etc. Once this is done A/N Data Media Interface 4000 may start a process of synchronizing its back-end UTOPIA Rx and Tx clocks with the external switch fabric. Once this is done, u_Tx 4006 of A/N Data Media Interface 4000 may start generating “idle-cells” on its 110 MHz (alternatively 104 MHz) non-asynchronous (e.g., isochronous) UTOPIA Tx interface whenever there is no data to present from PCI bus 4012. Simultaneously, A/N Data Media Interface 4000's UTOPIA Rx state machine u_Rx 4007 may start receiving, and possibly discarding, cell data until its PCI Rx state machine 4005 is ready/active.

Timing/Synchronization

In this example, A/N Data Media Interface 4000 may be configured to support at least 2 clock domains to “bridge” between the PCI interface 4012 and UTOPIA interface 4022. If the UTOPIA transmit (Tx) and receive (Rx) clocks are independent, then A/N Data Media Interface 4000 may be configured to support 3 clock domains, i.e., one clock domain for 66.67 MHz PCI, one clock domain for 110 MHz UTOPIA Tx (generated), and one clock domain for 110 MHz UTOPIA Rx (receive synchronization); or in an alterative embodiment one clock domain for 66.67 MHz PCI, one clock domain for 104 MHz UTOPIA Tx (generated), and one clock domain for 104 MHz UTOPIA Rx (receive synchronization). Buffering and signaling may also be segregated with respect to the clock of each interface. Cells for the UTOPIA interfaces may be constantly generated and received without respect to the PCI activities.

General Operation

For transmission from PCI bus interface 4012 to the UTOPIA interface 4022, A/N Data Media Interface 4000 may be configured to burst data into internal buffers, using an arbitration scheme that has no guaranteed finite latencies, and is configured to burst data in raw bulk transfers, that may be interrupted at any time, while non-asynchronously (e.g., isochronously) generating cells on its u_Tx 4006. Specifically, the PCI 2.2-compliant interface operating at 66.67 MHz is capable of bursting 64-bits/8 bytes every 15 nanoseconds after some nondeterminate arbitration for access to the PCI bus. A/N Data Media Interface 4000 may be configured to then organize the PCI data into UTOPIA compliant, 80-byte (alternatively 64-byte) cells, complete with header information, and to move these to the u_Tx 4006, e.g., operating on a 110 MHz (alternatively 104 MHz) clock domain. At this rate, u_Tx may move 32-bits/4 bytes every 9.0909 nanoseconds (or every 9.615 nanoseconds for alternative 104 MHz embodiment), and therefore may generate a 80 byte cell every 181.818 nanoseconds (or alternatively generate a 64 byte cell every 153.84 nanoseconds for 104 MHz embodiment). If data is not present, or not signaled as ‘present’ across the 66.67-to-110 MHz clock domain (alternatively, across the 66.67 to 104 MHz clock domain embodiment), u_Tx 4006 may be configured to generate one or more idle cells until transmit data cells are ready.

Conversely, u_Rx 4007 may be configured to receive all incoming cells every 181.818 nanoseconds (or every 153.84 nanoseconds for 104 MHz embodiment), and to process them. This processing may include identifying and discarding idle cells, and receiving and processing data cells. All data cells are decoded for any target specific parameters (buffers are coalesced/managed/aggregated/etc.), interrogated for errors and cell loss, and then staged, via signaling across the UTOPIA Rx and PCI clock domains, for movement across the PCI bus interface 4012 into memory.

In the implementation of the exemplary embodiment of this example, it will be understood that any suitable mechanism/s for signaling PCI Tx and Rx events (completions, errors, buffer placement, queue status, interrupt generation, etc.) may be employed including, but not limited to, interrupts, status registers, buffer events, etc.

Rate Adaptation and Flow Control

In the exemplary embodiment of this example, data may be adapted from a Simplex 66.67MHz I/O bus to an isochronous 110MHz (alternatively 104 MHz) UTOPIA interface using rate adaptation and internal state machine support for participating in UTOPIA's flow control mechanisms. Isochronous data media employ fixed-size cells, or channel data, that always arrive at a fixed rate. In such an exemplary implementation, flow control mechanisms do not affect cell arrival or generation, but instead only affect whether the cells contain valid data or are idle. Thus in the implementation of this example, PCI data may be burst into the AIN Data Media Interface 4000 and aggregated into at least a 80-byte cell (or 64-byte cell for alternative 104 MHz embodiment) before data cell transmission may commence. In addition, the u_Tx 4006 may be configured to honor switch fabric flow control information (hardware signals <out-of-band> or received cell status header information <in-band>) to determine what type of cells to transmit: idle versus data.

In this exemplary embodiment, u_Rx 4007 of A/N Data Media Interface 4000 may be configured to simultaneously perform at least 2 high-level functions: 1) Pass received flow control information received in the headers of incoming cells to the u_Tx 4006 (across a clock domain potentially), and 2) also signal u_Tx 4006 of its own buffering status. In the event that in-band flow control is supported by the switch fabric, signaling the buffering status of the U_Rx 4007 to U_Tx 4006 allows the U_Tx 4006 to incorporate the Tx state of the A/N Data Media Interface 4000 into its own outbound cell headers as its own in-band flow control information. U_Rx 4007 of the A/N Data Media Interface 4000 may be configured to monitor its own internal buffer pool status due to the fact that the PCI state machine(s) 4005 of A/N Data Media Interface 4000 may be configured to arbitrate for both Rx and Tx opportunities on the PCI bus, with the potential for inordinate latencies per bus transaction. Thus, U_Rx 4007 is configured to ‘shape’ its flow control back to the switch fabric across the UTOPIA (Tx) interface.

Error/State Processing

In the exemplary embodiment of this example, A/N Data Media Interface 4000 may be configured to signal UTOPIA error events and state information across the PCI interface 4012 to system firmware/software in a relevant fashion. This includes the signaling of parity errors, data errors, cell loss, flow control state (Rx and Tx), physical interface synchronization status (clock state, etc.), and statistics. This includes PCI interfaces that allow firmware/software access to UTOPIA states for diagnostics. Likewise, PCI events, especially errors, are translated into UTOPIA Tx and Rx events, primarily, UTOPIA flow control events. This includes maintaining UTOPIA activity and synchronization regardless of PCI errors and resets, etc.

### REFERENCES

The following references, to the extent that they provide exemplary system, method, or other details supplementary to those set forth herein, are specifically incorporated herein by reference.

U.S. patent application Ser. No. 10/003,683 filed on Nov. 2, 2001 which is entitled “SYSTEMS AND METHODS FOR USING DISTRIBUTED INTERCONNECTS IN INFORMATION MANAGEMENT ENVIRONMENTS”

U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS”

U.S. patent application Ser. No. 09/797,413 filed on Mar. 1, 2001 which is entitled “NETWORK CONNECTED COMPUTING SYSTEM”

U.S. Provisional Patent Application Serial No. 60/285,211 filed on Apr. 20, 2001 which is entitled “SYSTEMS AND METHODS FOR PROVIDING DIFFERENTIATED SERVICE IN A NETWORK ENVIRONMENT,”

U.S. Provisional Patent Application Serial No. 60/291,073 filed on May 15, 2001 which is entitled “SYSTEMS AND METHODS FOR PROVIDING DIFFERENTIATED SERVICE IN A NETWORK ENVIRONMENT”

U.S. Provisional Patent Application Serial No. 60/246,401 filed on Nov. 7, 2000 which is entitled “SYSTEM AND METHOD FOR THE DETERMINISTIC DELIVERY OF DATA AND SERVICES”

U.S. patent application Ser. No. 09/797,200 filed on Mar. 1, 2001 which is entitled “SYSTEMS AND METHODS FOR THE DETERMINISTIC MANAGEMENT OF INFORMATION”

U.S. Provisional Patent Application Serial No. 60/187,211 filed on Mar. 3, 2000 which is entitled “SYSTEM AND APPARATUS FOR INCREASING FILE SERVER BANDWIDTH”

U.S. patent application Ser. No. 09/797,404 filed on Mar. 1, 2001 which is entitled “INTERPROCESS COMMUNICATIONS WITHIN A NETWORK NODE USING SWITCH FABRIC”

U.S. patent application Ser. No. 09/947,869 filed on Sep. 6, 2001 which is entitled “SYSTEMS AND METHODS FOR RESOURCE MANAGEMENT IN INFORMATION STORAGE ENVIRONMENTS”

U.S. patent application Ser. No. 10/003,728 filed on Nov. 2, 2001, which is entitled “SYSTEMS AND METHODS FOR INTELLIGENT INFORMATION RETRIEVAL AND DELIVERY IN AN INFORMATION MANAGEMENT ENVIRONMENT”

U.S. Provisional Patent Application Serial No. 60/246,343, which was filed Nov. 7, 2000 and is entitled “NETWORK CONTENT DELIVERY SYSTEM WITH PEER TO PEER PROCESSING COMPONENTS”

U.S. Provisional Patent Application Serial No. 60/246,335, which was filed Nov. 7, 2000 and is entitled “NETWORK SECURITY ACCELERATOR”

U.S. Provisional Patent Application Serial No. 60/246,443, which was filed Nov. 7, 2000 and is entitled “METHODS AND SYSTEMS FOR THE ORDER SERIALIZATION OF INFORMATION IN A NETWORK PROCESSING ENVIRONMENT”

U.S. Provisional Patent Application Serial No. 60/246,373, which was filed Nov. 7, 2000 and is entitled “INTERPROCESS COMMUNICATIONS WITHIN A NETWORK NODE USING SWITCH FABRIC”

U.S. Provisional Patent Application Serial No. 60/246,444, which was filed Nov. 7, 2000 and is entitled “NETWORK TRANSPORT ACCELERATOR”

U.S. Provisional Patent Application Serial No. 60/246,372, which was filed Nov. 7, 2000 and is entitled “SINGLE CHASSIS NETWORK ENDPOINT SYSTEM WITH NETWORK PROCESSOR FOR LOAD BALANCING”

U.S. patent application Ser. No. 09/797,198 filed on Mar. 1, 2001 which is entitled “SYSTEMS AND METHODS FOR MANAGEMENT OF MEMORY,”

U.S. patent application Ser. No. 09/797,201 filed on Mar. 1, 2001 which is entitled “SYSTEMS AND METHODS FOR MANAGEMENT OF MEMORY IN INFORMATION DELIVERY ENVIRONMENTS”

U.S. Provisional Application Serial No. 60/246,445 filed on Nov. 7, 2000 which is entitled “SYSTEMS AND METHODS FOR PROVIDING EFFICIENT USE OF MEMORY FOR NETWORK SYSTEMS”

U.S. Provisional Application Serial No. 60/246,359 filed on Nov. 7, 2000 which is entitled “CACHING ALGORITHM FOR MULTIMEDIA SERVERS”

U.S. provisional patent application No. 60/353,104, filed Jan. 30, 2002, and entitled “SYSTEMS AND METHODS FOR MANAGING RESOURCE UTILIZATION IN INFORMATION MANAGEMENT ENVIRONMENTS,” by Richter et. al

U.S. patent application Ser. No. 10/117,028, filed Apr. 5, 2002, and entitled “SYSTEMS AND METHODS FOR MANAGING RESOURCE UTILIZATION IN INFORMATION MANAGEMENT ENVIRONMENTS” by Richter, et al

U.S. patent application Ser. No. 10/060,940, filed Jan. 30, 2002, and entitled “SYSTEMS AND METHODS FOR RESOURCE UTILIZATION ANALYSIS IN INFORMATION MANAGEMENT ENVIRONMENTS,” by Jackson et al.

U.S. Provisional Patent Application Serial No. 60/353,561, filed January 31, 2002, and entitled “METHOD AND SYSTEM HAVING CHECKSUM GENERATION USING A DATA MOVEMENT ENGINE,” by Richter et al.

U.S. patent application Ser. No. 10/125,065, filed Apr. 18, 2002, and entitled “SYSTEMS AND METHODS FOR FACILITATING MEMORY ACCESS IN INFORMATION MANAGEMENT ENVIRONMENTS,” by Willman et al.

U.S. provisional patent application No. 60/358,244, filed Feb. 20, 2002, and entitled “SYSTEMS AND METHODS FOR FACILITATING MEMORY ACCESS IN INFORMATION MANAGEMENT ENVIRONMENTS,” by Willman et. al

U.S. patent application Ser. No. 10/236,467 filed Sep. 6, 2002, and entitled “SYSTEM AND METHODS FOR READ/WRITE I/O OPTIMIZATION IN INFORMATION MANAGEMENT ENVIRONMENTS,” by Richter.

U.S. patent application Ser. No. ______ filed concurrently herewith on Oct. 22, 2002, and entitled “METHOD AND SYSTEM FOR PERFORMING PACKET INTEGRITY OPERATIONS USING A DATA MOVEMENT ENGINE”, by Richter (Atty Dkt. SURG-152).

What is claimed is:

1. An A/N data media interface configured to communicatively couple at least one asynchronous data medium to at least one non-asynchronous data medium.

2. The A/N data media interface of claim 1, wherein said A/N data media interface is configured to:
receive first information in asynchronous form from said at least one asynchronous data medium;
transform said first information from asynchronous form to non-asynchronous form;
transmit said first information in non-asynchronous form to said non-asynchronous data medium;
receive second information in non-asynchronous form from said at least one non-asynchronous data medium device;
transform said second information from non-asynchronous form to asynchronous form; and
transmit said second information in asynchronous form to said at least one asynchronous data medium.

3. The A/N data media interface of claim 2, further comprising:
an asynchronous communication engine configured to be coupled to said at least one asynchronous data medium; and
a non-asynchronous communication engine coupled to said asynchronous communication engine, said non-asynchronous communication engine being configured to be coupled to said at least one non-asynchronous data medium;
wherein said asynchronous communication engine is configured to receive said first information in asynchronous form from said at least one asynchronous data medium, and wherein said non-asynchronous communication engine is configured to transmit said first information in non-asynchronous form to said non-asynchronous data medium;
wherein said non-asynchronous communication engine is configured to receive said second information in non-asynchronous form from said at least one non-asynchronous data medium device, and wherein said asynchronous communication engine is configured to transmit said second information in asynchronous form to said at least one asynchronous data medium;
wherein said A/N data media interface is configured to transform said first information from asynchronous form to non-asynchronous form after said first information is received by said asynchronous communication engine from said asynchronous data medium and before said first information is transmitted by said non-asynchronous communication engine to said non-asynchronous data medium; and
wherein said A/N data media interface is configured to transform said second information from non-asynchronous form to asynchronous form after said second information is received by said non-asynchronous communication engine from said non-asynchronous data medium and before said first information is transmitted by said asynchronous communication engine to said asynchronous data medium.

4. The A/N data media interface of claim 2, wherein said non-asynchronous data medium comprises a distributed interconnect.

5. The A/N data media interface of claim 2, wherein said A/N data media interface is configured to control information flow and to adapt information rate.

6. The A/N data media interface of claim 2, wherein said A/N data media interface comprises a switch fabric interface; wherein said non-asynchronous data medium comprises a switch fabric; and wherein said asynchronous data medium comprises a computing I/O bus medium.

7. The A/N data media interface of claim 6, wherein said asynchronous data medium comprises a PCI-type bus medium.

8. The A/N data media interface of claim 2, wherein said non-asynchronous data medium comprises a T/N medium; and wherein said asynchronous data medium comprises a computing I/O bus medium.

9. The A/N data media interface of claim 3, wherein said A/N data media interface further comprises an information transformation engine coupled between said asynchronous communication engine and said non-asynchronous communication engine, said information transformation engine configured to:
receive said first information in asynchronous form from said asynchronous communication engine;
transform said first information from asynchronous form to non-asynchronous form;
transmit said transformed first information in non-asynchronous form to said a non-asynchronous communication engine;
receive said second information in non-asynchronous form from said non-asynchronous communication engine;
transform said second information from non-asynchronous form to asynchronous form; and
transmit said transformed second information in asynchronous form to said a non-asynchronous communication engine.

10. The A/N data media interface of claim 9, wherein said information transformation engine comprises a segmentation and reassembly engine.

11. The A/N data media interface of claim 6, wherein said A/N data media interface is configured to transform said first information from asynchronous form to non-asynchronous form in a manner that allows selective implementation of one or more capabilities of said non-asynchronous data medium on a real time basis.

12. The A/N data media interface of claim 6, wherein said A/N data media interface is configured to transform said first information from asynchronous form to non-asynchronous form in a manner that allows selective implementation of one or more differentiated service capabilities of said non-asynchronous data medium on a real time basis.

13. The A/N data media interface of claim 11, wherein said first information is transmitted in PDU form, and wherein said A/N data media interface is configured to selectively implement said one or more capabilities of said non-asynchronous data medium on a real time basis by using instructional information contained in at least one PDU of said first information.

14. The A/N data media interface of claim 6, wherein said A/N data media interface is configured to present at least one standardized interface to said at least one asynchronous data medium.

15. An information management system, comprising:
a first processing engine;
a first asynchronous data medium coupled to said first processing engine;
a non-asynchronous data medium, said non-asynchronous data medium comprising a distributed interconnect; and
a first A/N data media interface communicatively coupled between said first asynchronous data medium and said non-asynchronous data medium.

16. The system of claim 15, wherein said first A/N data media interface is configured to:
receive first information in asynchronous form from said first processing engine across said first asynchronous data medium;
transform said first information from asynchronous form to non-asynchronous form;
transmit said first information in non-asynchronous form to said non-asynchronous data medium;
receive second information in non-asynchronous form from said non-asynchronous data medium device;
transform said second information from non-asynchronous form to asynchronous form; and
transmit said second information in asynchronous form to said first processing engine across said first asynchronous data medium.

17. The system of claim 16, wherein said system further comprises:
a second processing engine;
a second asynchronous data medium coupled to said second processing engine; and
a second A/N data media interface communicatively coupled between said second asynchronous data medium and said non-asynchronous data medium, said second A/N data media interface being configured to:
receive said first information in non-asynchronous form from said non-asynchronous data medium device;
transform said first information from non-asynchronous form to asynchronous form;
transmit said first information in asynchronous form to said second processing engine across said second asynchronous data medium;
receive said second information in asynchronous form from said second processing engine across said second asynchronous data medium;
transform said second information from asynchronous form to non-asynchronous form; and
transmit said second information in non-asynchronous form to said non-asynchronous data medium.

18. The system of claim 17, wherein said first and second A/N data media interfaces are each configured to control information flow and to adapt information rate.

19. The system of claim 17, wherein said first and second A/N data media interfaces each comprise a switch fabric interface; wherein said non-asynchronous data medium comprises a switch fabric; and wherein said first and second asynchronous data media each comprise a computing I/O bus medium.

20. The system of claim 19, wherein said asynchronous data medium comprises a PCI-type bus medium.

21. The system of claim 19, wherein each of said first and second A/N data media interfaces is configured to transform said at least one of said respective first or second information from asynchronous form to non-asynchronous form in a manner that allows selective implementation of one or more capabilities of said non-asynchronous data medium on a real time basis.

22. The system of claim 19, wherein each of said first and second A/N data media interfaces is configured to transform said respective first or second information from asynchronous form to non-asynchronous form in a manner that allows selective implementation of one or more differentiated service capabilities of said non-asynchronous data medium on a real time basis.

23. The system of claim 21, wherein each of said first and second information is transmitted in PDU form, and wherein each of said first and second A/N data media interfaces is configured to selectively implement said one or more capabilities of said non-asynchronous data medium on a real time basis by using instructional information contained in at least one PDU of said respective first or second information.

24. The system of claim 19, wherein at least one of said first or second A/N data media interfaces is configured to present at least one standardized interface to at least one of said respective first or second asynchronous data medium.

25. The system of claim 19, wherein said information management system comprises a network connectable information management system; and wherein each of said first and second processing engines is assigned separate information manipulation tasks in an asymmetrical multi-processor configuration.

26. The system of claim 25, wherein said information management system comprises a content delivery system.

27. The system of claim 26, wherein said separate information manipulation tasks assigned to each of said first and second processing engines comprises information manipulation tasks performed by at least one of an application processing engine, a transport processing engine, a storage management processing engine, a network interface processing engine, a system management engine, or a combination thereof.

28. The system of claim 26, wherein said information management system further comprises:
a plurality of processing engines that includes said first and second processing engines, each of said processing engines being coupled to a respective asynchronous data medium;
a respective A/N data media interface communicatively coupled between said non-asynchronous data medium and each of said respective asynchronous data medium that is coupled to each of said plurality of processing engines; and
wherein said plurality of processing engines comprise at least one application processing engine, at least one transport processing engine, at least one storage management processing engine, at least one network interface processing engine, and at least one system management processing engine.

29. A method of interfacing at least one asynchronous data medium with at least one non-asynchronous data medium, comprising:
receiving first information in asynchronous form from said at least one asynchronous data medium;
transforming said first information from asynchronous form to non-asynchronous form;
transmitting said first information in non-asynchronous form to said non-asynchronous data medium;
receiving second information in non-asynchronous form from said at least one non-asynchronous data medium device;
transforming said second information from non-asynchronous form to asynchronous form; and
transmitting said second information in asynchronous form to said at least one asynchronous data medium.

30. The method of claim 29, further comprising controlling information flow and adapting information rate.

31. The method claim 29, wherein said non-asynchronous data medium comprises a distributed interconnect.

32. The method of claim 29, further comprising:
providing an A/N data media interface, said A/N data media interface being configured to perform each of said steps of receiving, transforming and transmitting each of said first and second information;
communicatively coupling said at least one asynchronous data medium to said at least one non-asynchronous data medium using said A/N data media interface; and
performing said steps of receiving, transforming and transmitting each of said first and second information using said A/N data media interface.

33. The method of claim 31, wherein said non-asynchronous data medium comprises a switch fabric; and wherein said asynchronous data medium comprises a computing I/O bus medium.

34. The method of claim 33, wherein said asynchronous data medium comprises a PCI-type bus medium.

35. The method of claim 29, wherein said wherein said non-asynchronous data medium comprises a T/N medium; and wherein said asynchronous data medium comprises a computing I/O bus medium.

36. The method of claim 29, wherein said transforming of said first information from asynchronous form to non-asynchronous form comprises staging said first information received in asynchronous form from said at least one asynchronous data medium for non-asynchronous transmittal; and wherein said transforming of said second information from non-asynchronous form to asynchronous form comprises staging said second information received in non-asynchronous form from said at least one non-asynchronous data medium for asynchronous transmittal.

37. The method of claim 36, further comprising using a first clock domain to receive said first information in asynchronous form from said at least one asynchronous data medium, and to transmit said second information. in asynchronous form to said at least one asynchronous data medium; and using a second clock domain to receive said second information in non-asynchronous form from said at least one non-asynchronous data medium device, and to transmit said first information in non-asynchronous form to said non-asynchronous data medium; wherein said first clock domain is independent from said second clock domain.

38. The method of claim 37, further comprising controlling flow of at least one of said first or second information by communicating flow control information with said non-asynchronous data medium; arbitrating for communication opportunities across an asynchronous interface to said asynchronous data medium; and communicating a status of said arbitration to said non-asynchronous data medium.

39. The method of claim 36, further comprising using segmentation and reassembly protocol to transform said first information from asynchronous form to non-asynchronous form, and to transform said second information from non-asynchronous form to asynchronous form.

40. The method of claim 33, further comprising transforming said first information from asynchronous form to non-asynchronous form to allow selective implementation of one or more capabilities of said non- asynchronous data medium on a real time basis.

41. The method of claim 33, further comprising transforming said first information from asynchronous form to non-asynchronous form to allow selective implementation of one or more differentiated service capabilities of said non-asynchronous data medium on a real time basis.

42. The method of claim 40, further comprising selectively implementing said one or more capabilities of said non-asynchronous data medium on a real time basis by using instructional information contained in at least one PDU of said first information.

43. The method of claim 33, further comprising presenting at least one standardized interface to said at least one asynchronous data medium.

44. A method of interfacing a first processing engine of an information management system with at least one non-asynchronous data medium, comprising:
receiving first information in asynchronous form from said first processing engine across at least one asynchronous data medium;
transforming said first information from asynchronous form to non-asynchronous form;
transmitting said first information in non-asynchronous form to said non-asynchronous data medium;
receiving second information in non-asynchronous form from said non-asynchronous data medium device;
transforming said second information from non-asynchronous form to asynchronous form; and
transmitting said second information in asynchronous form to said first processing engine across said first asynchronous data medium.

45. The method of claim 44, further comprising:
receiving said first information in non-asynchronous form from said non-asynchronous data medium device;
transforming said first information from non-asynchronous form to asynchronous form;
transmitting said first information in asynchronous form to said second processing engine across said second asynchronous data medium;
receiving said second information in asynchronous form from said second processing engine across said second asynchronous data medium;
transforming said second information from asynchronous form to non-asynchronous form; and
transmitting said second information in non-asynchronous form to said non-asynchronous data medium.

46. The method of claim 45, further comprising controlling flow and adapting rate of said first and second information.

47. The method of claim 45, wherein said non-asynchronous data medium comprises a switch fabric; and wherein said first and second asynchronous data media each comprise a computing I/O bus medium.

48. The method of claim 47, wherein said asynchronous data medium comprises a PCI-type bus medium.

49. The method of claim 47, further comprising transforming at least one of said respective first or second information from asynchronous form to non-asynchronous form to allow selective implementation of one or more capabilities of said non-asynchronous data medium on a real time basis.

50. The method of claim 47, further comprising transforming at least one of said respective first or second information from asynchronous form to non-asynchronous form in a manner to allow selective implementation of one or more differentiated service capabilities of said non-asynchronous data medium on a real time basis.

51. The method of claim 49, wherein each of said first and second information is transmitted in PDU form; and wherein said method further comprises selectively implementing said one or more capabilities of said non-asynchronous data medium on a real time basis using instructional information contained in at least one PDU of said respective first or second information.

52. The method of claim 47, wherein said method further comprises presenting at least one standardized interface to at least one of said respective first or second asynchronous data medium.

53. The method of claim 47, wherein said information management system comprises a network connectable information management system; and wherein each of said first and second processing engines is assigned separate information manipulation tasks in an asymmetrical multi-processor configuration.

54. The method of claim 53, wherein said information management system comprises a content delivery system.

55. The method of claim 54, wherein said separate information manipulation tasks assigned to each of said first and second processing engines comprises information manipulation tasks performed by at least one of an application processing engine, a transport processing engine, a storage management processing engine, a network interface processing engine, a system management engine, or a combination thereof.

56. The method of claim 54, wherein said information management system further comprises a plurality of processing engines that includes said first and second processing engines, each of said processing engines being coupled to a respective asynchronous data medium; and wherein said plurality of processing engines comprise at least one application processing engine, at least one transport processing engine, at least one storage management processing engine, at least one network interface processing engine, and at least one system management processing engine.

57. A switch fabric interface configured to couple a switch fabric with a PCI bus interface, comprising:
a UTOPIA/UDASL engine configured to be coupled to said switch fabric;
a PCI engine configured to be coupled to said PCI bus interface;
a SAR Master/Target logic coupled to said PCI engine;
a SAR Tx logic coupled between said UTOPIA/UDASL engine and said SAR Master Target; and
a SAR Rx logic coupled between said UTOPIA/UDASL engine and said SAR Master Target.

58. The switch fabric interface of claim 57, further comprising a UTOPIA PCI control interface coupled between said UTOPIA/UDASL engine and said PCI engine.

59. The switch fabric interface of claim 58, wherein said UTOPIA/UDASL engine comprises u_Tx logic coupled to said SAR Tx logic, u_Rx logic coupled to said SAR Rx logic, and u_If logic coupled to said Utopia PCI control interface; and wherein said PCI engine comprises PCI config logic coupled to said SAR Master/Target logic, and PCI state machine logic coupled to SAR Master/Target logic.

60. The switch fabric interface of claim 59, wherein said switch fabric interface comprises an FPGA.
